(19) United States
(12) Patent Application Publication
(10) Pub. No.: US 2025/0319614 A1
(43) Pub. Date: Oct. 16, 2025

(54) LOWER ARM ASSEMBLY OF A ROBOT

(71) Applicant: Figure AI Inc., San Jose, CA (US)

(72) Inventors: Michael Stevens, San Jose, CA (US); Jake Goldsmith, San Jose, CA (US); Steve Morfey, San Jose, CA (US)

(21) Appl. No.: 19/249,517

(22) Filed: Jun. 25, 2025

Related U.S. Application Data
(63) Continuation-in-part of application No. 19/173,793, filed on Apr. 8, 2025, now abandoned.
(60) Provisional application No. 63/575,887, filed on Apr. 8, 2024.
(60) Provisional application No. 63/680,381, filed on Aug. 7, 2024.

(51) Int. Cl. B25J 18/00; B25J 9/10; B25J 15/00; B62D 57/032

(52) U.S. Cl. CPC B25J 18/00; B25J 9/1075; B25J 15/0009; B62D 57/032

(57) ABSTRACT

The disclosure presents a humanoid robot with an upper region (head, torso, arms with forearm assemblies, end effectors), lower region (legs), and connecting central region. Each end effector features index, middle, ring, little finger, and thumb assemblies attached to a housing of said end effector. The housing includes interior wall extents creating spaces for tendon routing, where the first distance between first and second wall extents is less than 45% of the second distance between third and fourth wall extents. Tendons controlling finger movements pass between these wall extents. The robot incorporates a wrist assembly connecting the housing of the end effector to the forearm, actuators housed in the forearm that control the tendons, and a carpal tunnel-like structure that guides tendons from forearm to base of the housing, enabling precise hand movements without requiring actuators in the hand itself.

### PRIORITY CLAIM AND CROSS-REFERENCE TO RELATED APPLICATIONS

This application is a continuation-in-part application of U.S. patent application Ser. No. 19/173,793, filed Apr. 8, 2025, which claims the benefit of and priority to U.S. Provisional Application No. 63/680,381, filed Aug. 7, 2024, and U.S. Provisional Patent Application No. 63/575,887, filed Apr. 8, 2024, each of which is expressly incorporated by reference herein in its entirety.

Reference is hereby made to: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, PCT/US25/25005, (ii) U.S. patent application Ser. Nos. 18/919,263, 18/919,274, 19/000,626, 19/006,191, 19/038,657, 19/064,596, 19/066,122, 19/180,106, and (iii) U.S. Provisional Patent Application Nos. 63/557,874, 63/558,373, 63/561,307, 63/561,311, 63/561,313, 63/561,315, 63/564,741, 63/565,077, 63/573,226, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/634,599, 63/634,697, 63/685,856, 63/696,507, 63/696,533, 63/700,749, 63/706,768, 63/707,547, 63/708,003, 63/722,057, 63/633,941, 63/635,152, 63/556,102, 63/561,317, 63/561,318, and 63/766,911, each of which is expressly incorporated by reference herein in its entirety.

### TECHNICAL FIELD

This disclosure relates generally to robotic systems and, more specifically, to a lower arm assembly for a general-purpose humanoid robot. The lower arm assembly includes a forearm, a wrist, and an end effector or hand and incorporates various sub-assemblies and components, along with the connections between these components. This integrated design provides the lower arm assembly with the capacity to substantially replicate the movements, capabilities, and physical configuration of a human arm and hand.

### BACKGROUND

The contemporary workplace landscape is confronted by a significant labor shortage, which is evidenced by over 10 million unfilled positions in the United States. These positions are often characterized as unsafe, undesirable, or physically demanding. This escalating challenge underscores the critical need for the development and integration of advanced robotic systems. Such systems must be capable of performing tasks that are hazardous, unappealing, or too physically strenuous for human workers. General-purpose humanoid robots represent a promising solution to address this labor gap. These robots are designed specifically for human-centric environments and typically emulate human morphology, featuring a bipedal design with two legs, two arms, and a head-like structure.

For these humanoid robots to operate effectively and fulfill tasks within environments designed for humans, the lower arm assembly, and particularly the end effector or hand, is a component of paramount importance. This requirement extends beyond superficial resemblance; the robotic hand must be capable of seamlessly interacting with and physically manipulating a diverse range of objects within complex and unstructured settings. Furthermore, such interaction must be achievable in a durable, cost-effective, and controllable manner, operating efficiently within the inherent constraints of the robot's resources, notably its limited battery power.

However, current robotic hand technologies frequently fail to meet these demanding and multifaceted requirements. Existing designs often struggle to replicate the full range of motion, flexibility, and adaptability that are characteristic of the human hand. Many robotic hands exhibit significant limitations in performing tasks that require fine motor skills, such as the delicate grasping and manipulation of objects with varied sizes, shapes, and textures. Deficiencies also persist in the execution of complex, coordinated movements that involve multiple digits operating simultaneously. Additionally, providing adequate force and precise control, especially for delicate operations, remains a substantial challenge. Moreover, practical challenges concerning power consumption and long-term durability continue to persist in current robotic hand designs. The integration of necessary actuators and complex control systems directly within the hand often results in bulky and oversized configurations. This increased size and mass can limit the robot's ability to access confined spaces or perform intricate tasks that demand high dexterity. Consequently, this restricts the potential applications of humanoid robots in numerous industrial, service, and healthcare sectors where human-like manipulation is an essential prerequisite. Therefore, there is a clear and unmet need for a complex lower arm with an advanced end effector.

### SUMMARY OF INVENTION

The presently disclosed subject matter is directed to a humanoid robot. Particularly, the robot comprises an upper region including at least: (i) a head, (ii) a torso, (iii) an arm having: (a) an elbow assembly, (b) a forearm assembly, and (c) a wrist assembly. The forearm assembly includes a forearm frame having: (i) a forearm axis that is substantially centered within an extent of the forearm frame, (ii) a proximal end coupled to an extent of the elbow assembly, (iii) a proximal mounting portion positioned adjacent to the proximal end, (iv) a distal end coupled to an extent of the wrist assembly, (v) a distal mounting portion positioned adjacent to the distal end. The forearm assembly also includes a first plurality of actuators coupled to the proximal mounting portion and arranged radially around the forearm axis, wherein a first actuator contained in the first plurality of actuators is in contact with a first tendon and includes a first tendon departure region. The forearm assembly further includes a second plurality of actuators coupled to the distal mounting portion and arranged radially around the forearm axis, wherein a second actuator contained in the second plurality of actuators is in contact with a second tendon and includes a second tendon departure region. The first tendon departure region is positioned at a first distance from the wrist assembly and the second tendon departure region is positioned at a second distance from the wrist assembly, wherein the first distance is not equal to the second distance. The humanoid robot also comprises a lower region spaced apart from the upper region and including a pair of legs, and a central region interconnecting the upper region and the lower region.

The presently disclosed subject matter is directed to a humanoid robot. Particularly, the robot comprises an upper region including: (i) a head, (ii) a torso, (iii) an arm coupled to the torso and including: (a) a forearm assembly, (b) a wrist assembly coupled to the forearm assembly, and (c) an end effector coupled to the wrist assembly. The wrist assembly includes a left base member, a right base member, a rotational axis that extends between the left and right base members, and a carpal tunnel-like structure coupled to the end effector and having an opening formed therein. The opening includes a centroid, and the centroid of the opening formed in the carpal tunnel-like structure is offset from the rotational axis, whereby said centroid does not lie on the rotational axis. The humanoid robot also comprises a lower region spaced apart from the upper region and including a pair of legs, and a central region interconnecting the upper region and the lower region.

Disclosed herein are embodiments of a humanoid robot featuring an advanced forearm, wrist, and end effector system. The forearm assembly incorporates a frame with a tapered design, where the proximal end has a larger perimeter, circumference, and/or diameter than the distal end. Housed within this forearm are a plurality of actuators, specifically more than six but fewer than twenty motors, which are coupled to a tendon-based actuation system. In some embodiments, a non-tendon-based actuator, such as a linear actuator, is also positioned at least partially between the elbow assembly and the proximal and distal ends of the forearm frame, augmenting the system's capabilities. The end effector, which includes a housing and a finger assembly, is designed to have more than 19 but less than 24 degrees of freedom, providing a high level of dexterity while maintaining a compact design with fewer than 20 motors. A protective glove may substantially encase the end effector, the wrist assembly, and a portion of the forearm.

The system utilizes a sophisticated tendon-based transmission to actuate the end effector's movements. To facilitate this, a carpal tunnel-like structure is configured to guide the tendons from the forearm assembly, through the wrist, and into the housing of the end effector. Individual tendons may be further routed through sheaths that have extents positioned within this carpal tunnel-like structure and extending towards both the finger assembly and the wrist assembly. The design accounts for the operational demands on the tendons; for instance, a first tendon may have a greater total curvature than a second tendon, where the second tendon is associated with a greater application of force or a higher frequency of use. To manage tendon tension and dynamics, some embodiments may further include biasing members in contact with the tendons.

A multi-component wrist assembly couples the housing of the end effector to the forearm assembly. This wrist assembly comprises a base structure for coupling to the forearm, a yaw component coupled to a housing coupling component to provide side-to-side movement (i.e., yaw) relative to the forearm assembly, and a pitch component coupled to the yaw component for up-and-down movement (i.e., pitch) of the end effector relative to the forearm assembly. The pitch component may include a cable guide specifically designed to route at least one of the tendons around a portion of its structure, ensuring smooth and reliable transmission of force from the actuators in the forearm to the joints of the end effector.

The presently disclosed subject matter is directed to a humanoid robot. Particularly, the robot comprises an upper region that includes: (i) a head, (ii) a torso, (iii) a pair of arms coupled to the torso, (iv) a forearm assembly coupled to each arm of the pair of arms, and (v) an end effector coupled to each forearm assembly. Each said end effector includes an index finger assembly, a middle finger assembly positioned proximate to the index finger assembly, a ring finger assembly positioned proximate to the middle finger assembly, a little finger assembly positioned proximate to the ring finger assembly, and a thumb assembly. The end effector also includes a housing having a base, and wherein said housing is coupled to the index finger, middle finger, ring finger, little finger, and thumb assemblies. The housing of the end effector includes a first interior wall extent, a second interior wall extent positioned a first distance from the first interior wall extent, a third interior wall extent, and a fourth interior wall extent positioned a second distance from the third interior wall extent. The second distance is located closer to the base of the housing than the first distance, and the first distance is less than 45% of the second distance. The robot further comprises a plurality of tendons coupled to at least the index finger assembly and the middle finger assembly. These tendons are positioned to pass between both: (i) the first and second interior wall extents, and (ii) the third and fourth interior wall extents. The robot also includes a lower region spaced apart from the upper region and including a pair of legs, and a central region interconnecting the upper region and the lower region.

The presently disclosed subject matter is also directed to a robotic hand assembly. Particularly, the assembly comprises a housing, a plurality of finger assemblies coupled to the housing, and a thumb assembly coupled to the housing. The assembly further includes a plurality of tendons configured to control the movement of at least one of the finger assemblies or the thumb assembly, and a plurality of actuators positioned in a forearm assembly and coupled to the plurality of tendons. The forearm assembly comprises a frame that has a distal mounting portion, an intermediate mounting portion, and a proximal mounting portion. the plurality of actuators are distributed among these distal, intermediate, and proximal mounting portions. Each finger assembly comprises a knuckle assembly coupled to the housing, a proximal assembly coupled to the knuckle assembly to form a first finger joint, and a medial-distal assembly coupled to the proximal assembly to form a second finger joint.

The presently disclosed subject matter is also directed to a robotic finger assembly. Particularly, the assembly comprises a knuckle assembly configured to couple to a housing, a proximal assembly coupled to the knuckle assembly to form a first finger joint, and a medial-distal assembly coupled to the proximal assembly to form a second finger joint. The assembly further includes a plurality of tendons routed through the knuckle assembly, the proximal assembly, and the medial-distal assembly, wherein the plurality of tendons are configured to control the movement of the first finger joint and the second finger joint.

The presently disclosed subject matter is also directed to a method of controlling a robotic hand. Particularly, the method comprises receiving a control signal at a plurality of actuators positioned in a forearm assembly, actuating one or more tendons coupled to the plurality of actuators in response to the control signal, and controlling the movement of at least one of a plurality of finger assemblies or a thumb assembly, which are coupled to a housing of the robotic hand, via the actuated tendons.

The presently disclosed subject matter is also directed to a robotic thumb assembly. Particularly, the assembly comprises a thumb knuckle assembly configured to couple to a housing, a thumb proximal assembly coupled to the thumb knuckle assembly to form a first thumb joint, and a thumb distal assembly coupled to the thumb proximal assembly to form a second thumb joint. The assembly further includes a plurality of tendons routed through the thumb knuckle assembly, the thumb proximal assembly, and the thumb distal assembly, wherein the plurality of tendons are configured to control the movement of the first thumb joint and the second thumb joint.

The presently disclosed subject matter is also directed to a robotic wrist assembly. Particularly, the assembly comprises a housing coupling component configured to couple to a palm frame of a hand assembly, a yaw component coupled to the housing coupling component, a pitch component coupled to the yaw component, and a base structure configured to couple to a forearm assembly. The assembly further includes a plurality of tendons routed through the yaw component and the pitch component, wherein the plurality of tendons are configured to control yaw and pitch movements of the hand assembly relative to the forearm assembly.

The presently disclosed subject matter is also directed to a method of routing tendons in a robotic hand assembly. Particularly, the method comprises providing a forearm assembly with a plurality of actuators, routing a plurality of tendons from the actuators through a wrist assembly, guiding the plurality of tendons through a carpal tunnel-like structure within the robotic hand assembly, and connecting each tendon to at least one of a plurality of finger assemblies or a thumb assembly that is coupled to a palm frame.

The presently disclosed subject matter is also directed to a robotic hand tendon assembly. Particularly, the assembly comprises a plurality of tendons, a plurality of actuators positioned in a forearm assembly and coupled to the plurality of tendons, a carpal tunnel-like structure configured to guide the plurality of tendons from the forearm assembly to a palm region, and a plurality of tendon routing structures configured to guide individual tendons to specific locations within a plurality of finger assemblies and a thumb assembly coupled to a palm frame.

The presently disclosed subject matter is also directed to a rotary actuator for a robotic assembly. Particularly, the actuator comprises a housing, an input shaft rotatably mounted within the housing, a single cycloidal disc coupled to the input shaft, and a stationary ring gear fixed relative to the housing and engaged with the cycloidal disc. The actuator further includes an output shaft assembly coupled to the cycloidal disc and a dynamic balancing feature configured to counteract imbalance caused by the cycloidal disc. The rotary actuator is configured to produce a torque output of at least 1 Nm within a perimeter, circumference, and/or diameter of 29 mm or less.

The presently disclosed subject matter is also directed to a method of actuating a robotic joint. Particularly, the method comprises receiving a control signal at a rotary actuator positioned in a forearm assembly of a robotic arm, and rotating an input shaft of the rotary actuator in response to the control signal. The method continues by driving a single cycloidal disc, which is coupled to the input shaft, in an orbital motion relative to a stationary ring gear, transferring rotational motion from the cycloidal disc to an output shaft assembly, and actuating a tendon coupled to the output shaft assembly to control the movement of a robotic joint.

Aspects of the disclosure relate to robotic systems, such as a robotic hand and forearm, that feature a distributed actuation system. In this system, multiple actuators are strategically mounted (e.g., four actuators each on distal, intermediate, and proximal forearm portions) and are configured to control specific movements. These movements include finger flexion/extension, finger abduction/adduction, thumb flexion/extension, thumb abduction/adduction, and wrist motion. The robotic hand typically includes multiple finger assemblies (e.g., index, middle, ring, and little fingers) and a thumb assembly, all coupled to a palm frame or an extent of the housing of the end effector. The design may feature shared actuation where, for instance, the ring and little fingers are driven by a single actuator for coupled flexion and extension. These finger and thumb assemblies are comprised of interconnected components (e.g., knuckle, proximal, and medial-distal segments) and are driven by the actuators via a tendon-based transmission system.

Efficient and precise operation is enabled by features such as a sophisticated tendon routing system. This system may include a carpal tunnel-like structure with individual external sheaths that guide each tendon to prevent pinching or tearing, alongside various integrated routing guides. Associated methods may involve actively tensioning the tendons under the control of a processor, based on feedback from various sensors. The actuators may be specialized cycloidal drives that incorporate dynamic balancing, modified gear profiles (e.g., shortened cycloids), and are constructed from high-precision, durable materials. Additionally, the system can include rotational interfaces between segments (e.g., the forearm and elbow) that feature mechanical limits (e.g., hardstops) and sensors (e.g., encoders) to provide for controlled movement and feedback regarding position and velocity.

The presently disclosed subject matter is directed to a robotic lower arm assembly. Particularly, the assembly comprises a forearm assembly including a forearm frame having a proximal mounting portion, an intermediate mounting portion, and a distal mounting portion. The assembly includes a plurality of actuators coupled to the forearm frame, wherein the plurality of actuators includes at least one direct-drive actuator and a plurality of rotary actuators, wherein each rotary actuator comprises a single cycloidal disc, a cycloidal spline fixed relative to an actuator housing, and an eccentric bearing assembly. The assembly includes a hand assembly coupled to a distal end of the forearm assembly, the hand assembly including a housing, a plurality of finger assemblies, and a thumb assembly, wherein each finger assembly includes a knuckle assembly, a proximal assembly, and a medial-distal assembly. The assembly includes a wrist assembly coupling the hand assembly to the forearm assembly, the wrist assembly including a housing coupling component, a yaw component, a pitch component, and a wrist tendon routing structure. The assembly includes a tendon assembly including a plurality of tendons, each tendon operatively connecting one of the plurality of actuators to a corresponding joint in the hand assembly or the wrist assembly, wherein the hand assembly and the wrist assembly lack any actuators contained within their respective structures, and wherein each tendon is routed through the wrist tendon routing structure and a carpal tunnel-like structure in the housing of the hand assembly.

The presently disclosed subject matter is directed to a method of operating a robotic lower arm assembly. Particularly, the method comprises activating at least one of a plurality of actuators coupled to a forearm frame of a forearm assembly, wherein the plurality of actuators includes at least one direct-drive actuator and a plurality of rotary actuators, wherein each rotary actuator comprises a single cycloidal disc, a cycloidal spline fixed relative to an actuator housing, and an eccentric bearing assembly. The method includes transmitting force from the activated actuator through a tendon of a tendon assembly to a corresponding joint in a hand assembly or a wrist assembly, wherein the hand assembly and the wrist assembly may lack any actuators contained within their respective structures. The method includes moving the corresponding joint in response to the transmitted force, wherein the hand assembly includes a housing, a plurality of finger assemblies, and a thumb assembly, wherein each finger assembly includes a knuckle assembly, a proximal assembly, and a medial-distal assembly, and wherein the tendon is routed through a wrist tendon routing structure in the wrist assembly and a carpal tunnel-like structure in the housing of the end effector.

The presently disclosed subject matter is directed to a robotic hand assembly. Particularly, the assembly comprises a housing or an extent of the housing (e.g., palm frame) may define a cavity having a first interior wall extent and a second interior wall extent positioned a first distance from the first interior wall extent, and a narrowing portion of the cavity between the first and second interior wall extents, the narrowing portion having a second distance that is less than 45% of the first distance. The assembly includes a plurality of finger assemblies coupled to the housing, each finger assembly including a knuckle assembly, a proximal assembly, and a medial-distal assembly, wherein the knuckle assembly includes a knuckle support configured to couple to the housing, a knuckle enclosure coupled to the knuckle support, and at least one bearing positioned between the knuckle support and the knuckle enclosure. The assembly includes a thumb assembly coupled to the housing, the thumb assembly including a thumb knuckle assembly, a thumb proximal assembly, and a thumb distal assembly. The assembly includes a carpal tunnel-like structure coupled to the housing and positioned within the narrowing portion of the cavity, the carpal tunnel-like structure including a bottom carpal tunnel member with a plurality of bottom tendon grooves and a top carpal tunnel member with a plurality of top tendon grooves, the carpal tunnel-like structure configured to guide a plurality of tendons from a forearm assembly through the housing to the finger assemblies and the thumb assembly, wherein movement of each finger assembly and the thumb assembly is controlled by at least one tendon operatively connected to an actuator located in the forearm assembly.

The presently disclosed subject matter is directed to a method of assembling a robotic lower arm. Particularly, the method comprises coupling a plurality of actuators to a forearm frame, the forearm frame having a proximal mounting portion, an intermediate mounting portion, and a distal mounting portion, wherein the plurality of actuators includes at least one direct-drive actuator and a plurality of rotary actuators, each rotary actuator comprising a single cycloidal disc, a cycloidal spline fixed relative to an actuator housing, and an eccentric bearing assembly. The method includes connecting a hand assembly to a distal end of the forearm frame via a wrist assembly, wherein the hand assembly includes a housing, a plurality of finger assemblies, and a thumb assembly, and wherein the wrist assembly includes a housing coupling component, a yaw component, a pitch component, and a wrist tendon routing structure. The method includes routing a plurality of tendons from the plurality of actuators through the wrist tendon routing structure of the wrist assembly and into a carpal tunnel-like structure in the housing frame of the hand assembly. The method includes operatively connecting each tendon to a corresponding joint in the hand assembly or the wrist assembly, wherein the hand assembly and the wrist assembly may be further configured to lack any actuators within their respective structures.

The presently disclosed subject matter is directed to a robotic finger assembly. Particularly, the assembly comprises a knuckle assembly configured to couple to a housing, the knuckle assembly including a knuckle support, a knuckle enclosure coupled to the knuckle support, the knuckle enclosure including a top member and a bottom member, and at least one bearing positioned between the knuckle support and the knuckle enclosure. The assembly includes a proximal assembly coupled to the knuckle assembly to form a first finger joint, the proximal assembly including a proximal member having a top surface with two spaced-apart wheel wells, at least two wheels each rotatably secured within one of the wheel wells, a first slot extending between the two wheel wells, and a second slot substantially parallel to the first slot. The assembly includes a medial-distal assembly coupled to the proximal assembly to form a second finger joint, the medial-distal assembly including a medial-distal member having a coupling end portion configured to couple with the proximal assembly, a distal end portion extending from the coupling end portion at a preset angle to form a fixed third finger joint, and at least one guide slot formed in an exterior surface of the coupling end portion. The assembly includes a plurality of tendon routing structures configured to guide at least one tendon through the finger assembly, wherein the at least one tendon is operatively connected to an actuator located in a forearm assembly and configured to control movement of the first finger joint and the second finger joint, and wherein the at least one tendon includes a first tendon routed through the first slot for controlling flexion of the first finger joint and a second tendon routed through the second slot for controlling extension of the first finger joint.

The presently disclosed subject matter is directed to a method of controlling a robotic hand. Particularly, the method comprises receiving a control signal at an actuator located in a forearm assembly, wherein the actuator is a rotary actuator comprising a single cycloidal disc, a cycloidal spline fixed relative to an actuator housing, and an eccentric bearing assembly. The method includes rotating an output shaft of the actuator in response to the control signal. The method includes applying tension to a tendon operatively connected to the output shaft. The method includes transmitting the tension through the tendon to a joint in a finger assembly or a thumb assembly of a hand assembly. The method includes moving the joint in response to the transmitted tension, wherein the hand assembly lacks any actuators contained within its structure, and wherein the tendon is routed through a wrist tendon routing structure in a wrist assembly and a carpal tunnel-like structure in a palm region of the hand assembly.

The presently disclosed subject matter is directed to a robotic thumb assembly. Particularly, the assembly comprises a thumb knuckle assembly configured to couple to a palm frame of the housing, the thumb knuckle assembly including a first spool and a second spool arranged perpendicular to each other, a housing structure configured to couple the first and second spools, and a thumb support configured to couple to the palm frame. The assembly includes a thumb proximal assembly coupled to the thumb knuckle assembly to form a first thumb joint, the thumb proximal assembly including a proximal thumb member having a top surface with two spaced-apart wheel wells, at least two wheels each rotatably secured within one of the wheel wells, a first slot extending between the two wheel wells, and a second slot substantially parallel to the first slot. The assembly includes a thumb distal assembly coupled to the thumb proximal assembly to form a second thumb joint. The assembly includes a plurality of tendon routing structures configured to guide at least one tendon through the thumb assembly, wherein the at least one tendon is operatively connected to an actuator located in a forearm assembly and configured to control movement of the first thumb joint and the second thumb joint, and wherein the first spool forms a portion of a trapeziometacarpal (TM) joint and the second spool forms a portion of a carpometacarpal (CMC) joint.

The presently disclosed subject matter is directed to a wrist assembly for a robotic arm. Particularly, the assembly comprises a housing coupling component configured to attach to a palm frame of a hand assembly, the housing coupling component including a base member formed to define tendon guides. The assembly includes a yaw component coupled to the housing coupling component and configured to enable side-to-side movement of the hand assembly, the yaw component including pegs that mate with bearings coupled to the base member of the housing coupling component, the pegs extending from a base structure along a yaw axis. The assembly includes a pitch component coupled to the housing coupling component and configured to enable up-and-down movement of the hand assembly, the pitch component including pegs that mate with bearings coupled to a wrist mount of the palm frame, the pegs extending from the base member of the housing coupling component along a pitch axis. The assembly includes a base structure configured to couple to a forearm assembly. The assembly includes a wrist tendon routing structure coupled to the base structure and configured to guide a plurality of tendons from the forearm assembly to the hand assembly, the wrist tendon routing structure including a routing plate with guide channels and a plurality of bushing sub-assemblies, wherein movement of the yaw component and the pitch component is controlled by tendons operatively connected to actuators located in the forearm assembly.

The presently disclosed subject matter is directed to a robotic forearm frame. Particularly, the frame comprises a wrist end portion configured to couple to a wrist assembly. The frame includes a distal mounting portion extending from the wrist end portion and configured to house a first set of actuators, the distal mounting portion including actuator mounts for securing the first set of actuators. The frame includes an intermediate mounting portion extending from the distal mounting portion and configured to house a second set of actuators, the intermediate mounting portion including actuator mounts for securing the second set of actuators. The frame includes a proximal mounting portion extending from the intermediate mounting portion and configured to house a third set of actuators, the proximal mounting portion including actuator mounts for securing the third set of actuators. The frame includes an elbow end portion configured to couple to an elbow assembly, the elbow end portion including an interior portion and a threaded exterior portion, wherein the forearm frame has a tapered design with a perimeter, circumference, and/or diameter that decreases from the proximal mounting portion to the distal mounting portion, and wherein the perimeter, circumference, and/or diameter of the proximal mounting portion is between 1.2 and 1.5 times the perimeter, circumference, and/or diameter of the distal mounting portion.

The presently disclosed subject matter is directed to a method of routing tendons in a robotic lower arm assembly. Particularly, the method comprises securing a plurality of actuators within a forearm frame, wherein the plurality of actuators includes at least one direct-drive actuator and a plurality of rotary actuators, each rotary actuator comprising a single cycloidal disc, a cycloidal spline fixed relative to an actuator housing, and an eccentric bearing assembly. The method includes routing a plurality of tendons from the actuators through a wrist assembly, wherein routing the plurality of tendons through the wrist assembly comprises guiding each tendon through a routing plate in a wrist tendon routing structure and directing each tendon around one of a plurality of bushing sub-assemblies coupled to the routing plate. The method includes guiding the plurality of tendons through a carpal tunnel-like structure in a palm frame of a hand assembly, wherein guiding the plurality of tendons through the carpal tunnel-like structure comprises positioning tendon sheaths between a bottom carpal tunnel member and a top carpal tunnel member and fastening the bottom and top carpal tunnel members together. The method includes connecting each tendon to a corresponding joint in a finger assembly or a thumb assembly of the hand assembly, wherein the routing of the tendons enables control of the hand assembly and the wrist assembly without actuators located within the hand assembly or the wrist assembly.

Disclosed herein are embodiments for a sophisticated robotic hand and forearm assembly. The system utilizes a plurality of actuators housed within a forearm frame to control the movement of a multi-jointed hand assembly through a complex tendon system. In some embodiments, the forearm frame includes proximal, intermediate, and distal mounting portions, housing a specific arrangement of rotary actuators of two different sizes and at least one direct-drive actuator for wrist twist. The first, larger-sized rotary actuators are configured for higher torque applications, while the second, smaller-sized actuators, between 60% and 80% of the first size, handle lower torque requirements. A representative configuration places four large actuators in the proximal portion, one large and three small actuators in the intermediate portion, and four small actuators in the distal portion. These rotary actuators, featuring a single cycloidal disc and a fixed cycloidal spline, achieve a gear reduction ratio between 30:1 and 50:1. Each actuator drives a continuous loop tendon that extends to a specific joint in the finger or thumb assembly and back to the actuator's spool.

The routing of this multitude of tendons from the forearm to the hand is achieved through a specialized wrist assembly that provides pitch and yaw movements, each with a substantial angular range of motion. The wrist tendon routing structure within this assembly features a routing plate with guide channels and a series of bushing sub-assemblies. Each sub-assembly is equipped with exactly two pulleys on a dowel, each pulley designed to change a tendon's direction by approximately 90 degrees. A clamp assembly with corresponding guide channels is secured over the routing plate to maintain the tendons' positions. From the wrist, the tendons pass through a novel carpal tunnel-like structure situated in a narrowing portion of a cavity within the palm frame. This structure is composed of a top and a bottom member with corresponding grooves that clamp around individual tendon sheaths, each having a perimeter, circumference, and/or diameter between 1.5 mm and 3 mm, ensuring smooth and organized tendon movement into the digits. This narrowing portion of the palm cavity has a width that is between 30% and 45% of the cavity's upper width.

The hand assembly itself exhibits a high degree of dexterity with nine degrees of freedom, complemented by two degrees of freedom in the wrist (pitch and yaw) and one in the forearm (wrist twist). The finger and thumb assemblies incorporate detailed joint mechanisms. For instance, the thumb's functionality is enabled by a knuckle assembly with perpendicular spools for abduction/adduction and flexion/extension, corresponding to the trapeziometacarpal (TM) and carpometacarpal (CMC) joints. The proximal thumb member includes two wheels and distinct slots with ball recesses for securing the tendons that control the CMC joint's flexion and extension. A similar design with two wheels and tendon slots is found in the proximal members of the fingers. The finger assemblies also feature knuckle joints providing two degrees of freedom (flexion/extension and abduction/adduction) and a medial-distal assembly with a fixed third finger joint. Notably, a finger coupler mechanism within the palm links the movement of the ring and little fingers, providing a single degree of freedom for their combined motion.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a perspective view of a humanoid robot in an upright, neutral position P1 and including: (i) an upper region having: (a) a head and neck assembly, (b) a torso, (c) left and right shoulders, (d) left and right upper arm assemblies that each include an upper humerus, a lower humerus, and an upper forearm, and (e) left and right lower arm assemblies that each include a lower forearm, a wrist, and a hand assembly, (ii) a lower region having: (a) left and right shins, (b) left and right ankle assemblies, and (e) left and right feet; and (iii) a central region connecting the upper and lower regions, and having (a) a spine, (b) a pelvis, (c) left and right hips, (d) left and right upper thighs, and (e) left and right lower thighs;

FIG. 2 is a perspective view of another embodiment of a humanoid robot;

FIG. 3 is a perspective view of the left lower arm assembly of the robot of FIG. 1 or FIG. 2, showing that the left lower arm assembly includes: (i) a hand assembly, (ii) a wrist assembly, (iii) an elbow assembly, (iv) a tendon assembly, and (v) a forearm assembly shown without its housing to reveal: (a) a forearm frame with a distal mounting portion, an intermediate mounting portion, and a proximal mounting portion, (b) four H2 actuators contained in the distal mounting portion of the forearm frame, (c) three H2 actuators and one H1 actuator contained in the intermediate mounting portion of the forearm frame, and (d) four H1-sized actuators contained in the proximal mounting portion of the forearm frame;

FIG. 4 is a perspective view of the forearm frame included in the forearm assembly of the lower arm assembly of FIG. 3, wherein the forearm frame includes: (i) a distal mounting portion, (ii) an intermediate mounting portion, (iii) a proximal mounting portion, (iv) a wrist end portion, and (v) an elbow end portion;

FIG. 5 is a perspective view of an actuator contained within the forearm assembly of the lower arm assembly of FIG. 3, wherein the actuator of the forearm may be a first size (H1) or a second size (H2);

FIG. 6 is a side view of the actuator of FIG. 5;

FIG. 7 is a front view of the actuator of FIG. 5;

FIG. 8 is cross-sectional view of the actuator of FIG. 5;

FIG. 9 is a perspective view of the tendon coupled to the actuator of FIG. 8, showing tendons coupled to, wound around a spool, and routed through first and second pulleys on each side of said actuator;

FIG. 10 is a perspective view of the end effector or hand assembly of the robot of FIG. 1 or FIG. 2, which comprises: (i) at least one finger assembly (e.g., index, middle, ring, and little), (ii) a thumb assembly, (iii) a palm assembly including a housing with an omitted bottom cover, and (iv) a plurality of tendons and their associated tendon sheaths, shown with top views of the finger and thumb assemblies detached from the hand assembly;

FIG. 11A-11B are an exploded view of one of the finger assemblies included in the hand assembly of the robot of FIG. 1 or FIG. 2, showing the finger assembly includes: (i) a knuckle assembly having (a) a knuckle support, (b) a spacer, (c) a knuckle enclosure, (d) bearings, and (e) pins, (ii) a proximal assembly having (a) a proximal member, (b) spanning covers, and (c) a proximal housing, and (iii) a medial-distal assembly having (a) a medial-distal member, (b) a distal housing, and (c) a finger tip cover;

FIG. 12 is a perspective view of the finger assembly of FIG. 11 in an uncurled state;

FIG. 13 is a side view of the finger assembly of FIG. 11 in the uncurled state;

FIG. 14 is a first partially assembled view of the finger assembly of FIG. 11, wherein the knuckle support is coupled to a palm frame, and a tendon is routed through the cable passageways of the knuckle support and includes a ball to be received in the knuckle enclosure;

FIG. 15 is a second partially assembled view of the finger assembly of FIG. 14, where the ball on the tendon is aligned with the ball seat of a top member of the knuckle enclosure;

FIG. 16 is a third partially assembled view of the finger assembly, wherein a spacer and the proximal member are added to the assembly of FIG. 15;

FIG. 17 is a fourth partially assembled view of the finger assembly, wherein the bottom member of the knuckle enclosure is added to the assembly of FIG. 16;

FIG. 18 is a fifth partially assembled view of the finger assembly, wherein a bearing is coupled to the assembly of FIG. 17;

FIG. 19 is a sixth partially assembled view of the finger assembly, wherein a clasp is coupled to the knuckle enclosure of FIG. 18;

FIG. 20 is a seventh partially assembled view of the finger assembly, wherein a medial-distal member is coupled to the proximal member on a first side via a first spanning cover and a pair of bearings;

FIG. 21 is an eighth partially assembled view of the finger assembly, wherein a second and opposed spanning cover is coupled to the proximal and the medial-distal members;

FIG. 22 is a ninth partially assembled view of the finger assembly, wherein wheels are secured within the proximal member via pins that are inserted in slots formed in said proximal member;

FIG. 23 is a tenth partially assembled view of the finger assembly, wherein an MCP flexion tendon is routed through cable guide slots on the exterior of the bottom member;

FIG. 24 is an eleventh partially assembled view of the finger assembly, wherein a ball is coupled to the MCP flexion tendon;

FIG. 25 is a twelfth partially assembled view of the finger assembly, wherein the ball of an MCP extension tendon is positioned within a ball recess of the knuckle assembly;

FIG. 26 is a thirteenth partially assembled view of the finger assembly, wherein a ball is coupled to the PIP flexion tendon and inserted within the second ball seat, and the tendon is routed into the bottom guide slot of said medial-distal member;

FIG. 27 is a fourteenth partially assembled view of the finger assembly, wherein said PIP flexion tendon is routed over the wheels of the proximal member;

FIG. 28 is a fifteenth partially assembled view of the finger assembly, wherein said PIP flexion tendon is inserted into a second cable guide slot;

FIG. 29 is a sixteenth partially assembled view of the finger assembly, wherein a PIP extension tendon is inserted into an opening formed in the medial-distal member;

FIG. 30 is an end view of the index, middle, ring, and little finger assemblies included in the end effector or hand assembly of FIG. 10, showing the tendon passageways;

FIG. 31 is an exploded view of the thumb assembly included in the hand assembly of the robot of FIG. 1 or FIG. 2, showing the thumb assembly includes: (i) a knuckle assembly having (a) a thumb knuckle member with spools and a housing structure configured to couple the spools together and (b) a thumb support, (ii) a proximal assembly having (a) a proximal thumb member, (b) thumb spanning covers, and (c) a proximal thumb housing, and (iii) a distal assembly having (a) a distal thumb member, (b) a distal housing, and (c) a thumb tip cover;

FIG. 32 is a perspective view of the thumb assembly of FIG. 31 in an uncurled state;

FIG. 33 is an end view of the thumb assembly of FIG. 31, showing the tendon passageways;

FIG. 34 is a perspective view of the end effector or hand assembly of FIG. 10, showing tendon sheaths arranged within a carpal tunnel-like structure included in the palm assembly of the hand assembly;

FIG. 35 is a bottom or palm view of a portion of the end effector or hand assembly of FIG. 34;

FIG. 36 is a first perspective view of the wrist assembly coupled to the end effector or hand assembly of FIG. 10, showing the wrist assembly includes: (i) at least a housing coupling component, (ii) a yaw component, (iii) a pitch component, (iv) a base structure, and (v) a wrist tendon routing structure;

FIG. 37 is a second perspective view of a portion of the wrist assembly of FIG. 36, showing the housing coupling component includes: (i) a base member, (ii) a cover member coupled to the base member over tendon guides formed on the base member, and (iii) fasteners that extend through the cover member into the base member;

FIG. 38 is a third perspective view of a portion of the wrist assembly of FIG. 36, showing tendons routed through the tendon guides of the housing coupling component;

FIG. 39 is a first view of the wrist tendon routing structure included in the wrist assembly of FIG. 36, showing the wrist tendon routing structure includes a routing plate formed with guide channels for the tendons routed therethrough and bushing sub-assemblies coupled to the routing plate;

FIG. 40 is a cross-sectional view of the wrist tendon routing structure taken along line 40-40 of FIG. 39;

FIG. 41 is a second view of the wrist tendon routing structure of FIG. 39, showing the guide channels for the tendons routed therethrough;

FIG. 42 is a perspective view of the wrist assembly of FIG. 36, showing the wrist tendon routing structure further includes a clamp assembly that couples to the routing plate over the tendons;

FIG. 43 is an end view of the end effector or hand assembly of FIG. 10, showing the carpal tunnel-like structure of the palm;

FIG. 44A-44B is a bottom or palm view of the left lower arm assembly of FIG. 3 without the forearm housing of the forearm assembly;

FIG. 45A is a cross-sectional view of the left lower arm assembly taken along line 45-45 of FIG. 44;

FIG. 45B is a zoomed in view of an extent of the left lower arm assembly of FIG. 44;

FIG. 46 is a zoomed in view of the actuators in the distal mounting portion of FIG. 45B;

FIG. 47 is a side view of the finger assembly of FIG. 12 in the uncurled state;

FIG. 48 is a cross-sectional view of the finger assembly taken along line 48-48 of FIG. 47;

FIG. 49 is a cross-sectional view of the finger assembly taken along line 49-49 of FIG. 47 and showing the omission of a spacer that prevents adduction and abduction;

FIG. 50 is a bottom view of the finger assembly of FIG. 47 in an adducted state, wherein said finger assembly moved in a first direction at the first or MCP joint;

FIG. 51 is a bottom view of the finger assembly of FIG. 47 in a central and uncurled state;

FIG. 52 is a bottom view of the finger assembly of FIG. 47 in an abduction state, wherein said finger assembly moved in a second direction at the first or MCP joint

FIG. 53 is a bottom view of the finger assembly of FIG. 47 in a central and uncurled state;

FIG. 54 is a cross-sectional view of the finger assembly taken along line 54-54 of FIG. 53 and showing the PIP extension tendon (blue) along with the MCP flexion tendon (red);

FIG. 55 is a cross-sectional view of the finger assembly taken along line 55-55 of FIG. 53 and showing the MCP extension tendon (blue) along with the PIP flexion tendon (red);

FIG. 56 is a top view of the finger assembly of FIG. 53, wherein said finger assembly is curled towards the palm at the first or MCP joint and is in a partially flexed position;

FIG. 57 is a cross-sectional view of the index finger assembly taken along line 57-57 of FIG. 56 and showing the MCP extension tendon (blue) along with the PIP flexion tendon (red);

FIG. 58 is a cross-sectional view of the index finger assembly taken along line 58-58 of FIG. 56 and showing the PIP extension tendon (blue) along with the MCP flexion tendon (red);

FIG. 59 is a rear view of the finger assembly of FIG. 56, wherein said finger assembly is curled towards the palm at the first or MCP joint and is in a fully flexed position;

FIG. 60 is a cross-sectional view of the finger assembly along line 60-60 of FIG. 59 and showing the PIP extension tendon (blue) along with the MCP flexion tendon (red);

FIG. 61 is a cross-sectional view of the finger assembly along line 61-61 of FIG. 59 and showing the MCP extension tendon (blue) along with the PIP flexion tendon (red);

FIG. 62 is a top view of the finger assembly of FIG. 59, wherein said finger assembly is curled towards the palm at the second or PIP joint and is in a fully flexed position;

FIG. 63 is a cross-sectional view of the finger assembly along line 63-63 of FIG. 62 and showing the PIP flexion tendon (red) along with the MCP extension tendon (blue);

FIG. 64 is a cross-sectional view of the finger assembly along line 64-64 of FIG. 62 and showing a PIP extension tendon (blue) along with the MCP flexion tendon (red);

FIG. 65 is a rear view of the finger assembly of FIG. 62, wherein said finger assembly is in a fully curled state, wherein the finger assembly is curled towards the palm at the first or MCP joint and the second or PIP joint;

FIG. 66A is a cross-sectional view of the finger assembly along line 66-66 of FIG. 65 and showing the PIP flexion tendon (red) along with the MCP extension tendon (blue);

FIG. 66B is a cross-sectional view of the finger assembly along line 67-67 of FIG. 65 and showing the PIP extension tendon (blue) along with the MCP flexion tendon (red);

FIG. 67A is an isolated view of the PIP extension tendon (blue) and the MCP flexion tendon (red) of FIG. 54 and showing the total curvature associated with said tendons when the finger assembly is in the uncurled state;

FIG. 67B is an isolated view of the MCP extension tendon (blue) along with the PIP flexion tendon (red) of FIG. 55 and showing the total curvature associated with said tendons when the finger assembly is in the uncurled state;

FIG. 67C is an isolated view of the PIP extension tendon (blue) and the MCP flexion tendon (red) of FIG. 66B and showing the total curvature associated with said tendons when the finger assembly is in the fully curled state;

FIG. 67D is an isolated view of the MCP extension tendon (blue) along with the PIP flexion tendon (red) of FIG. 66A and showing the total curvature associated with said tendons when the finger assembly is in the fully curled state;

FIG. 68 is a bottom view of the thumb assembly of FIG. 32, wherein said thumb assembly is curled towards the palm at the second or CMC joint in a partially flexed position;

FIG. 69 is a cross-sectional view of the thumb assembly taken along line 69-69 of FIG. 68 and showing a CMC flexion tendon (red) along with the MCP extension tendon (blue);

FIG. 70 is a cross-sectional view of the thumb assembly taken along line 70-70 of FIG. 68 and showing a CMC extension tendon (blue) along with the MCP flexion tendon (red);

FIG. 71 is a bottom view of the thumb assembly of FIG. 68, wherein said thumb assembly is curled towards the palm at the second or CMC joint in a fully flexed position;

FIG. 72 is a cross-sectional view of the thumb assembly taken along line 72-72 of FIG. 71 and showing a CMC flexion tendon (red) along with the MCP extension tendon (blue);

FIG. 73 is a cross-sectional view of the thumb assembly taken along line 73-73 of FIG. 71 and showing a CMC extension tendon (blue) along with the MCP flexion tendon (red);

FIG. 74 is a side view of the thumb assembly of FIG. 71;

FIG. 75 is a bottom view of the thumb assembly of FIG. 71;

FIG. 76 is a cross-sectional view of the thumb assembly taken along line 76-76 of FIG. 74;

FIG. 77 is a cross-sectional view of the thumb assembly taken along line 77-77 of FIG. 75;

FIG. 78 is a cross-sectional view of the thumb assembly taken along line 78-78 of FIG. 75;

FIG. 79 is a side view of the thumb assembly of FIG. 74, wherein said thumb assembly is rotated towards the palm at the first or TM joint in a fully abducted position;

FIG. 80 is a cross-sectional view of the thumb assembly taken along line 80-80 of FIG. 79 and showing a TM abduction tendon (red) and a TM adduction tendon (blue);

FIG. 81 is a bottom view of the thumb assembly of FIG. 79, wherein said thumb assembly is rotated towards the palm at the first or TM joint in a fully abducted position;

FIG. 82 is an end view of the thumb assembly of FIG. 81;

FIG. 83 is a cross-sectional view of the thumb assembly taken along line 83-83 of FIG. 82 and showing a TM abduction tendon (red) and a TM adduction tendon (blue);

FIG. 84 is a bottom or palm view of the end effector or hand assembly of FIG. 34, wherein the wrist assembly has been omitted;

FIG. 85 is a zoomed in view of a portion of the end effector or hand assembly of FIG. 84;

FIG. 86 is a cross-sectional view of the end effector or hand assembly taken along line 86-86 of FIG. 84;

FIG. 87 is a bottom or palm perspective view of: (i) the ring and little finger assembly and (ii) a finger coupler of the palm assembly included in the end effector or hand assembly of FIG. 34;

FIG. 88 is a perspective view of a portion of the wrist assembly included in the left lower arm assembly of FIG. 3, showing a step associated with the routing of a tendon in connection with the wrist assembly;

FIG. 89 is a perspective view of a portion of the wrist assembly of FIG. 88, showing another step associated with the routing of a tendon in connection with the wrist assembly;

FIG. 90 is a bottom or palm view of the hand assembly attached at the wrist assembly included in the left lower arm assembly of FIG. 3, wherein said hand assembly is in a maximum yaw position;

FIG. 91 is a bottom or palm view of the hand assembly attached at the wrist assembly of FIG. 90, wherein said hand assembly is in a minimum yaw position;

FIG. 92 is a side view of the hand assembly attached at the wrist assembly included in the left lower arm assembly of FIG. 3, wherein said hand assembly is in a minimum pitch position;

FIG. 93 is a side view of the hand assembly attached at the wrist assembly of FIG. 92, wherein said hand assembly is in a maximum pitch position;

FIG. 94 is a perspective view of the elbow assembly included in the left lower arm assembly of FIG. 3;

FIG. 95 is a partially assembled view of the left lower arm assembly of FIG. 3, wherein the wrist twist actuator is being coupled to the proximal mounting portion of the forearm frame;

FIG. 96 is a front view of the hand assembly attached at the wrist assembly included in the left lower arm assembly of FIG. 3, wherein said hand assembly is in a minimum counter-clockwise twist position; and

FIG. 97 is a front view of the hand assembly attached at the wrist assembly of FIG. 96, wherein said hand assembly is in a maximum counter-clockwise twist position.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such specific details. In other instances, well-known methods, procedures, components, and circuitry have been described at a relatively high level, without extensive detail, in order to avoid unnecessarily obscuring aspects of the present disclosure.

While this disclosure includes several embodiments in many different forms, there is shown in the drawings and will herein be described in detail specific embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations, and several of their details are capable of being modified in various respects, all without departing from the scope of the disclosed methods and systems. For example, one or more of the following embodiments, in part or in whole, may be combined in a manner consistent with the disclosed methods and systems. As such, one or more steps from the flow charts or components in the Figures may be selectively omitted or combined, consistent with the principles of the disclosed methods and systems. Additionally, one or more steps from the flow charts or the method of assembling the shoulder and upper arm may be performed in a different order than presented. Accordingly, the drawings, flow charts, and detailed description are to be regarded as illustrative in nature, and not as restrictive or limiting.

### A. Introduction

General-purpose humanoid robots are designed to emulate human form and functionality, typically featuring two legs, two arms, and a face-like screen. With the general-purpose humanoid robot's emulation of the human body, there arises the necessity for an arm assembly that can closely replicate human movements, and capabilities. The need for the arm assembly to be capable of mimicking human structure and function extends far beyond cosmetic resemblance. For example, it is required that the arm assembly enables the end effector or hand assembly of the robot to seamlessly interact with and physically manipulate diverse objects in complex environments, all while performing in a durable, cost-effective, and controllable manner using the robot's limited resources, including its onboard battery power. Enabling such a robot system to meet these requirements, along with being able to execute general human tasks, poses a significant challenge due to the vast array of potential positions, locations, and states that said robot could occupy at any given time in a dynamic environment. The multitude of these permutations can be minimized by training the robot system through various established methodologies, such as: (i) imitation learning or teleoperation, (ii) supervised learning, (iii) unsupervised learning, (iv) reinforcement learning, (v) inverse reinforcement learning, (vi) regression techniques, or (vii) other similar methods. To further streamline the vast array of possible positions, locations, and states, reduce manufacturing steps, complexities, and costs, minimize the number of components within the robot system, enhance component modularity, reduce training time, and achieve several other advantages that would be apparent to those skilled in the art, two or more components of the end effector can be either: (i) linked, or (ii) fused to one another. When two or more components are linked or fused, the movement of one component results in a corresponding movement in another component and in such case the end effector or the component of the end effector can be considered underactuated. In particular, the disclosed end effector or hand assembly: (i) links the movement of the ring finger to the movement of the little finger, and (ii) fuses the distal portion of each finger with the medial portion of that same finger. This design provides substantial advantages over conventional end effectors that lack this specific configuration.

In addition to linking and fusing components, the disclosed lower arm assembly includes a plurality of actuators that are positioned within the forearm and are designed to control the operation of the end effector or hand assembly. To this extent, the hand assembly and the wrist assembly are designed to lack any actuators contained within their respective structures. To enable the actuators positioned in the forearm to control the movement of the hand assembly, the actuators are coupled to extents or portions of the hand assembly using flexible cables, also referred to as tendons. To facilitate this coupling, the lower arm assembly utilizes a unique tendon assembly. Said tendon assembly routes the tendons through a carpal tunnel-like structure in a tightly formed bundle. Within this area, each tendon is routed through an external sheath to enable smooth movement of the tendon without pinching, tearing, or otherwise harming the tendons. This unique design provides substantial benefits over conventional robotic hands and their associated structures because it enables: (i) the end effector to have a smaller footprint (e.g., a smaller and slimmer profile), and (ii) the inclusion of additional degrees of freedom (DoF) that are not possible or would be difficult to achieve using a direct-actuation configuration.

To facilitate the positioning of the actuators within the forearm, said forearm includes a frame that has three primary mounting portions. Each mounting portion is designed to accommodate four actuators, wherein the first or distal mounting portion is designed to house the actuators that control portions of each finger, the second or intermediate mounting portion is designed to house actuators that control portions of the wrist, thumb, and index finger, and the third or proximal mounting portion is designed to house actuators that control the thumb and wrist. The frame has a tapered design to enable a portion positioned adjacent, substantially adjacent, proximate, or near the wrist to have an end effector, wrist, distal, or second perimeter, circumference and/or diameter that is smaller than elbow, forearm, proximate, or first perimeter of a portion positioned adjacent, substantially adjacent, proximate, or near the elbow. In other words, the perimeter, circumference, and/or diameter of the frame at a point in the third or proximal mounting portion is greater than the perimeter, circumference and/or diameter at a point in the first or distal mounting portion. This tapered design or reduction in the perimeter, circumference and/or diameter of the frame: (i) enables said frame to appear more human-like, (ii) allows the hand assembly to fit into smaller spaces, and (iii) reduces the mass that is positioned at the distal end of the arm. The diameter of the forearm at its widest point is preferably significantly less than 100 mm and more preferably less than 70 mm.

The end effector or hand assembly includes: (i) a thumb, and (ii) a plurality of finger assemblies-namely an index finger, a middle finger, a ring finger, and a little finger. Each of the finger assemblies has the same or similar structure as all other finger assemblies, with the potential exception of the omission of a spacer component in the index finger. In a preferred embodiment, the finger assemblies are designed to be substantially interchangeable with one another. The use of identical or nearly identical structures for the finger assemblies is beneficial because it reduces the number of distinct components required, increases modularity, and reduces the overall cost of the hand assembly and the robot system. While said finger assemblies are preferably structurally the same, the tips or ends of the distal portion of each finger are not positioned within a single plane. In other words, the tips or ends of the distal portions are intentionally offset from one another. This configuration is achieved by staggering the location where each finger assembly is coupled to the housing of the hand assembly. In particular, the middle finger is coupled to the housing in a position that is furthest away from the wrist, and the little finger is coupled to the housing in a position that is closest to the wrist. This enables the hand assembly to (i) appear more human-like, and (ii) increase fine manipulation of objects. Additionally, each finger is preferably fixed in at least one direction to the housing. In other words, the fingers are preferably not configured to rotate around a longitudinal axis of the finger.

Unlike conventional end effectors or hands, the disclosed lower arm assembly includes 12 degrees of freedom (DoF). In particular, the hand assembly includes 9 DoF, the wrist assembly includes 2 DoF, and the forearm includes 1 DoF for wrist twist. Extracting the hand assembly orientation or wrist twist DoF from the total, the combination of the wrist and hand assemblies includes 11 DoF. These 11 DoF can be broken down as follows: (i) the index finger includes 3 DoF, (ii) the middle finger includes 2 DoF, (iii) the combined ring and little fingers have a total of 1 DoF, (iv) the thumb includes 3 DoF, (v) wrist pitch includes 1 DoF, and (vi) wrist yaw includes 1 DoF. The 9 DoF contained in the hand assembly are controlled by the above-described nine tendon-based actuators that are positioned within the forearm, not the hand or wrist. It should be understood that alternative embodiments that are discussed below focus on an end effector the includes more than 19 degrees of freedom, but less than 24 degrees of freedom. Meanwhile, said end effector includes more than six motors, but fewer than 20 motors.

Unlike conventional end effectors or hands, each degree of freedom contained in the hand assembly is actively driven by an actuator in both directions of movement. In other words, the hand assembly does not include springs or other passive biasing members that force a joint into a specific orientation (e.g., open or closed). Instead, the disclosed hand assembly utilizes an actuator to extend a structure (e.g., proximal extent of a finger) around a joint, rotational axis, or pivot point and uses the same or another actuator to retract the structure (e.g., proximal extent of a finger) around said joint, rotational axis, or pivot point. Additionally, the disclosed assemblies feature two joints of the thumb that are controlled by a rotary actuator of a first, larger size (H1), while all other joints of the hand assembly (e.g., fingers and one joint of the thumb) are controlled by a rotary actuator of a second, smaller size (H2). Using different sized actuators provides a substantial benefit over conventional lower arm assemblies that lack this feature because it: (i) reduces the overall power consumption of the lower arm assembly, (ii) provides the necessary torques to the specific components that require it, without providing unnecessary additional torque to components that do not need it, and (iii) enables the forearm to have the aforementioned tapered configuration.

Unlike the hand assembly and wrist joints, the hand orientation or wrist twist is controlled by a direct-drive actuator that is positioned in a proximal end portion of the forearm. Thus, the lower arm assembly includes at least one direct-drive actuator along with eleven tendon-driving actuators. While the preceding paragraphs describe multiple benefits, desired configurations, and unique aspects of the lower arm assembly disclosed in the figures of this Application, it should be understood that these benefits, configurations, and aspects are only exemplary. They may not apply to all embodiments disclosed in or contemplated by this Application, or that can be derived by one of skill in the art based on the disclosure contained in this Application. In other words, the benefits, desired configurations, and unique aspects are not limiting in any manner.

### B. Robot

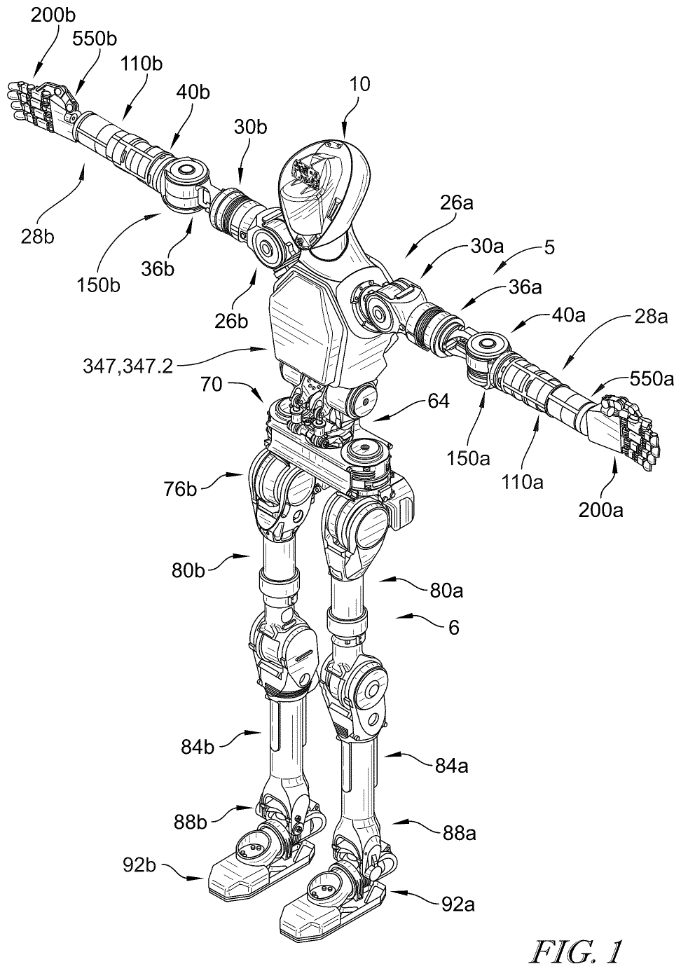

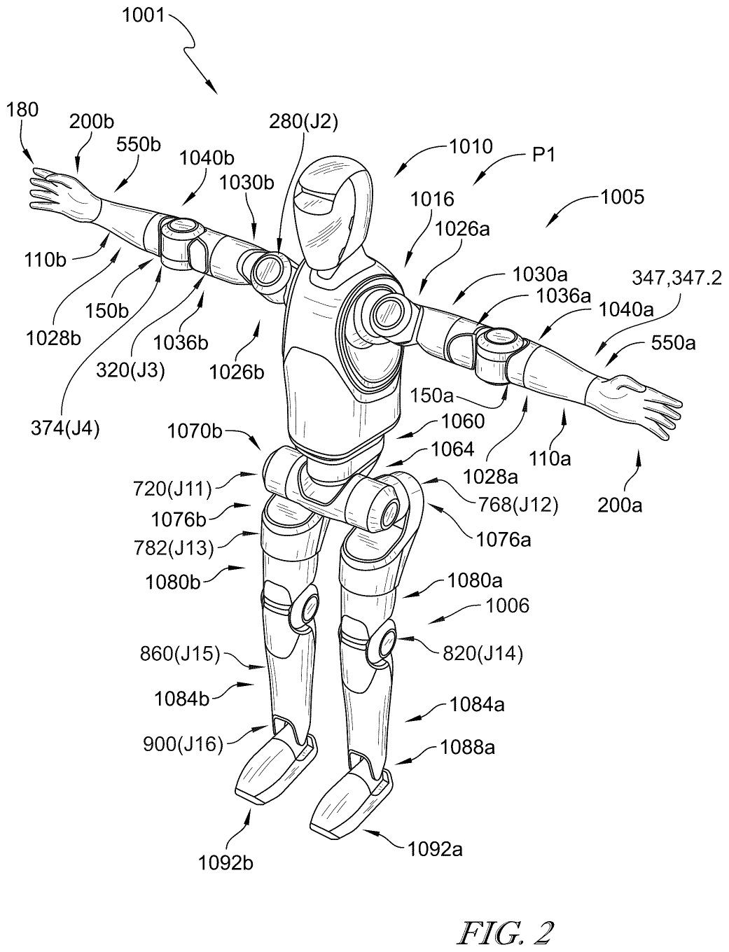

Referring to FIGS. 1-2, a humanoid robot 1, 1001 may include the following systems, assemblies, components, and parts: (i) an upper region including a head and neck assembly 10, 1010, a torso 16, 1016, left and right arms 5, 1005, and left and right hand assemblies 200; (ii) a central region including a spine 60, 1060, a pelvis 64, 1064, and left and right upper leg assemblies, where each upper leg includes a hip 70, 1070 and an upper thigh 76, 1076, and a lower thigh 80, 1080; and (iii) a lower region including left and right lower leg assemblies, where each lower leg including a shin 84, 1084, an ankle or talus assembly 88, 1088, and feet 92, 1092.

As shown in FIGS. 1 and 2, each arm 5, 1005 may be subdivided into an upper arm assembly 24, 1024 and a lower arm assembly 28, 1028. The upper arm assembly 24, 1024 includes the shoulder 26, 1026, the upper humerus 30, 1030, and the lower humerus 36, 1036. The lower arm assembly 28, 1028, which extends from the elbow to the fingertips, generally includes an upper forearm 40, 1040, a lower forearm 46, 1046, a wrist 550, 1550, and an end effector or hand assembly 200. The end effector or hand assembly 200 is coupled to the wrist 550, 1550 of the lower arm assembly 28, 1028 and is therefore considered an integral part of the lower arm assembly 28, 1028. A more detailed discussion of the constituent sub-assemblies of the lower arm assembly 28, 1028, along with their alterations and combinations.

The robot 1, 1001 includes various actuators arranged within its structure to closely replicate human movements and capabilities. In the illustrative embodiment, the left and right arms 5, 1005 extend from the torso 16, 1016 of the robot 1, 1001, and the left and right legs 6, 1006 extend from the pelvis 64, 1064 of the robot 1, 1001. The actuators in the upper arm assembly include: (i) a shoulder actuator 280 (J2) configured to move the arm 5, 1005 relative to the robot's torso 16, 1016, (ii) an upper arm twist actuator 320 (J3) configured to rotate the portion of the arm 5, 1005 below the upper humerus 30, 1030 relative to upper humerus 30, 1030, and (iii) an elbow actuator 374 (J4) configured to bend the elbow of the arm 5, 1005 of the robot 1, 1001. The lower arm assembly actuators include: (i) a first group that contains a single direct-drive actuator (i.e., non-tendon based) actuator 136 designed to control the twisting of the lower forearm 46, 1046 and the hand assembly 200, and (ii) a second group that contains eleven tendon-driving actuators 132, 134 designed to control the movement of the joints in the hand assembly 200 and the wrist 50, 1050. The arm actuators contained in the torso 16, 1016 and the actuators contained in the arm 5, 1005 cooperate to position the hand assembly 200 that is coupled to the wrist 50, 1050. The actuators in the upper leg assembly include: (i) a hip flex actuator 720 (J11) configured to move the leg 6, 1006 forward and backward relative to the robot's torso 16, 1016, (ii) a hip roll actuator 768 (J12) configured to move the leg 6, 1006 sideways (e.g., to the left or right) relative to the robot's torso 16, 1016, (iii) a leg twist actuator 782 (J13) configured to rotate the leg 6, 1006 relative to the robot's torso 16, 1016, and (iv) a knee actuator 820 (J14) configured to bend the knee of the leg 6, 1006 of the robot 1, 1001. The actuators in the lower leg assembly include: (i) a foot flex actuator 860 (J15) configured to change the pitch of the foot 92, 1092 and (ii) a foot roll actuator 900 (J16) configured to roll the foot 92, 1092.

The housing or exoskeleton of the components of robot 1, 1001 can vary in shape and form based on individual structural or material requirements for the specific components (e.g., torso, shoulder, head, etc.). Although it may be desirable to utilize a particular material for all the housings to have a consistent exterior appearance for the robot, fabrication may be complicated by the varying structural or operational needs at different locations on the robot. It may not be necessary to utilize the same materials in different component housings that have different load requirements. Various materials may be preferred for a specific component housing based on properties such as strength, toughness, elasticity, yield point, strain energy, resilience, elongation during load, weight, and conductivity. Similarly, the complexity of some housing designs may be better suited for one type of manufacturing process over another. Various fabrication methods for the housing components can include machining, die casting, injection molding, compression molding, and composite fabrication, among others. For example, some housings may be fabricated from cast metal instead of machined metal to achieve the desired cost, form, speed of manufacturing, and mechanical properties.

To hide the fact that different fabrication methods may be used, that different materials may be used, or to conceal the surface finishes caused by the fabrication methods or the materials themselves, it may be advantageous to obscure the exterior of the housings using an exterior covering system 347, 1347. Said exterior covering system 347, 1347 may provide additional benefits, as it can be easily replaced if damaged, protects internal components from dust and debris, conforms to the robot's form without excessive wrinkling, is generally inexpensive, and accommodates ventilation and thermal regulation needs. Further, the exterior covering system 347 may be designed so that it does not impede the range of motion of the robot 1, 1001, while maintaining access to underlying components and allowing for the access or operation of indicators or other functional elements (e.g., buttons, levers, etc.) on the robot's exterior surface.

The exterior covering system 347, 1347 may include attachment mechanisms for secure, detachable mounting at multiple locations, such as the collar, waist, sleeves, and ankles. This multi-point attachment ensures a snug fit, reducing the risk of interference between the robot 1, 1001 and factory equipment. In some instances, the cover members 347.2, 1347.2 of the exterior covering system 347, 1347 can attach directly to the surface of specific components or portions thereof. The exterior covering system 347, 1347 can be constructed from highly durable textiles that exhibit high stretch capabilities and resistance to pilling, abrasions, and cuts. Additional information about said cover members and their materials is disclosed in U.S. patent application Ser. No. 19/066,122, which is incorporated herein by reference.

The disclosed exterior covering system 347, 1347 for the humanoid robot 1, 1001 is form-fitting, meaning it is neither loose nor detached by more than a small margin (e.g., between 1 inch and 5 inches, and preferably 3 inches) from the robot's exterior surface or the outer surface of an energy attenuation assembly, without becoming disconnected. In other words, rather than draping loosely over the robot's frame, the exterior covering system is precisely and securely fitted to specific regions of the robot. The exterior covering material exhibits an elongation or stretch percentage exceeding 10% (preferably more than 30%, and most preferably greater than 50%), ensuring that when it is affixed to the robot 1, 1001, it remains under tension to conform closely to the robot's structure. Furthermore, a single cover member 347.2 does not cover or surround all actuators within the robot 1, 1001, nor a majority of the actuators contained in an upper portion of the robot 1, 1001, nor does it typically enclose more than three actuators at a time. In other words, a single cover member 347.2, 1347.2 does not resemble an oversized jumpsuit with a single zipper extending from the pelvis to the head region. Additionally, it does not feature a hood that covers a substantial portion of the robot's head. Instead, the exterior covering system 347, 1347 may be designed to include textile inserts positioned strategically between moving joint components to further ensure that pivoting motion is not restricted at the robot's joints. Different textile patterns are incorporated to facilitate movement in specific regions, enhancing the robot's functional dexterity.

### C. Lower Arm Assembly

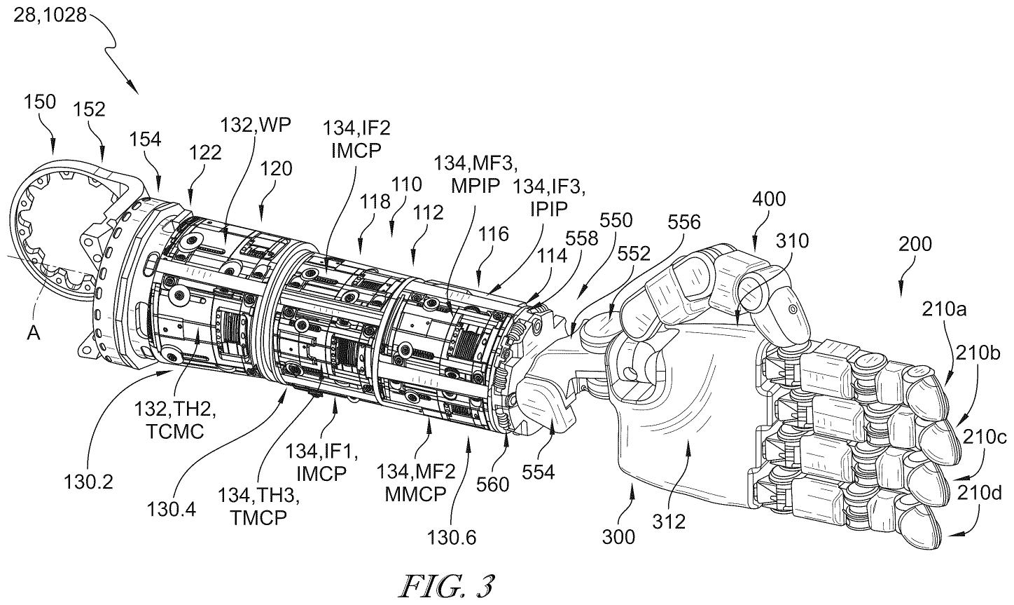

As shown in FIG. 3, the lower arm assembly 28, 1028 includes: (i) a forearm assembly 110, (ii) an end effector or hand assembly 200, (iii) an elbow assembly 150, (iv) a wrist assembly 550, and (v) a tendon assembly 600. These components are arranged in the following manner, when moving outward from the center of the robot 1, 1001 towards the fingertips of each lower arm assembly 28, 1028: (i) the elbow assembly 150 is coupled to a proximal end of the forearm assembly 110, and (ii) the wrist assembly 550 is coupled between a distal end of the forearm assembly 110 and the hand assembly 200. The tendon assembly 600 is arranged throughout portions of the forearm assembly 28, 1028, the wrist assembly 550, and the hand assembly 200. While the following text discloses an exemplary embodiment of the lower arm assembly 28, 1028, it should be understood that other embodiments are contemplated by this application.

### 1. Forearm Assembly

As shown in the Figures, the forearm assembly 110 is an integral component of the lower arm assembly 28, 1028 because it secures and houses a plurality of actuators 130 configured to control the operation of the fingers, thumb, and wrist. As such, the forearm assembly 110 includes: (i) a forearm frame 112, (ii) a plurality of actuators 130 configured to operate tendons 610 of the tendon assembly 600, (iii) an electronics package 140 (e.g., control boards 140.2, an encoder 140.4, and wiring 140.6), and (iv) a forearm housing 142. The plurality of actuators 130 and the components of the electronics package 140 are arranged throughout and coupled to the forearm frame 112. The forearm housing 142 extends around and encompasses the forearm frame 112, actuators 130, and the electronics package 140 to provide protection and a finished appearance. Alternatively, the forearm frame 112 may be omitted, and the forearm housing 142 may instead act as an exoskeleton to which the actuators 130 are directly coupled. In such an embodiment, the thickness and configuration of the housing 142 may be modified to be thicker than the housing 142 shown in the figures. The actuator mounting areas, which are associated with the frame 112 in the primary embodiment, may be integrally formed with or coupled to this exoskeletal housing 142.

a. Forearm Frame

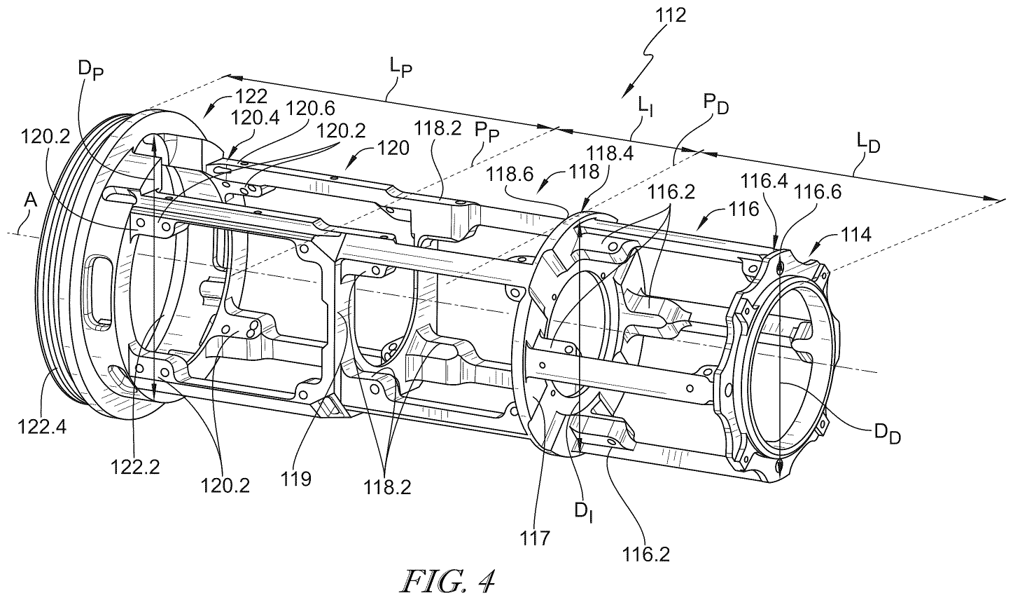

As shown in FIGS. 3 and 4, the forearm frame 112 includes: (i) a wrist portion, distal end, or second end 114, (ii) a third or distal mounting portion 116, (iii) a second or intermediate mounting portion 118, (iv) a first or proximal mounting portion 120, and (v) an elbow portion, proximal end, or first end 122. The elbow end portion 122 is configured to couple to the elbow assembly 150 using: (i) either or both an interior portion 122.2 and/or a threaded exterior portion 122.4, and/or (ii) any other suitable means. The proximal mounting portion 120 extends from the elbow end portion 122 toward the wrist end portion 114 and stops at a proximal plane P_{P} that is positioned in the middle of a lower intermediate wall 119 that extends on the interior of the frame 112. The distal mounting portion 116 is configured to couple to the wrist assembly 550 and extends from the wrist end portion 114 toward the elbow end portion 122, while stopping at a distal plane P_{D} that is positioned in the middle of an upper intermediate wall 117 that extends on the interior of the frame 112. Based on this configuration, the intermediate mounting portion 118 is located between and interconnects the distal mounting portion 116 and the proximal mounting portion 120. As such, said intermediate mounting portion 118 extends between the proximal plane P_{P} and the distal plane P_{D} or between the middle of the lower intermediate wall 119 and the middle of the upper intermediate wall 117. To note, an extent of the lower intermediate wall 117 is omitted to allow for a larger actuator H1 to be positioned within the intermediate mounting portion 118 in comparison to the other actuators H2 contained within the intermediate mounting portion 118.

The distal, intermediate, and proximal mounting portions 116, 118, and 120 of the forearm frame 112 are configured to couple the plurality of actuators 130 and the components of the electronics package 140 therein. At least one control board 140.2 included in the electronics package 140 is coupled within each of the distal, intermediate, and proximal mounting portions 116, 118, and 120 and is configured to control the actuators 130 coupled in the respective sections 116, 118, and 120. The encoder 140.4 included in the electronics package 140 is attached within the elbow end portion 122. It should be understood that additional or fewer control boards and/or encoders may be coupled to the frame 112 at different portions or locations of the frame 112.

As shown in FIGS. 3, 4, and 45, the distal, intermediate, and proximal mounting portions 116, 118, and 120 have axial lengths. The distal mounting portion 116 has a first length LD defined between the wrist end portion 114 and the distal plane P_{D}. The intermediate mounting portion 118 has a second length L_{I} defined between the distal plane P_{D} and the proximal plane P_{P}. The proximal mounting portion 120 has a third length L_{P} defined between the proximal plate P_{P} and the elbow end portion 122.

As shown in FIGS. 3, 4, and 45, the frame 112, the lower arm assembly 28, 1028, and a major portion of the arm 5, 1005 has a tapered configuration. This tapered configuration causes the wrist 550 or an extent of the distal mounting portion 116 to have a distal perimeter, circumference, and/or diameter D_{D} at a first location 116.4, and wherein said distal perimeter, circumference, and/or diameter D_{D} extends from a first outermost distal point 116.6 that is positioned on an outer surface of the frame 112 in the distal portion 116 to an opposed second outermost distal point 116.8 that is positioned on an opposed surface of the frame 112. Additionally, the intermediate mounting portion 118 has an intermediate perimeter, circumference, and/or diameter D_{I} at a second location 118.4, and wherein said intermediate perimeter, circumference, and/or diameter D_{I} extends from a first outermost intermediate point 118.6 that is positioned on an outer surface of the frame 112 in the intermediate portion 118 to an opposed second outermost intermediate point 118.8 that is positioned on an opposed surface of the frame 112. Further, the proximal mounting portion 120 has a proximal perimeter, circumference, and/or diameter D_{P} at a third location 120.4, and wherein said proximal perimeter, circumference, and/or diameter D_{P} extends from a first outermost proximal point 120.6 that is positioned on an outer surface of the frame 112 in the proximal portion 120 to an opposed second outermost proximal point 120.8 that is positioned on an opposed surface of the frame 112. As such, the proximal perimeter, circumference, and/or diameter D_{P} is significantly less than 100 mm and preferably less than 70 mm. The distal perimeter, circumference, and/or diameter D_{D} is less than the intermediate perimeter, circumference, and/or diameter D_{I}, and both are less than the proximal perimeter, circumference, and/or diameter D_{P}. In other words, the proximal perimeter, circumference, and/or diameter D_{P} is larger than the intermediate perimeter, circumference, and/or diameter D_{I}, which is larger than the distal perimeter, circumference, and/or diameter D_{D}. Finally, the first location 116.4 is closer to the wrist 550 than the second location 118.4, and the second location 118.4 is closer to the wrist 550 than the third location 120.4. In other words, the first location 116.4 is located at a first location or distance from the elbow assembly 150, while the second location 118.4 is located at a second location or distance from the elbow assembly 150, and wherein the second distance is less than the first distance. Likewise, the second location 118.4 is located at a second location or distance from the elbow assembly 150, while the third location 120.4 is located at a third location or distance from the elbow assembly 150, and wherein the third distance is less than the second distance.

As shown in FIGS. 3 and 4, the plurality of actuators 130 that are coupled to the mounting portions 116, 118, and 120 of the forearm frame 112 include twelve separate and distinct actuators. These twelve actuators 130 can be split into two main groups: (i) a first group that contains a single direct-drive actuator (e.g., non-tendon based) actuator 136 designed to control the twisting of the lower forearm 46, 1046 and the hand assembly 200 in a clockwise and counter-clockwise manner, and (ii) a second group that contains eleven rotary actuators 132, 134 that are designed to interface with the tendon assembly 600 to control the movement of the joints in the hand assembly 200 and the wrist 50, 1050. The actuator 136 of the first group is coupled to the proximal mounting portion 120 of the forearm frame 112, while the actuators 132, 134 of the second group are distributed among each of the mounting portions 116, 118, and 120 of the frame 112. In particular, the second group includes four actuators 134 that are coupled to the distal mounting portion 116, four actuators (a combination of actuators 132 and 134) that are coupled to the intermediate mounting portion 118, and three actuators 132 that are coupled to the proximal mounting portion 120. It should be understood that in other embodiments, each portion of the frame 112 may include additional actuators (e.g., 5-7) or may contain fewer actuators (e.g., 0-3). This is specifically true if actuators are moved out of the lower forearm 46, 1046 and into the hand assembly 200 or into a region positioned between the lower forearm 46, 1046 and the upper forearm 40, 1040. Some of the contemplated alternative embodiments are disclosed in other sections.

As shown in at least FIGS. 3, 4, 44, 45, the formation of the three mounting portions 116, 118, and 120 of the frame 112 is also associated with three distinct arrangements of said actuators 130—namely, a proximal actuator arrangement, first plurality of actuators, or a proximal plurality of actuators 130.2, an intermediate actuator arrangement, third plurality of actuators, or an intermediate plurality of actuators 130.4, and a distal actuator arrangement, second plurality of actuators, or a distal plurality of actuators 130.6. The first plurality of actuators or proximal arrangement of actuators 130.2 are arranged radially around the forearm axis A in the proximal mounting portion 120. Said first plurality of actuators or proximal arrangement of actuators 130.2 includes four actuators of the H1 size 132, wherein each of the four H1 actuators have upper and lower surfaces 130.2.4, 130.2.6 that are coplanar with one another. Additionally, the four H1 actuators contained in the proximal arrangement of actuators 130.2 have rotational axes A_{P} that are parallel to one another, equally spaced around the forearm axis A, and parallel with said forearm axis A. Further, a first actuator 130.2.2 contained in the first plurality of actuators 130.2 is in contact with a first tendon 610.2 and includes a first tendon departure region 612, wherein the first tendon departure region 130.2.8 is positioned at a location where the tendon 610.2 extends above an upper surface 130.2.4 of the first actuator 130.2.2.

The second plurality of actuators or distal arrangement of actuators 103.6 are arranged radially around the forearm axis A in the distal mounting portion 116. Said second plurality of actuators or distal arrangement of actuators 130.6 includes four actuators of the H2 size 134, wherein each of the four H2 actuators have upper and lower surfaces 130.6.4, 130.6.6 that are coplanar with one another. Additionally, the four H2 actuators contained in the distal arrangement of actuators 130.6 have rotational axes A_{P} that are parallel to one another, equally spaced around the forearm axis A, and parallel with said forearm axis A. Further, a second actuator 130.6.2 contained in the second plurality of actuators 130.6 is in contact with a second tendon 610.4 and includes a second tendon departure region 130.6.8, wherein the second tendon departure region 130.6.8 is positioned at a location where the tendon 610.4 extends above an upper surface 130.6.4 of the second actuator 130.6.2. While the first tendon departure region 130.2.8 is positioned at a first distance D_{F} from the wrist assembly 550 and the second tendon departure region 130.6.8 is positioned at a second distance D_{S} from the wrist assembly 550, and wherein the first distance D_{F} is not equal (specifically larger) to the second distance D_{S}.

Finally, the third plurality of actuators or intermediate arrangement of actuators 130.4 are arranged radially around the forearm axis A in the intermediate mounting portion 118. Said third plurality of actuators or intermediate arrangement of actuators 130.4 includes three H2 actuators 134 and one H1 actuator 132, wherein each of the three H2 actuators and one H1 actuator have upper and lower surfaces 130.4.4, 130.4.6. While the upper surfaces of all four actuators are coplanar with one another, said lower surfaces 130.4.6 of all four actuators are not coplanar with one another. Nevertheless, the three H2 actuators and one H1 actuator contained in the intermediate arrangement of actuators 130.4 have rotational axes A_{I} that are parallel to one another and parallel with said forearm axis A. Further, a third actuator 130.4.2 contained in the third plurality of actuators 130.4 is in contact with a third tendon 610.6 and includes a third tendon departure region 130.4.8, wherein the third tendon departure region 130.4.8 is positioned at a location where the tendon 610.6 extends above an upper surface 130.4.4 of the third actuator 130.4.2. The third tendon departure region 130.4.8 is positioned at a third distance D_{T} from the wrist assembly 550, and wherein the third distance D_{T} is not equal to either the first or second distances D_{F}, D_{S}. Specifically, the third distance D_{T} is larger than the second distance D_{S}, but smaller than the first distance D_{F}. It should be understood that rotational axes A_{P}, A_{I} A_{P} are not co-linear with each other. The radial arrangement of rotational axes A_{P}, A_{I} A_{P} with decreasing perimeters, circumferences, and/or diameters relative to each other as one moves from the proximal extent or the proximal mounting portion 120 of the frame 112 to the distal extent or distal mounting portion 116 of the frame 112 enables the perimeter, circumference, and/or diameter of the forearm to be reduced as one moves from the proximal extent 120 of the frame 112 to the distal extent 116 of the frame 112. This enables the radial distance to the exterior surfaces of the arrangement of actuators to decrease as one moves from the proximal extent 120 of the frame 112 to the distal extent 116 of the frame 112.

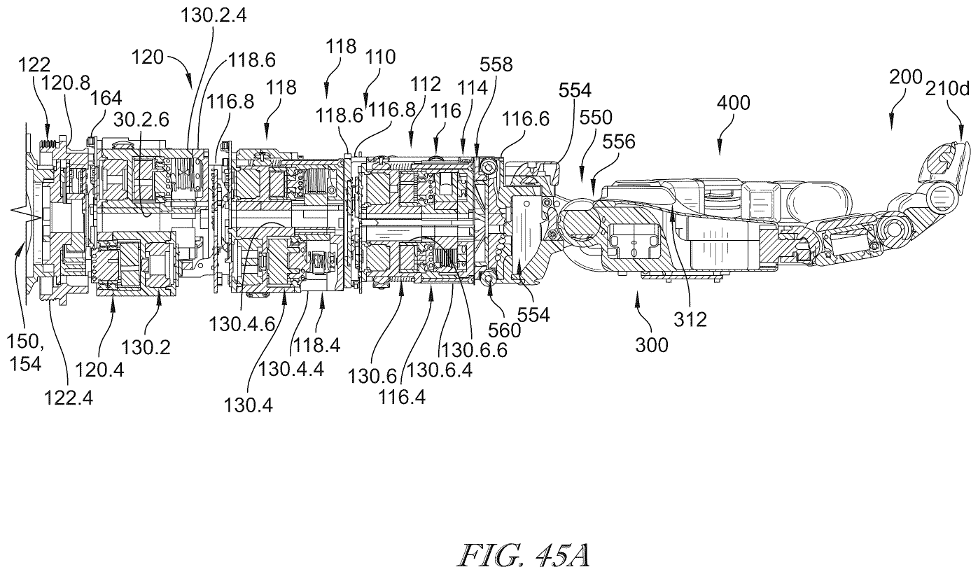

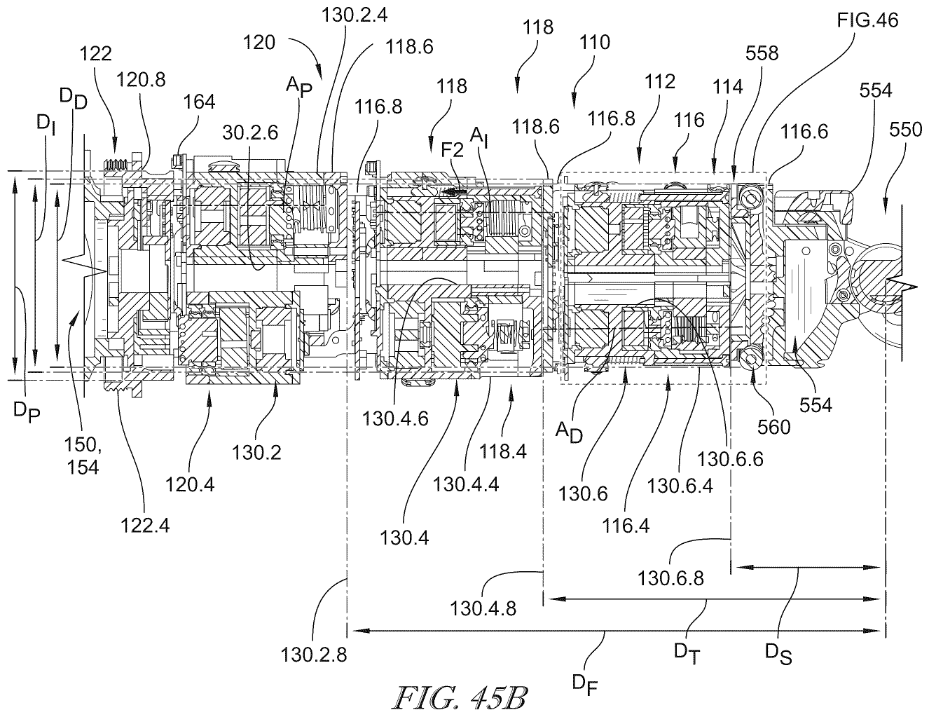

As best shown in at least FIG. 45, the upper or outer and lower or inner surfaces 130.2.4, 130.2.6, 130.6.4, 130.6.6 of the actuators in the proximal and distal arrangements 130.2, 130.6 generally include at least a portion that is arranged perpendicular to the forearm or longitudinal axis A of the forearm frame 112. Additionally, the positioning of the tendon departure regions 130.2.8, 130.4.8, 130.6.8, the extent of the actuators that are closest to the wrist assembly 550 (e.g., upper extent), an extent of the actuators that are farthest way from the wrist assembly 550 (e.g., lower extent), or any other consistent measurement will indicate that the actuators have an offset, stacked rearward, or longitudinal arranged configuration. This is discussed above by the fact that the third distance D_{T} is larger than the second distance D_{S}, but smaller than the first distance D_{F}. This longitudinal stacking (e.g., closer/further way from the wrist assembly 550) enables the lower arm assembly 28, 1028, and a major portion of the arm 5, 1005 to have a tapered configuration. In other words, the first (e.g., proximal) plurality of actuators 130.2 are generally positioned farthest away from the wrist assembly 550 and closest to the elbow assembly 150, the second (e.g., distal) plurality of actuators 130.6 are generally positioned farthest way from the elbow assembly 150 and closest to the wrist assembly 550, and the third (e.g., intermediate) plurality of actuators 130.4 are positioned between the first plurality of actuators and the second plurality of actuators 130.2, 130.6. Additionally, the first (e.g., proximal) plurality of actuators 130.2 is positioned radially or laterally outward of the third (e.g., intermediate) plurality of actuators 130.4, while the third (e.g., intermediate) plurality of actuators 130.4 is positioned radially or laterally outward of the second (e.g., distal) plurality of actuators 130.6. This combination of longitudinal and radial stacking is externally beneficial because it provides access to run the tendons without interference with other actuators and a tapered design. The combined radial and longitudinal stacking arrangement provides a benefit over arrangements that are only either radially stacked or longitudinally stacked, but not both. The latter non-combined arrangements would undesirably require a large forearm.

The actuators 130 contained within the first (e.g., proximal) plurality of actuators 130.2 and coupled to the proximal mounting portion 120 may each be configured to provide a force on the end effector 200 via a corresponding tendon. Similarly, the actuators 130 contained within the second (e.g., distal) plurality of actuators 130.6 and coupled to the distal mounting portion 116 may each be configured to provide a force on the end effector 200 via a corresponding tendon, and the actuators 130 contained within the third (e.g., intermediate) plurality of actuators 130.4 and coupled to the intermediate mounting portion 118 may each be configured to provide a force on the end effector 200 via a corresponding tendon. The force applied by each (or at least one) of those actuators individually in the first (e.g., proximal) plurality of actuators 130.2 may be greater than the force applied by each (or at least one) of those actuators 130 individually in the second (e.g., distal) plurality of actuators 130.6 and the third (e.g., intermediate) plurality of actuators 130.4. Additionally, the force applied by each (or at least one) of those actuators individually in the third (e.g., intermediate) plurality of actuators 130.4 may be greater than the force applied by each (or at least one) of those actuators 130 individually in the second (e.g., distal) plurality of actuators 130.6.

As shown in the Figures, the lower forearm 46, 1046 does not include more than 12 actuators 130 to control the at least 9 disclosed degrees of freedom. It should be understood that in other embodiments, the configuration of the actuators may not have decreasing exterior surfaces, or the rotational axes may be co-linear or coplanar with each other. Further, the actuators 130 contained within the frame 112 may not be positioned in the precise manner disclosed here. Instead, the actuator mounts 116.2, 118.2, and 120.2 may have an alternative arrangement so that said actuators 130 may be offset vertically or horizontally from one another within a single arrangement. Additionally or alternatively, the rotational axes of the actuators 130 may not extend along the longitudinal axis A of the forearm assembly 110, but instead may be arranged perpendicular to said longitudinal axis A.

b. Actuators of the Forearm Assembly

The twelve actuators 130 that are contained in the forearm assembly 110 and coupled to the forearm frame 112 may include two different sizes of rotary actuators-namely, a first size (H1) 132 and a second size (H2) 134, in addition to one direct-drive actuator (e.g., non-tendon based) actuator 136. In the disclosed design, the frame 112 is designed to accommodate the following actuators, wherein the second or distal mounting portion is designed to house the actuators that control portions of each finger, the third or intermediate mounting portion is designed to house actuators that control portions of the wrist, thumb, and index finger, and the first or proximal mounting portion is designed to house actuators that control the thumb and wrist. The positioning of the actuators may be based on: (i) local or total curvature of the tendons, (ii) length of the tendon, (iii) forces exerted by the that portion of the end effector (e.g., thumb may need to exert a larger amount of force in comparison to the little finger), (iv) acceleration of the end effector. In particular, it may be beneficial to position the actuator associated with the thumb rearward of the actuator associated with the little finger to help minimize local or total curvature of the tendon associated with the thumb in comparison to the little finger, as a reduction in local or total curvature can allow for an increase force that the tendon can transfer to the moving structure (e.g., thumb or little finger).

While the rotary or cycloidal actuators 132, 134 share a common cross-sectional design, they differ primarily in physical dimensions and torque. The first or larger size actuator (H1) 132 can produce a max peak torque output between 2 and 10 Nm, preferably between 3 and 7 Nm and has a perimeter, circumference, and/or diameter of 29 mm or less and a height of 49 mm or less, while the second or smaller size actuator (H2) 134 can produce a max peak output torque output between 0.5 and 3 Nm, preferably between 0.75 and 2 Nm and has a perimeter, circumference, and/or diameter of 22 mm or less and a height of 47 mm or less.

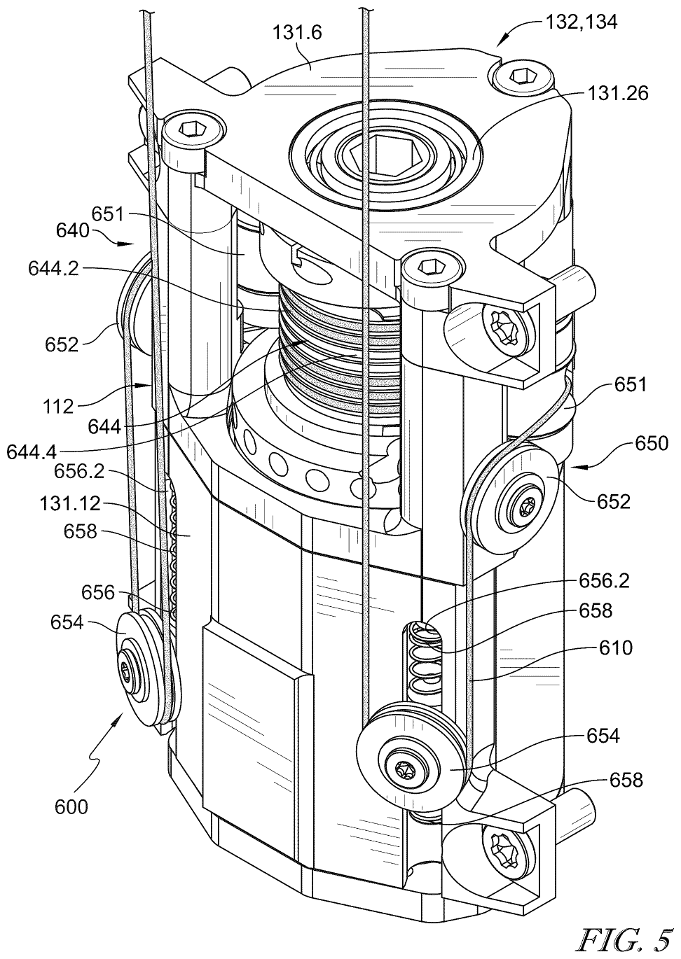

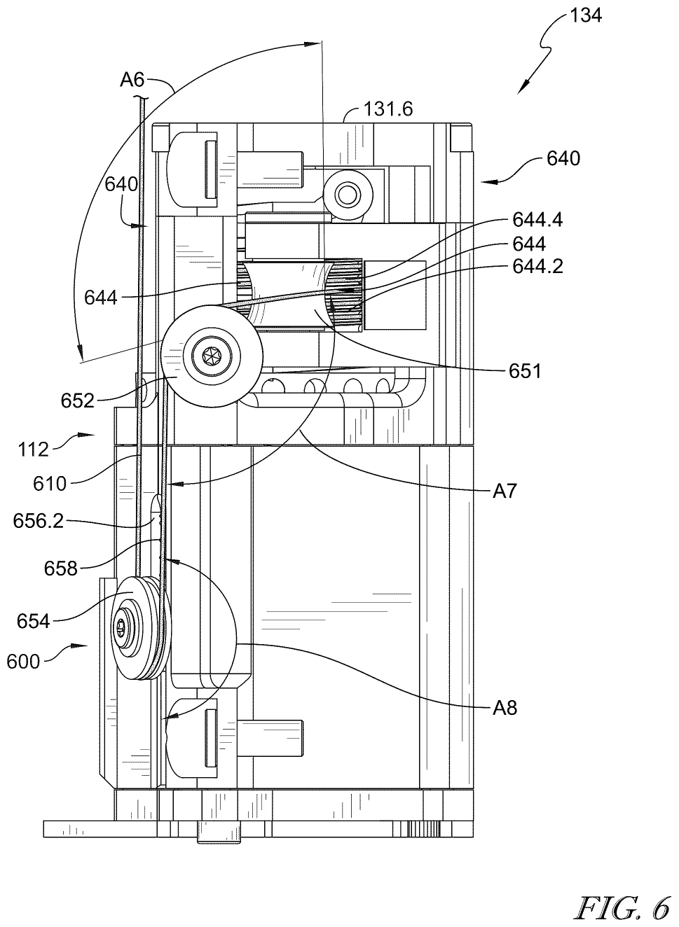

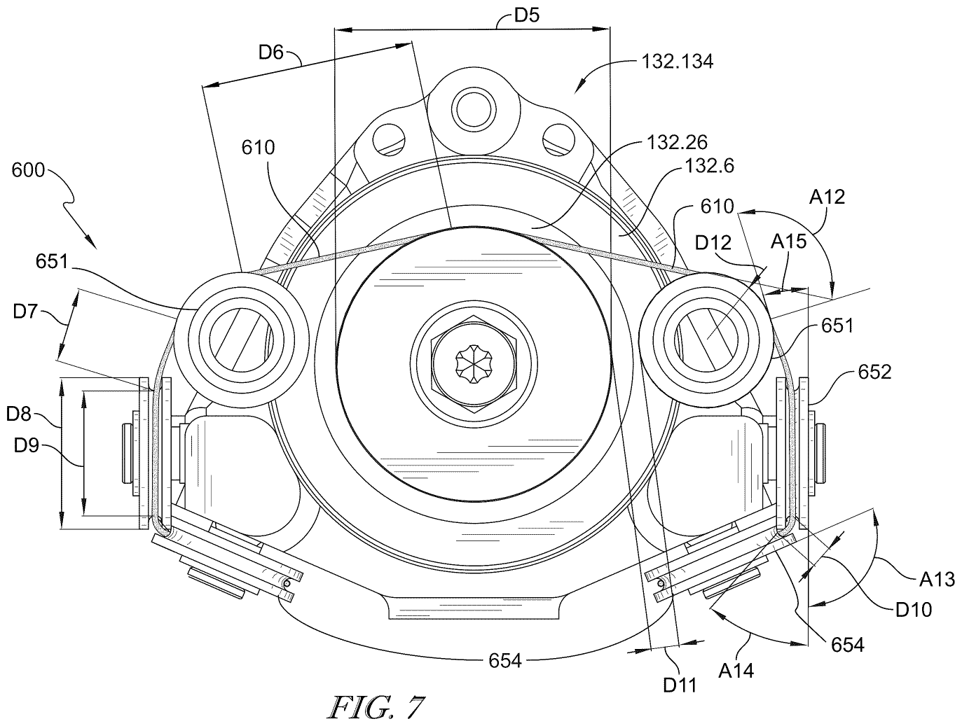

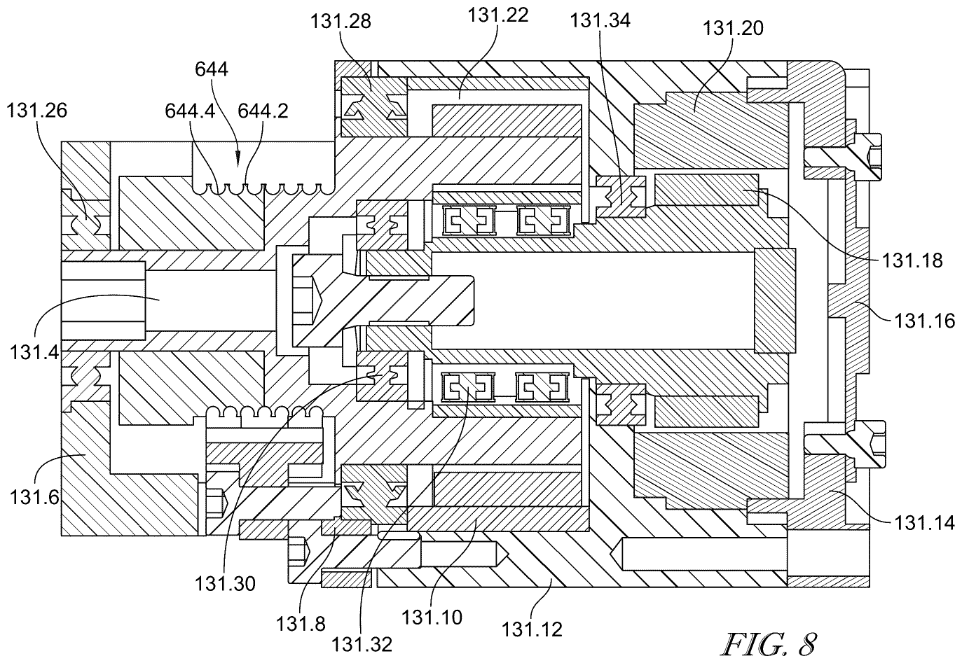

As shown in FIGS. 5-9, each rotary or cycloidal actuator 132, 134 includes: (i) an output shaft 131.4, (ii) an output cap 131.6, (iii) a retaining cap 131.8, (iv) a cycloidal spline 131.10, (v) an actuator housing 131.12, (vi) a motor retaining cap 131.14, (vii) a motor controller 131.16, (viii) a motor 131.20, (ix) a single-stage cycloidal disc 131.22, and (x) output bearings 131.26, 131.28. The H1 actuator 132 can produce between 3.5 and 5 Nm continuous torque output or more with its single-stage cycloidal disc 131.22, motor 131.20, and motor controller 131.16. The single cycloidal disc 131.22 has external gear teeth or lobes. The cycloidal spline 131.10 has internal gear teeth or pins. The cycloidal disc 131.22 and the cycloidal spline 131.10 contact each other at the gears or lobes and pins.

Unlike conventional actuators, the disclosed rotary or cycloidal actuators 132, 134 employ a single cycloidal disc 131.22. Specifically, said actuators 132, 134 include an input shaft that may be driven by any known type of motor with any combination of stator and rotor. As such, said motor 131.20 may be any one of various motor types, including brushless DC motors, stepper motors, servo motors, coreless DC motors, synchronous AC motors, asynchronous induction motors, linear motors, piezoelectric motors, direct-drive motors, switched reluctance motors, permanent magnet synchronous motors (PMSMs), axial flux motors, and hybrid stepper motors. The disclosed motors of the actuators 132, 134 may include a stator and a rotor. Said stator may include support components that are segmented in a radial direction or in a stacked or horizontal direction. The support components may be made from or include a metallic or metallic-based material, which includes electrical steel (i.e., silicon steel), non-oriented electrical steel including 0.5% to 3.25% silicon, a nickel-iron alloy, such as Permalloy (45% Ni, 55% Fe) or Supermalloy (79% Ni, 16% Fe, 5% Mo), a cobalt-iron alloy, such as Permendur (49% Co, 49% Fe, 2% V), one or more amorphous metals, one or more soft magnetic composites (SMC), and/or a combination of these and/or other similar materials. The motor windings may use or include round or flat wires and may implement a random approach, a layered approach, a quadrature approach, or any other approach. The windings may use aluminum or high-conductivity copper wire with advanced ceramic or polyimide insulation for superior thermal and electrical performance.

The rotor of the motor 131.20 may or may not be segmented and may include or be comprised of materials such as: (i) neodymium-iron-boron (NdFeB), (ii) samarium-cobalt (SmCo), (iii) alnico (Aluminum-Nickel-Cobalt), (iv) bonded magnets (e.g., Bonded NdFeB and Bonded Ferrite), (v) iron-chromium-cobalt (FeCrCo), (vi) cobalt-platinum (CoPt) and iron-platinum (FePt), (vii) hexaferrites (e.g., BaFe, SrFe), (viii) manganese-aluminum (MnAl), (ix) any combination thereof, and/or (x) any other similar material or material that one of skill in the art may use in said magnets. Further, said motors 131.20 may be packed with a potting material after they are installed within their housings to improve thermal dissipation and structural integrity. The potting material may include or be comprised of: (i) an epoxy resin, (ii) a polyurethane resin, (iii) a silicone resin, (iv) an acrylic resin, (v) a ceramic-based potting compound, and/or a combination thereof.

The motor 131.20 can be operatively coupled to at least one eccentric bearing assembly 131.32. The eccentric bearing assembly 131.32 imparts an orbital motion, which is characterized by an eccentricity ‘e’, to the single cycloidal disc 131.22 as the input shaft rotates about its primary axis. The cycloidal disc 131.22 features a peripheral profile that is defined by a plurality of lobes, which are commonly based on epitrochoidal or hypotrochoidal curves generated relative to the stationary gear component. This lobed profile of the disc meshingly engages with a plurality of pins, rollers, or teeth that are disposed on a stationary ring gear, often referred to as a cycloidal spline 131.10, which is fixed relative to the actuator housing 131.12. The cycloidal spline 131.10 can be a hollow cylindrical structure having internal gears or pins that extend across its thickness. The single cycloidal disc 131.22 can also be a hollow cylindrical structure having external gears or lobes that extend across its thickness. The cycloidal disc 131.22 can also have four cylindrical holes that extend through the thickness of the disc 131.22. The output shaft assembly can have a cylindrical output shaft 131.4 coupled to one side of a disc and four cylindrical rollers that extend from the opposite side. The output shaft 131.4 and the four cylindrical rollers can be oriented perpendicular to the planar end surfaces of the disc. When assembled, the cycloidal disc 131.22 is placed within the cycloidal spline 131.10, and the four cylindrical rollers are placed through the four corresponding holes in the cycloidal disc 131.22. In other embodiments, any other number of cylindrical rollers and holes can be used in the cycloidal actuator design.

The mechanism of speed reduction arises from the differential kinematics between the orbiting cycloidal disc 131.22 and the stationary ring gear. Typically, the number of lobes on the cycloidal disc differs by a small integer (e.g., one) from the number of pins or rollers in the stationary ring gear. As the eccentric bearing 131.32 drives the disc 131.22 through its orbital path, the difference in lobe count forces the disc to precess, executing a slow rotation relative to the stationary ring gear, typically in the direction opposite to the input shaft's rotation. The magnitude of this speed reduction is determined by the number of lobes on the disc and the number of pins or rollers on the ring gear. Torque is transmitted from the precessing cycloidal disc 131.22 to an output member via a plurality of output rollers or pins. These output rollers are typically mounted on an output flange or disc (which is coupled to the actuator's output shaft 131.4) and pass through corresponding apertures, such as precisely bored holes, within the body of the cycloidal disc 131.22. This arrangement allows the output rollers to accommodate the orbital motion of the disc while transmitting only its slow, high-torque rotational component to the output shaft.

Conventional single-disc cycloidal actuators often suffer from a dynamic imbalance. This imbalance results from the center of mass of the cycloidal disc and its associated eccentric components orbiting the input shaft's axis of rotation at the input angular velocity. This imbalance generates a rotating centrifugal force vector, the magnitude of which increases quadratically with input speed. This can potentially cause significant vibration, acoustic noise, increased bearing loads, reduced positioning accuracy, and component fatigue. To address this issue, the disclosed actuators 132, 134 incorporate specific design features. One such feature involves optimizing the profile of the cycloidal disc itself, potentially by utilizing a shortened cycloid profile. Said shortened cycloid profile may be characterized by lobes that are smoother and possess less radial height compared to a standard cycloidal profile. The less aggressive geometry of these shortened lobes potentially allows for proper meshing and load transmission with the ring gear pins, even when the overall orbital path, and thus the driving eccentricity, is decreased. To maintain a specific desired gear reduction (which requires keeping the same number of lobes on the disc) while simultaneously reducing the eccentricity, the fundamental geometric parameters that define the profile must be adjusted in a coordinated manner, typically involving proportional scaling. The inherent smoothness and reduced radial extent of the shortened cycloid profile can make it more tolerant of such adjustments, potentially enabling effective gear operation under lower eccentricity conditions where a standard profile might encounter interference or inadequate engagement. Specific embodiments may utilize an eccentricity offset of approximately 0.05 mm to 0.3 mm, and lobe or pin perimeters, circumferences, and/or diameters or maximum thicknesses between 0.1 mm and 0.6 mm.

Furthermore, the dynamic imbalance can be actively counteracted by incorporating balancing features into the rotating input shaft assembly. In one embodiment, the input shaft is counterbalanced by precisely offsetting its central bore relative to its axis of rotation, for instance, by an offset distance that is equal to the disc eccentricity (e.g., 0.1-0.6 mm). This offset may be oriented towards the direction of the eccentric bearing's maximum throw to preferentially remove mass from the heavier side of the rotating assembly. Alternatively, or in conjunction with other methods, counterbalancing can be achieved by adding discrete counterweights, potentially made of high-density materials, to the input shaft at a location diametrically opposite to the primary imbalance vector created by the eccentric bearing and disc. Conversely, mass can be strategically removed from the input shaft, such as by drilling blind or through-holes, or by creating machined cutouts in the portion of the shaft that is aligned with the eccentric offset. These balancing features are configured to shift the center of mass of the combined input shaft, eccentric bearing(s), and potentially associated hardware closer to the input shaft's axis of rotation, thereby minimizing the net rotating imbalance force. Depending on the axial distribution of mass, multi-plane dynamic balancing of the input shaft assembly may be employed for more precise correction.

Alternative or supplementary methods for addressing dynamic imbalance may also be contemplated. In one alternative, the cycloidal disc 131.22 itself could be designed with an asymmetric mass distribution, independent of its functional gear profile. This could be achieved by adding or removing material from its body to shift its intrinsic center of mass closer to its geometric center, or even partially towards the input axis, thereby reducing its contribution to the overall imbalance. Another approach involves incorporating passive or semi-active vibration damping mechanisms within the actuator structure or its mounting interface. This could also include the use of elastomeric elements strategically placed to isolate or absorb vibrations, or potentially tuned mass dampers designed to counteract vibrations at specific problematic frequencies, which are typically related to the input shaft speed.

To achieve a high gear ratio in the compact design of said actuators 132, 134 generally requires a small eccentricity value. For instance, a design targeting a 50:1 or greater gear ratio within a 25 mm outer perimeter, circumference, and/or diameter might necessitate an eccentricity as small as 0.05 mm to 0.3 mm. This small eccentricity, in turn, often dictates correspondingly small pin perimeters, circumferences, and/or diameters (e.g., potentially 0.1-0.6 mm). Such small pins concentrate the transmitted load onto diminutive surface areas, leading to significantly elevated stress concentrations on these critical load-bearing components. Furthermore, manufacturing components with the tight tolerances required for such small eccentricities is challenging; fabrication imperfections and tolerance stack-up can degrade performance, resulting in reduced output torque capability, increased backlash, and lower overall efficiency. To overcome these limitations, several design and material strategies may be employed. First, design modifications have been made to the actuators 132, 134 to help said actuators distribute the transmitted load more effectively. One approach involves increasing the axial width (or thickness) of the cycloidal disc, potentially doubling its width compared to conventional single-disc designs. This modification increases the contact area between the disc lobes and the spline features along the axial dimension. This increased contact surface helps to distribute the load over a larger material area, potentially keeping stresses below critical material limits (e.g., a design target of below 1130 MPa). Another synergistic approach involves designing the gear profile interaction such that the load is shared simultaneously across multiple points of contact (e.g., distributing the load between up to five pins or lobes in contact at any given time, analogous to load sharing in planetary gearsets). This significantly reduces the peak stress experienced by any single pin or lobe. Increasing the axial height of the pins themselves also contributes to a larger contact surface area. By strategically combining material selection (e.g., high hardness materials), increased component width, and multi-point load distribution, it is possible to realize high-performance rotary actuators that achieve substantial gear ratios (e.g., 58:1) within highly constrained package perimeters, circumferences, and/or diameters (e.g., 20 mm and 25 mm), overcoming the inherent challenges of stress concentration and manufacturability associated with miniaturized, high-ratio rotary drives.

In addition to the above modifications, specific materials and manufacturing methods have been utilized for the pins, rollers, and engaging surfaces of the disc and spline. Specifically, components of said actuators 132, 134 may include or be fabricated from SUJ2/AISI 52100, grade 440c, grade 420, 440m/cronidur 30 type, grade 410, grade 416, xd15nw/cronidur x15 type, xd16n, 17-4 PH/AISI 630, 15-5 PH, custom 455, custom 465, AISI 8630, AISI 4820, AISI 9310, AISI 4320, scm440/AISI 4140, AISI 4340, AISI 5160, S45c/AISI 1045, AISI 1050, AISI 1060, A2 tool steel, D2 tool steel, O1 tool steel, M2 tool steel, powder metallurgy (PM) tool steels, grade 303 stainless steel, grade 304 stainless steel, grade 316 stainless steel, TI-6AL-4V (grade 5 titanium), other titanium alloys, brass, phosphor bronze, aluminum bronze, cobalt-chromium alloys (stellite type), zirconia (ZrO₂), silicon nitride (Si3N4), alumina (Al2O3), silicon carbide (SiC), machinable glass-ceramic (macor type), polyetheretherketone (PEEK) (unfilled), polyetheretherketone (PEEK) (filled, bearing grade), acetal (POM) (delrin type), polyamide (PA/nylon), polyphenylene sulfide (PPS), polycarbonate (PC), polyamide-imide (PAI) (torlon type), polyimide (PI) (vespel type), or any combination thereof.

Additionally, components of said actuators 132, 134 may be manufactured using processes such as precision CNC machining (milling, turning), hard machining (hard turning, hard milling), electrical discharge machining (wire EDM, sinker EDM), micro powder injection molding (μ-MIM), UV-LIGA (lithography, electroplating, molding), laser machining, electrochemical machining (ECM), heat treatment including through hardening (quenching and tempering), case hardening (carburizing, nitriding, carbonitriding), precipitation hardening, cryogenic treatment, stress relieving, and tempering. Finishing processes may include precision profile grinding, creep feed grinding, surface grinding, cylindrical grinding, jig grinding, lapping, polishing, superfinishing, honing, precision deburring, ultrasonic cleaning, dimensional inspection, surface finish measurement (profilometry), hardness testing, or any combination thereof. As such, the actuators 132, 134 may have a hardness that is greater than 60 Rockwell hardness, a dimensional tolerance of +/−0.005 mm or less, and a surface finish of 16 Ra or less. These material properties reduce the friction coefficient while providing sufficient strength for a small (25 mm or less) perimeter, circumference, and/or diameter, high torque (5 Nm or more), high efficiency (80% or more) rotary actuator.

Further, the rotary actuators 132, 134 can have package sizes with perimeters, circumferences, and/or diameters of 25 mm and 20 mm or less. The H1 embodiment of the rotary actuator 132 can have a height that is between 30 mm and 60 mm and a perimeter, circumference, and/or diameter between 15 mm and 60 mm, with a peak output torque of approximately 5 Nm and an efficiency of 80% or more. The H2 embodiment of the rotary actuator 134 can have a height that is between 20 mm and 55 mm and a perimeter, circumference, and/or diameter between 12 mm and 55 mm, with a peak output torque of approximately 1.16 Nm and an efficiency of 80% or more. The disclosed design provides a significant advantage in efficiency over conventional designs. For example, a conventional harmonic drive can have an efficiency of approximately 10% at 1% of its maximum torque and approximately 83% efficiency at 100% of its maximum torque. A conventional planetary drive can have an efficiency of approximately 20% at 1% of its maximum torque and approximately 83% efficiency at 100% of its maximum torque. Li's cycloid drive can have an efficiency of 80% at 1% of its maximum torque and approximately 94% efficiency at 100% of its maximum torque. In contrast, the disclosed actuator system of actuators 132, 134 is designed to have a more uniform efficiency, potentially reaching 95% across a wide range of its maximum torque, from 1% to 100%.

### 2. End Effector or Hand Assembly

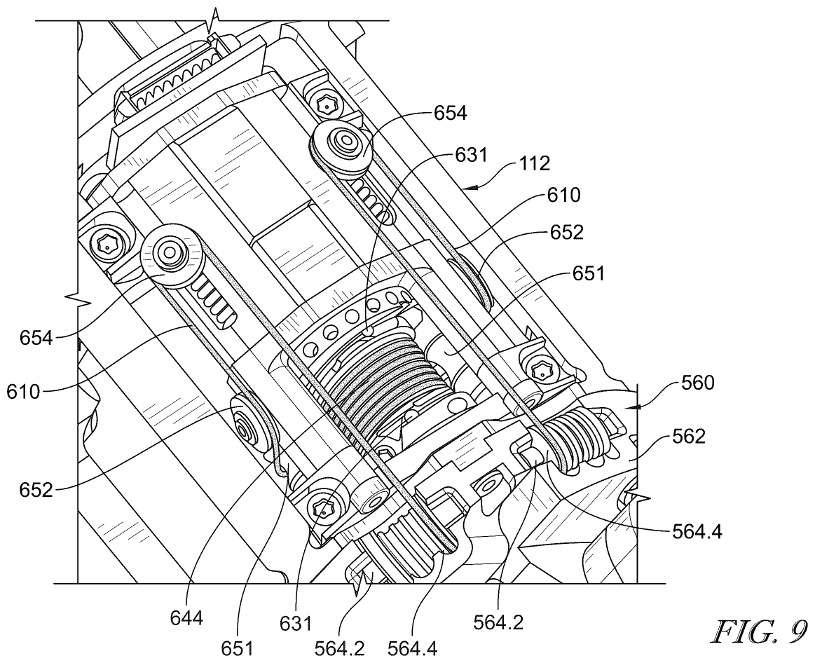

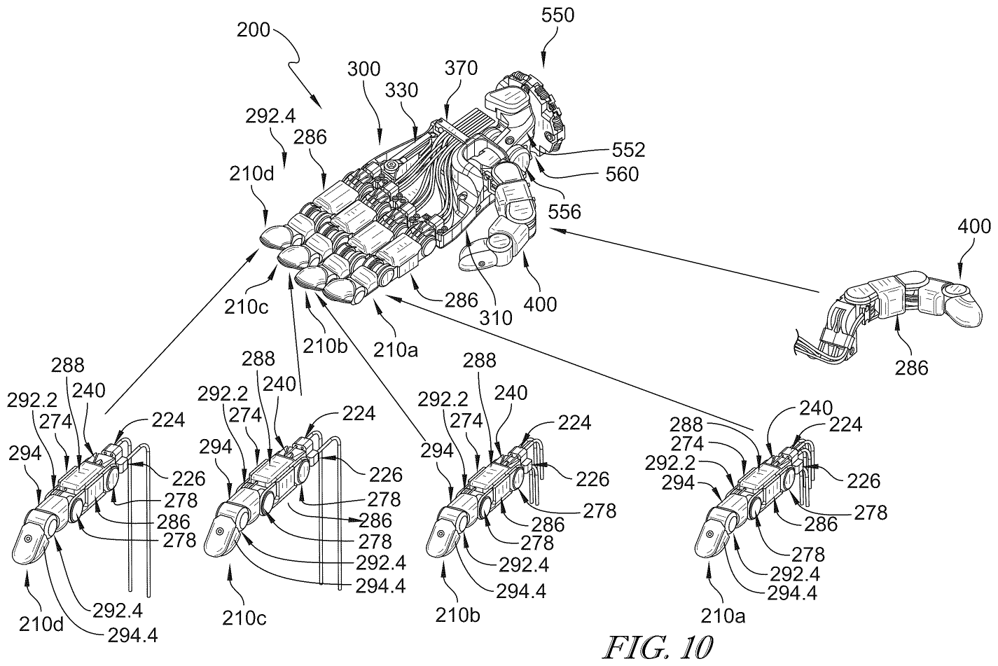

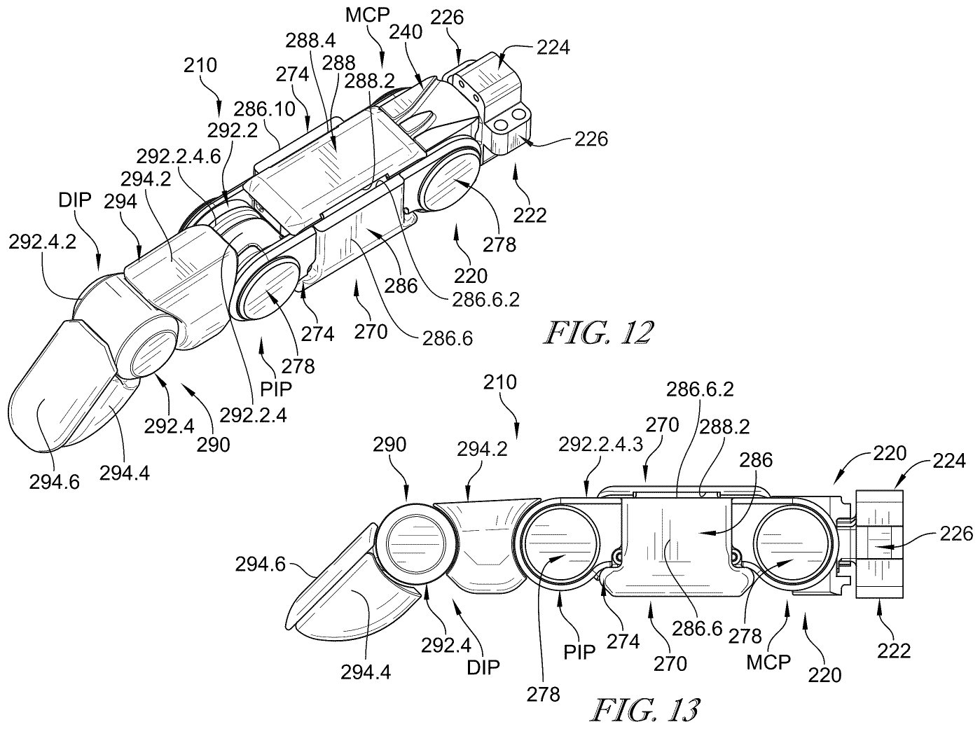

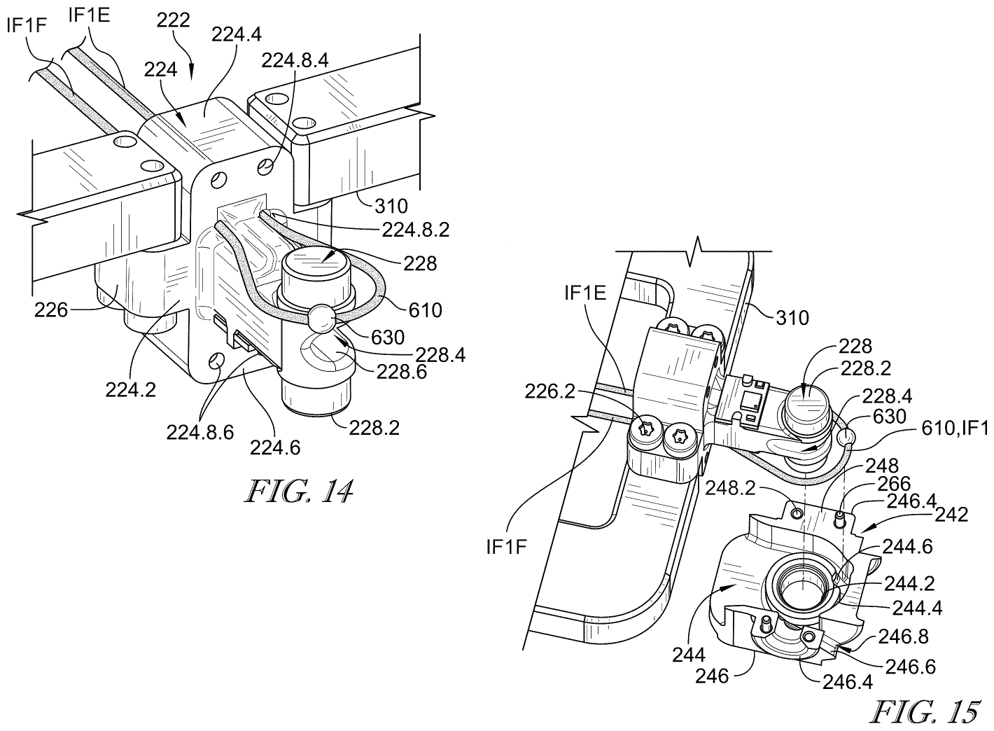

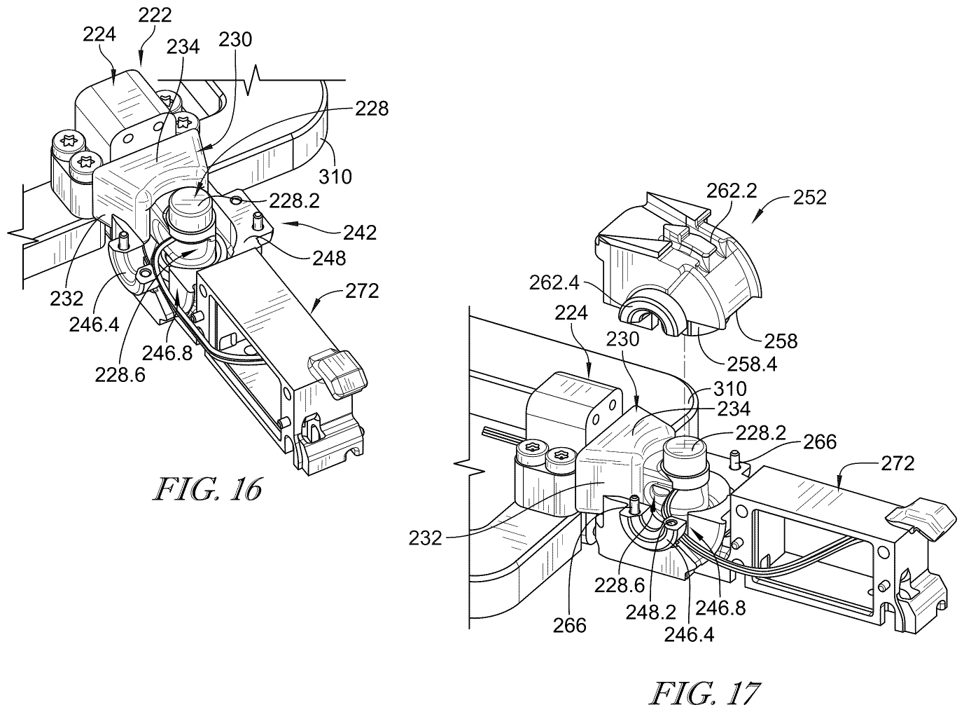

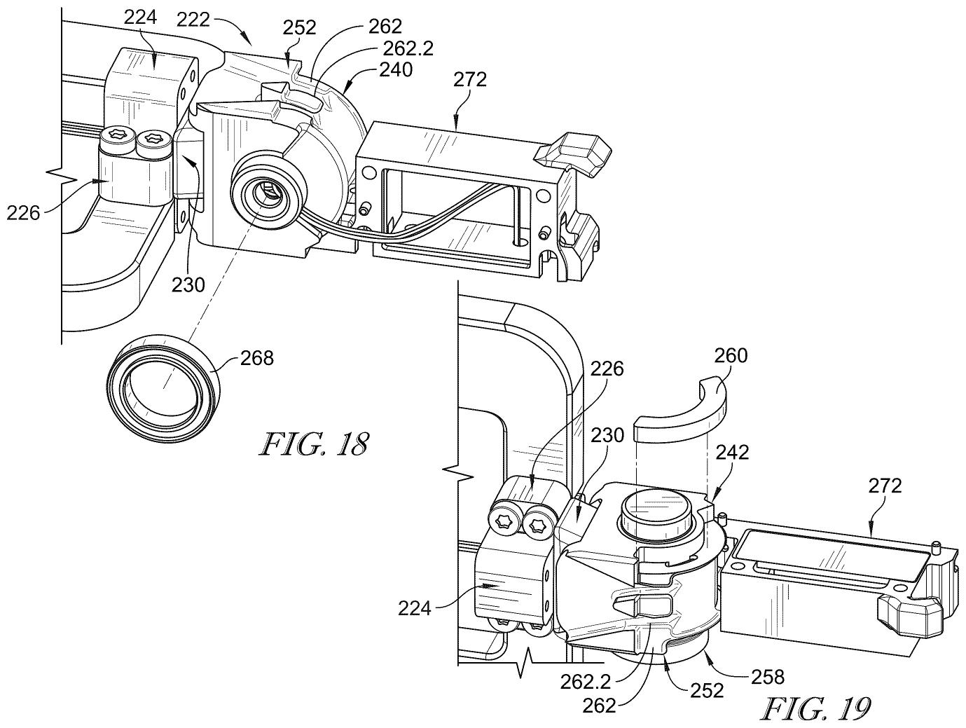

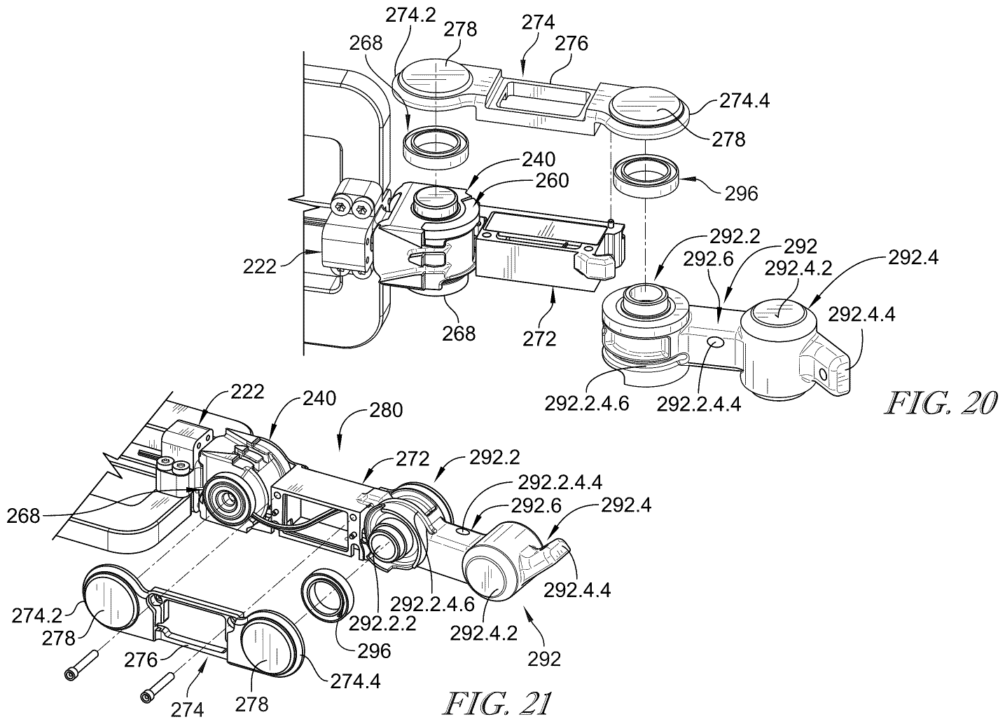

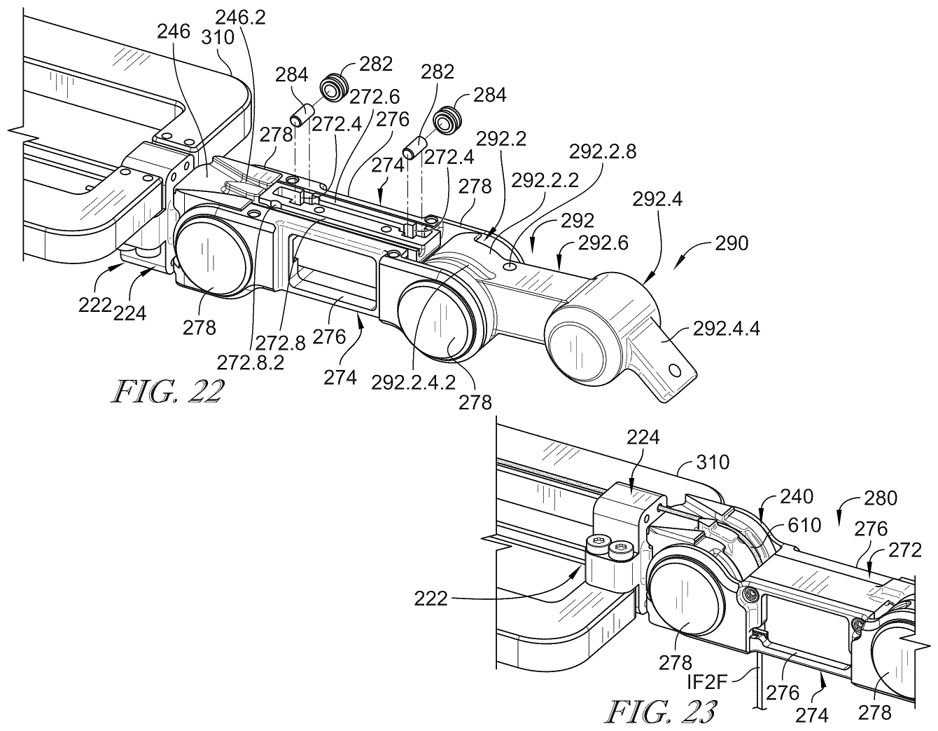

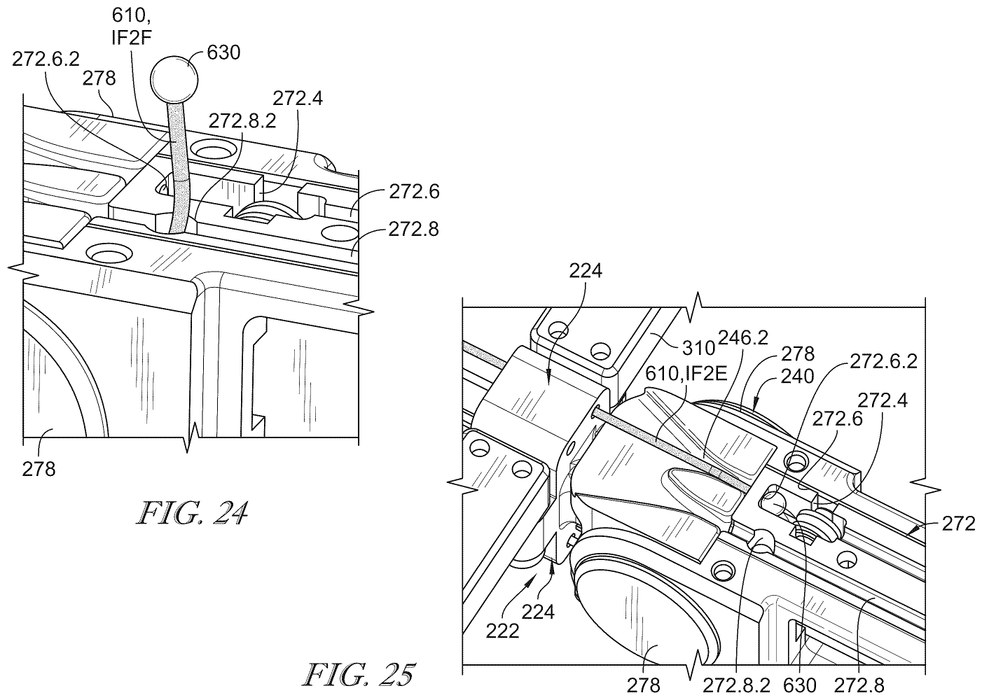

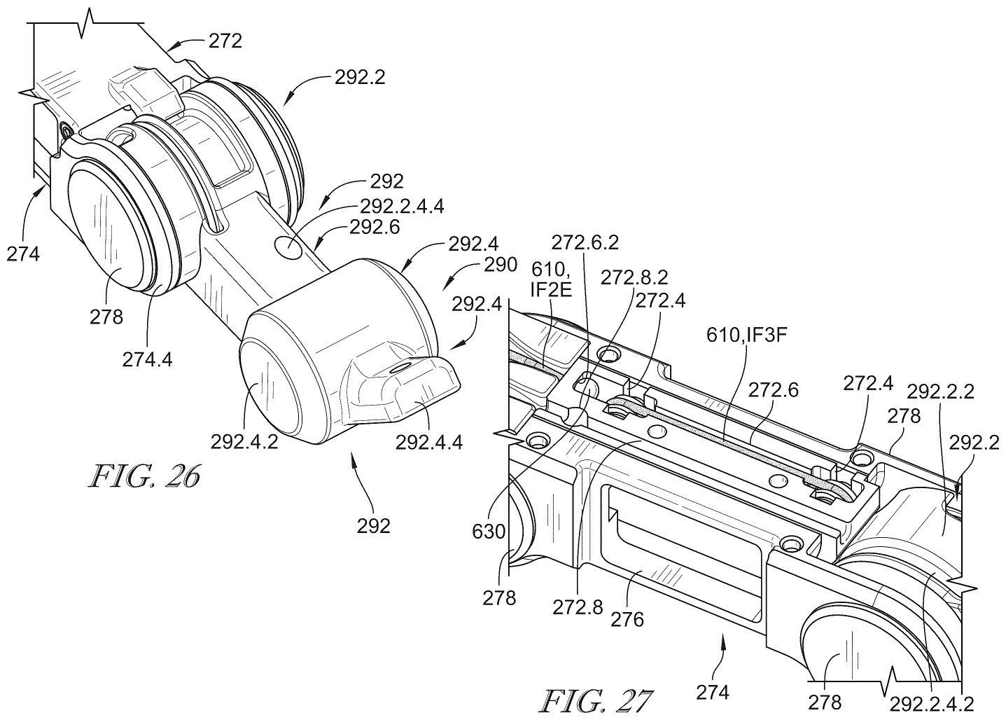

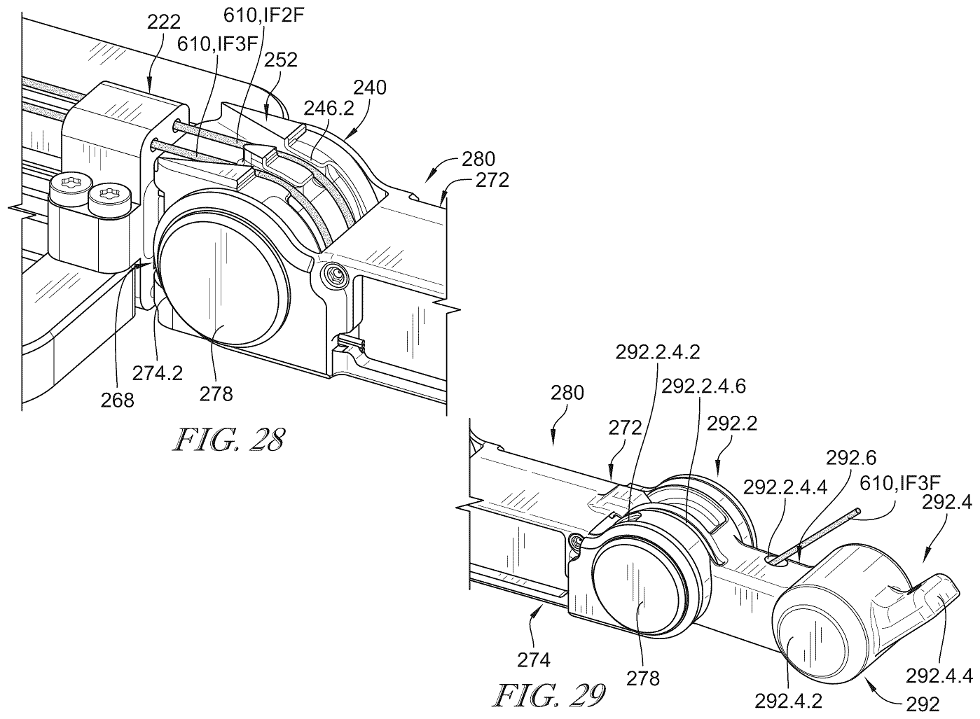

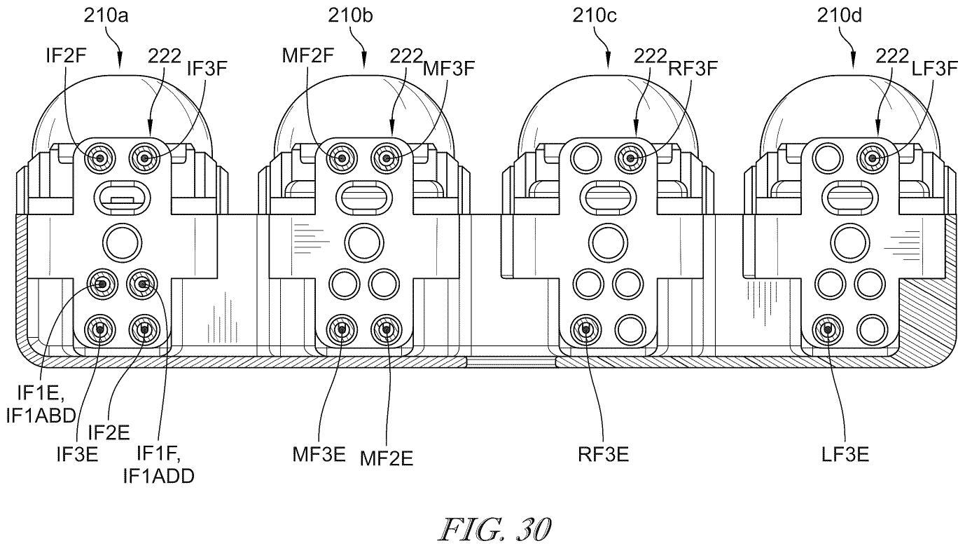

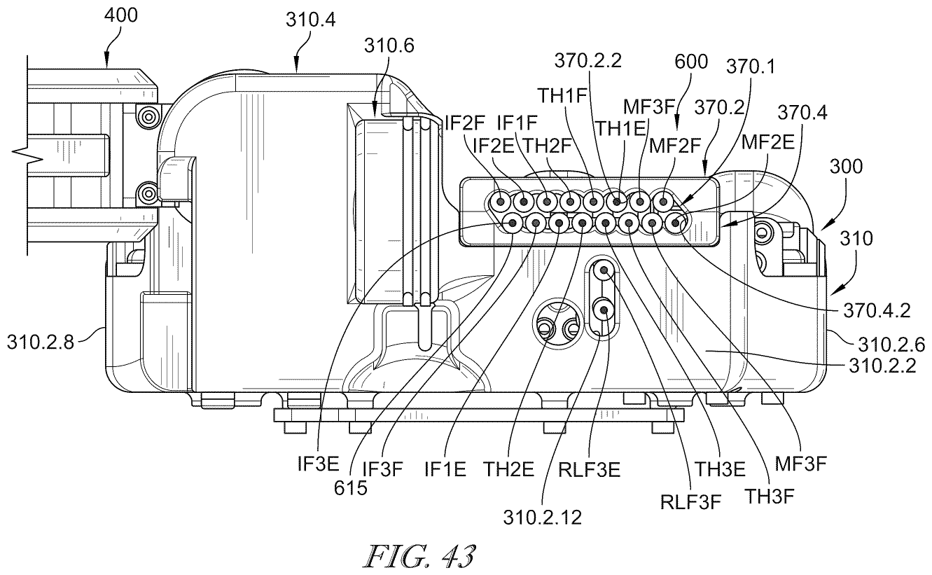

As shown in FIGS. 10-44, the end effector or hand assembly 200 is configured to support a load of at least 8 Kg, and preferably more than 10 Kg, and most preferably more than 20 Kg. The end effector 200 includes a hand housing 300, a thumb assembly 400, and at least one finger assembly 210, illustratively shown as a plurality of finger assemblies 210a-d. The thumb assembly 400 and the plurality of finger assemblies 210a-d are coupled to the hand housing 300. The plurality of finger assemblies 210 includes an index finger 210a, a middle finger 210b, a ring finger 210c, and a little finger 210d. Each of the plurality of fingers 210 includes the same structural components, with the exception of the index finger 210a, from which a spacer 230 is omitted to provide an additional degree of freedom (DoF). This configuration simplifies manufacturing and assembly, and reduces the number of unique parts required for the hand assembly 200. However, it should be understood that in other embodiments, some or all of the fingers 210 may be structurally unique. For example, these alternative embodiments might be structured as follows: (i) the index finger 210a and the middle finger 210b are the same, while the ring finger 210c and the little finger 210d are the same, such that the index finger 210a and ring finger 210c are different, (ii) the index finger 210a is unique, the middle finger 210b is unique, and the ring finger 210c and the little finger 210d are the same, such that the index, middle, and ring fingers 210a, 210b, 210c are different, (iii) the middle finger 210b is unique, the little finger 210d is unique, and the index finger 210a and the ring finger 210c are the same, such that the index, middle, and little fingers 210a, 210b, 210d are different, and/or (iv) any combination of the above or any other combination that is known by one of skill in the art.

The disclosed end effector or hand assembly 200 includes nine degrees of freedom (9 DoF). The index finger 210a has at least three DoF: (i) abduction/adduction at the first or metacarpophalangeal (IMCP) joint, (ii) flexion/extension of the first or metacarpophalangeal (IMCP) joint, and (iii) flexion/extension of the second or proximal interphalangeal (IPIP) joint. The middle finger 210b has at least 2 DoF: (i) flexion/extension of the first or metacarpophalangeal (MMCP) joint, and (ii) flexion/extension of the second or proximal interphalangeal (MPIP) joint. The combined ring and little fingers 210c, 210d have at least 1 DoF: (i) flexion/extension of the second or proximal interphalangeal (RPIP, LPIP) joint. The thumb 400 has at least 3 DoF: (i) abduction/adduction of the first thumb joint or trapeziometacarpal (TTM) joint, (ii) flexion/extension of the second thumb joint or carpometacarpal (TCMC) joint, and (iii) flexion/extension of the third thumb joint or metacarpophalangeal (TMCP) joint.

Each of the fingers 210a-d are fixed at the distal interphalangeal (DIP) joint at a preset inward angle (e.g., between 20 degrees and 90 degrees), which may be the same or different for each of the fingers 210a-d. Similarly, the distal interphalangeal (TIP) joint of the thumb 400 is also fixed at an inward angle that is the same as or different from the angle of the DIP joints of the fingers 210a-d. In other embodiments, the DIP joints and the TIP joint may be fixed at smaller angles with the MCP joints positioned with a bend. In further embodiments, bends at the DIP joints and the TIP joint may be omitted. It should be understood that the hand assembly 200 may include or specifically lack temperature sensors, current sensors, voltage sensors, or other types of sensors.

a. Palm

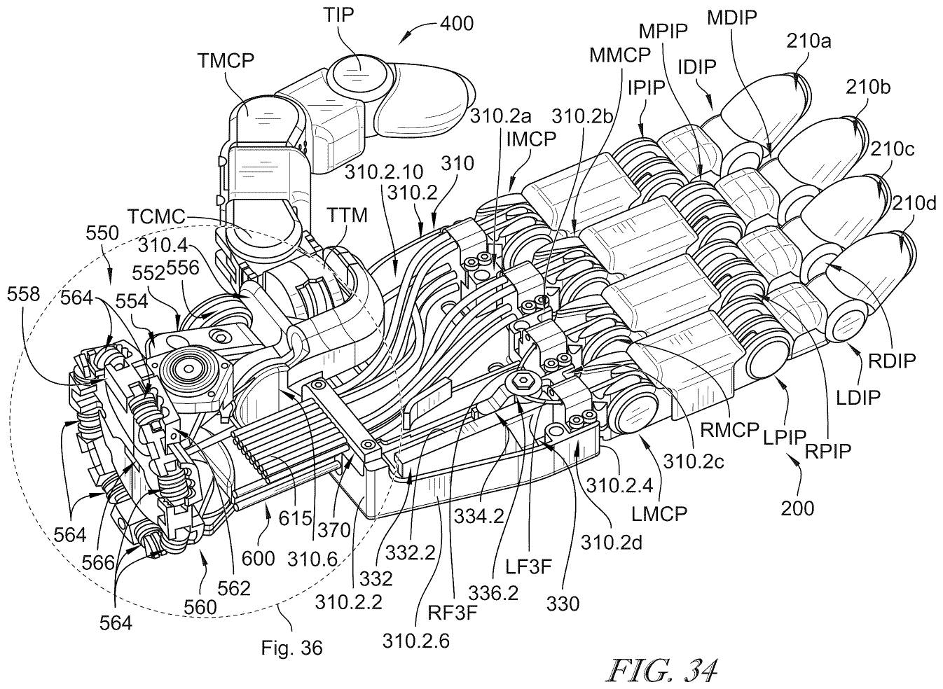

As shown in FIGS. 3, 10, 34, 35, and 43, the hand housing 300 includes: (i) a palm frame 310, (ii) a palm cover 312, and (iii) a carpal tunnel-like structure 370. Each finger assembly 210 is coupled to the palm frame 310. The palm frame 310 also defines a cavity 310.2.10 in which parts of the tendon assembly 600 may be located. The palm cover 312 is coupled to the palm frame 310 to enclose the tendon assembly 600 within the cavity 310.2.10 and to shield access to the finger attachment points 310.2a-d. As depicted in FIGS. 34-36, 42, and 43, the carpal tunnel-like structure 370 is coupled to the palm frame 310 and is configured to guide at least some tendons 610 of the tendon assembly 600 from the forearm assembly 110 and the wrist assembly 550 to the hand housing 300. For example, at least two tendons (tendons RLF2E and RLF2F) are not guided by the carpal tunnel-like structure 370, but instead are routed through an opening 310.2.12 formed in the palm frame 310 that opens to the cavity 310.2.10. In other embodiments, the carpal tunnel-like structure 370 may be integrally formed with an extent of the housing 300 or the palm frame 310 and as such may be formed from a combination of housing 300 or palm frame 310 projections and/or recesses. In further embodiments, the carpal tunnel-like structure 370 may be omitted.

As shown in FIGS. 3, 10, 34, 35, and 43, the palm frame 310 defines: (i) a base 310.2 having a plurality of finger attachment points 310.2a-d, (ii) a thumb receptacle 310.4, and (iii) a wrist mount 310.6. The base 310.2 has a first interior wall extent 310.2.2, a second interior wall extent 310.2.4 positioned a first distance from the first interior wall extent 310.2.2, a third interior wall extent 310.2.6, and a fourth interior wall extent 310.2.8 positioned a second distance from the third interior wall extent, wherein the second distance is closer to the base 310.2 of the hand housing 300 than the first distance. The interior walls 310.2.2, 310.2.4, 310.2.6, 310.2.8 define the cavity 310.2.10 in which parts of the tendon assembly 600 may be located. The opening 310.2.12 for the other tendons not routed through the carpal tunnel-like structure 370 is formed in the first interior wall extent 310.2.2.

As shown in FIGS. 3, 10, 34, 35, and 43, each finger assembly 210 is coupled to the palm frame 310 at one of the finger attachment points 310.2a-d. Specifically, The index finger 210a is coupled to the index attachment point 310.2a, the middle finger 210b is coupled to the middle attachment point 310.2b, the ring finger 210c is coupled to the ring attachment point 310.2c, and the little finger 210d is coupled to the little attachment point 310.2d. The thumb assembly 400 is coupled to the thumb receptacle 310.4 of the palm frame 310. The wrist assembly 550 is coupled to the wrist mount 310.6 of the palm frame 310. The carpal tunnel-like structure 370 may be positioned between the first interior wall extent 310.2.2 and the second interior wall extent 310.2.4.

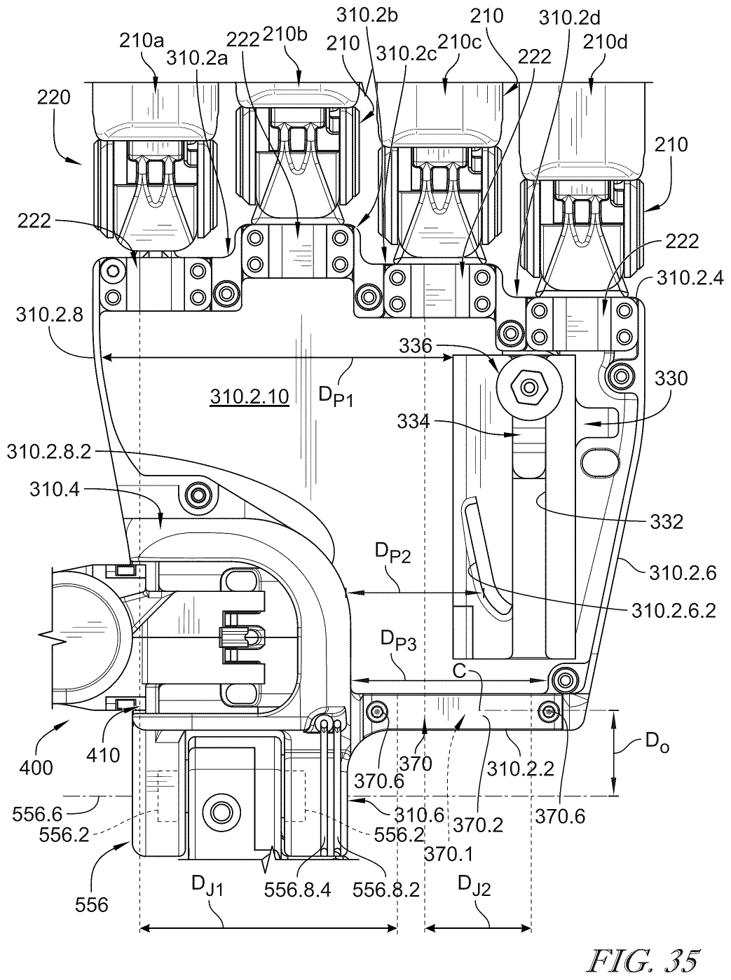

As shown in FIGS. 34-43, the carpal tunnel-like structure 370 includes: (i) a bottom carpal tunnel member 370.2, (ii) a top carpal tunnel member 370.4, and (iii) fastening means 370.6. The fastening means 370.6 (e.g., bolts) couples the bottom and top carpal tunnel members 370.2, 370.4 to clamp around the sheaths 615 and tendons 610 routed therethrough. The fastening means 370.6 may also couple the bottom and top carpal tunnel members 370.2, 370.4 to the palm frame 310. The bottom carpal tunnel member 370.2 is formed to include a plurality of bottom tendon grooves 370.2.2, and the top carpal tunnel member 370.4 is formed to include a plurality of top tendon grooves 370.4.2. The bottom and top tendon grooves 370.2.2, 370.4.2 receive portions of the sheaths 615 when the bottom and top members 370.2, 370.4 are coupled together. As best shown in FIGS. 35, 36, and 38, the carpal tunnel-like structure 370 that includes an opening 370.1 formed between the bottom carpal tunnel member 370.2 and the top carpal tunnel member 370.4, and wherein interior extents of said opening 370.1 serve to define a centroid C. The centroid C of the opening 370.1 (or in an alternative, the carpal tunnel-like structure 370) is offset from the rotational axis (e.g., pitch axis 556.6 or yaw axis 554.6), whereby said centroid C does not lie on the rotational or pitch axis 556.6. As shown in FIG. 35, the centroid C of the opening 370.1 is offset from the rotational or pitch axis 556.6 by an offset distance Do. In other embodiments, the centroid C of the opening 370.1 (or the carpal tunnel-like structure 370) may lie on or in a rotational axis (e.g., pitch axis 556.6 or yaw axis 554.6)

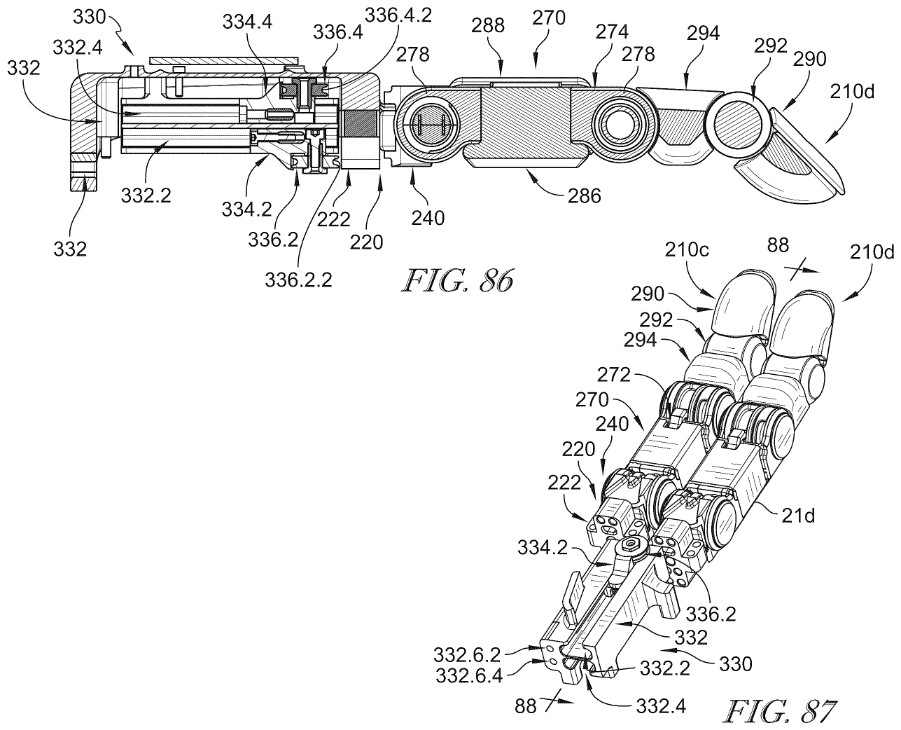

As shown in FIGS. 34, 35, and 84-87, the hand housing 300 also houses a finger coupler 330. The finger coupler 330 is arranged in the cavity 310.2.10 and is configured to link the movement of certain fingers, namely the little finger 210d and the ring finger 210c. The finger coupler 330 includes: (i) a track 332, (ii) slides 334.2, 334.4, and (iii) wheel guides 336.2, 336.4 coupled to the top and bottom slides 334.4, 334.2. The track 332 has a bottom track channel 332.2 and a top track channel 332.4. A bottom slide 334.2 is configured to move within the bottom track channel 332.2, and a top slide 334.4 is configured to move within the top track channel 332.4. One wheel guide 336.2 is coupled to the bottom slide 334.2, and the other wheel guide 336.4 is coupled to the top slide 334.4 to move therewith. Each wheel guide 336.2, 336.4 has grooves 336.2.2, 336.4.2 for a u-shaped tendon 610 that extends around the wheel guide 336.2, 336.4. The tendons 610 for the fingers 210c, 210d extend around the bottom and top wheel guides 336.2, 336.4, which are configured to slide in the track channels 332.2, 332.4 to control the flexion and extension of the fingers 210c, 210d. The track 332 is also formed to include guide channels 332.6.2, 332.6.4 for tendons 610 that extend from the slides 334.2, 334.4 back to a respective actuator 130. The arrangement of the tendons 610 on the finger coupler 330 is discussed in more detail below.

b. Fingers

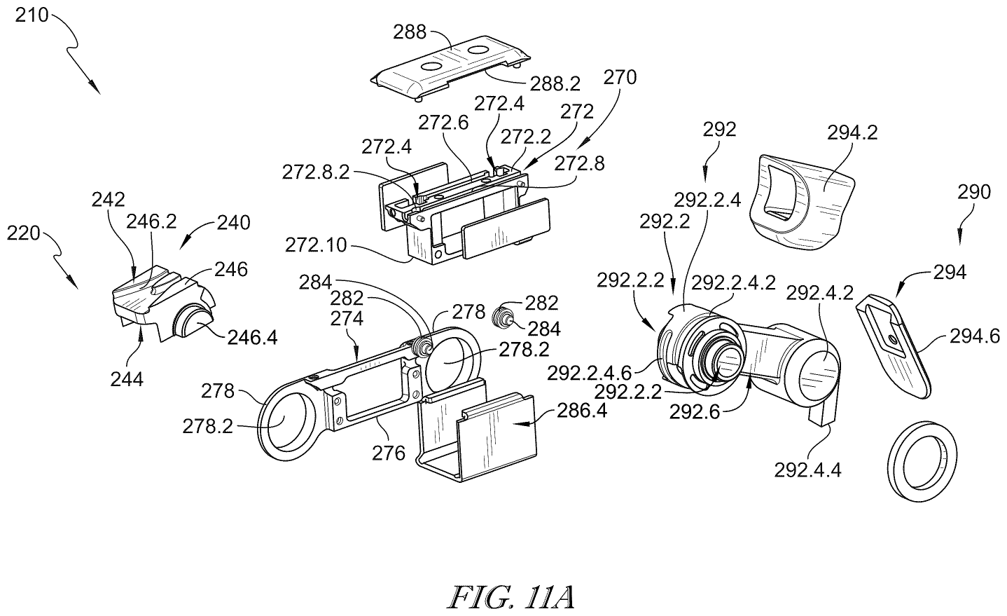

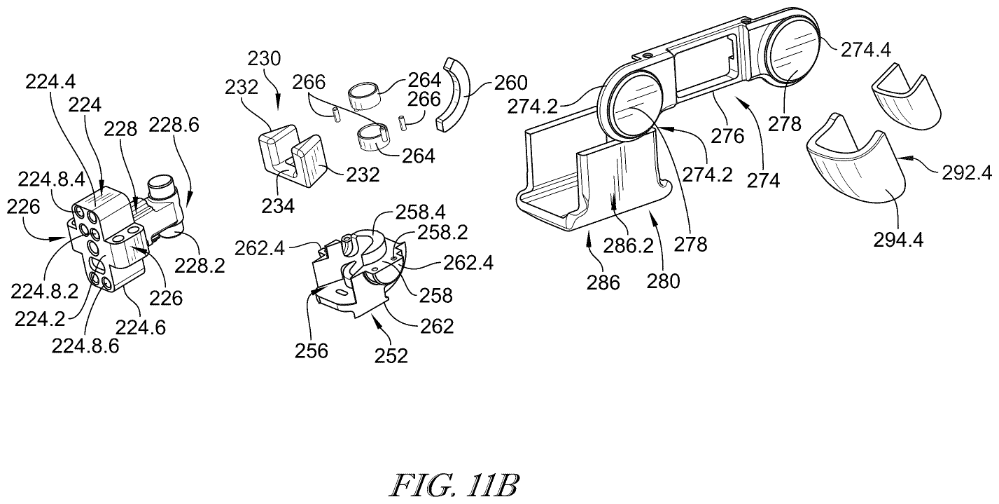

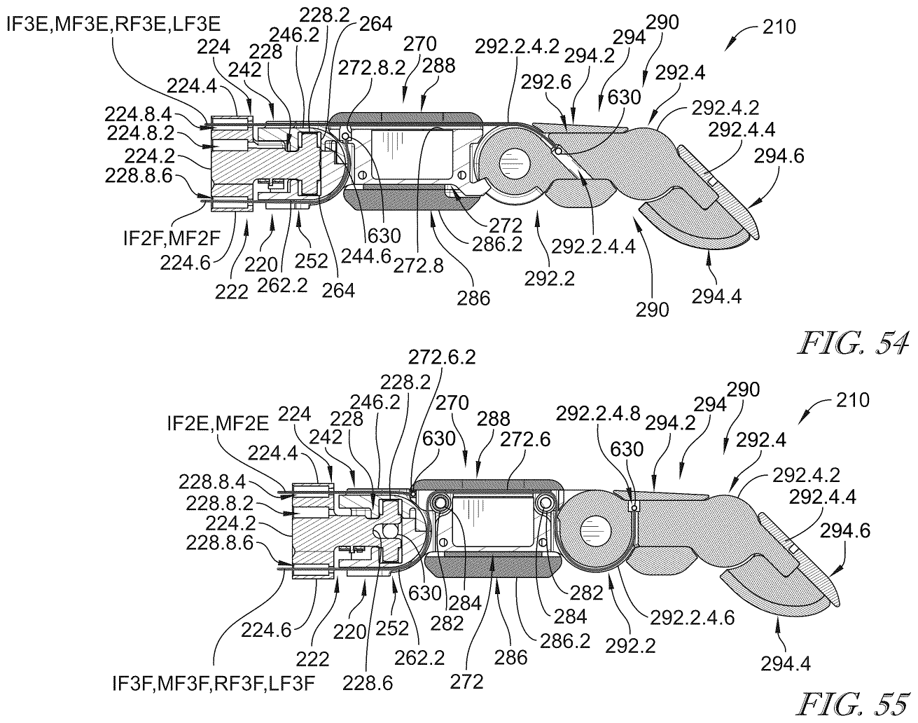

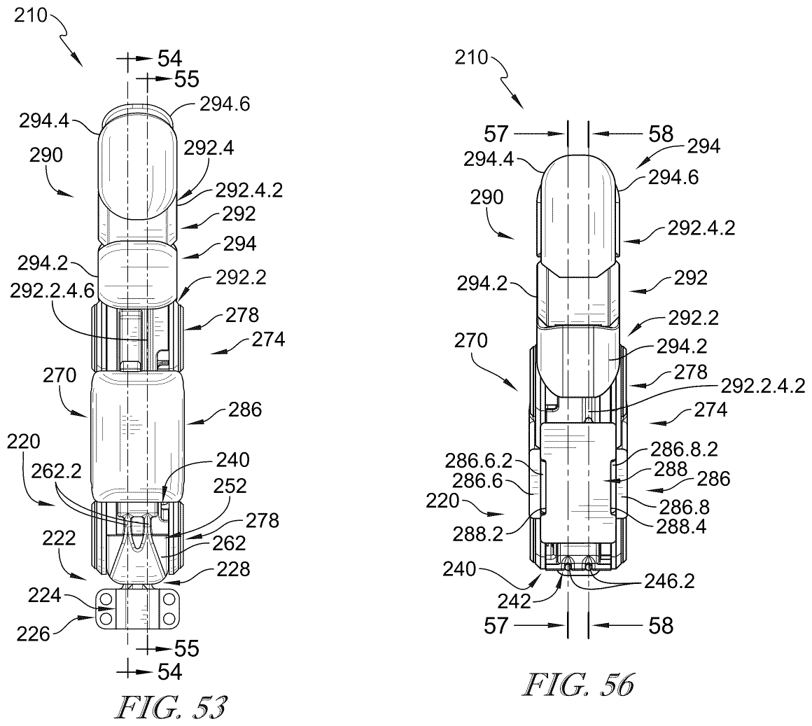

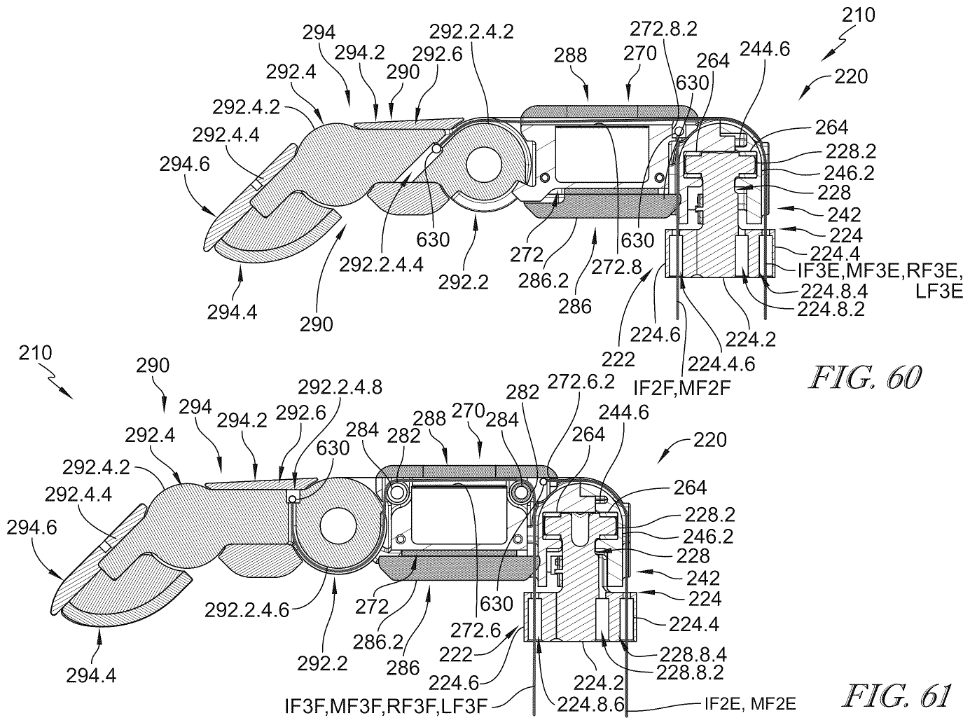

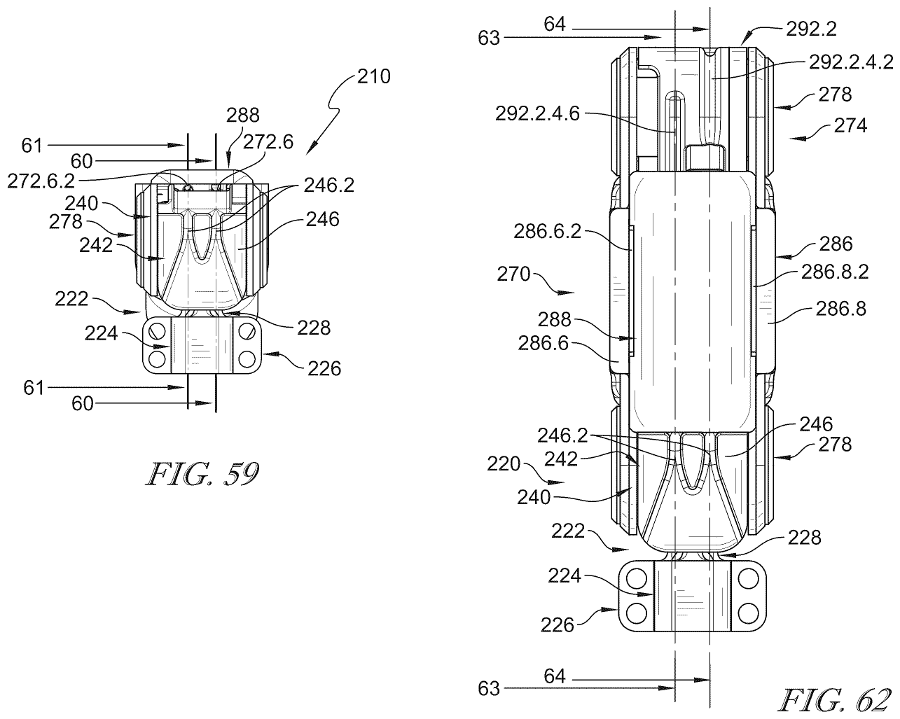

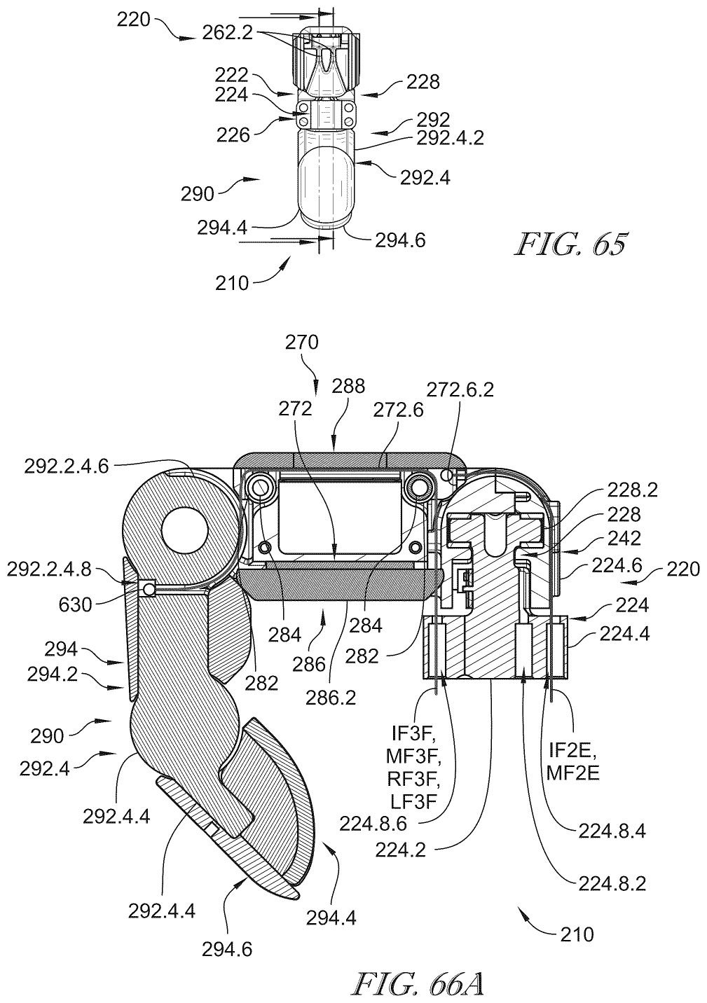

As shown in FIGS. 11-31 and 47-67, each finger assembly 210 of the hand assembly 200 includes: (i) a knuckle assembly 220, (ii) a proximal assembly 270, and (iii) a medial-distal assembly 290. The knuckle assembly 220 of each finger 210a-d is coupled to the palm frame 310 at the finger attachment points 310.2a-d. As shown in FIGS. 3, 10, 34, and 35, the locations of the connection between each finger 210a-d and the hand housing 300 are staggered and/or are not coplanar with one another. This configuration enables the distal ends of the fingers 210a-d to be offset relative to one another. In other embodiments, the locations of the connection between the finger assemblies 210a-d and the hand housing 300 may not be staggered and/or may be coplanar. The proximal assembly 270 is coupled to the knuckle assembly 220, forming a first finger joint, or metacarpophalangeal (MCP) joint. The medial-distal assembly 290 is coupled to the proximal assembly 270, forming a second finger joint, or proximal interphalangeal (PIP) joint. In the illustrative embodiment, the third finger joint, or distal interphalangeal (DIP) joint, is fixed at a predetermined angle within the medial-distal assembly 290. One or more of the knuckle assembly 220, proximal assembly 270, and medial-distal assembly 290 may include sensors, circuit boards, wiring, or other electronic components. In particular, the distal ends of the finger assemblies 210 may include pressure sensors, and encoders (e.g., absolute or incremental, magnetic and/or optical) may be placed at one or more of the joints. Additionally, a hand controller can send joint angles and wrist positions at a frequency between 150 Hz and 350 Hz.

i. Knuckle Assembly

As shown in FIGS. 11-31 and 47-67, the knuckle assembly 220 includes: (i) a knuckle support 222, (ii) a spacer 230, (iii) a knuckle enclosure 240, (iv) bearings 264, 268, and (v) pins 266. Although the components are the same for all fingers 210a-d, the spacer 230 is omitted from the index finger 210a to allow for abduction and adduction movement at the first joint, or MCP joint, of the index finger 210a, thereby providing an additional DoF.

Shown in FIGS. 11-31 and 47-67, the knuckle support 222 includes: (i) a support base 224, (ii) mounting portions 226, and (iii) a finger support 228 projecting from the support base 224. The support base 224 has a central portion 224.2, an upper portion 224.4, and a lower portion 224.6. The support base 224 is also formed to include a plurality of cable passageways 224.8.2, 224.8.4, 224.8.6 extending therethrough. Each cable passageway 224.8.2, 224.8.4, 224.8.6 is configured to allow passage and movement of a tendon 610 of the tendon assembly 600. For example, as shown in FIG. 14, a first set of cable passageways 224.8.2 is spaced on opposing sides of the finger support 228 to receive flexion and extension portions of a tendon 610 that controls the first finger joint or MCP joint, a second set of cable passageways 224.8.4 is positioned in an upper portion 224.4 of the support base 224, and a third set of cable passageways 224.8.6 is positioned in the lower portion 224.6. The mounting portions 226 project laterally from the central portion 224.2 of the support base 224 and include mounting apertures 226.2 configured to receive fasteners to secure the knuckle support 222 to the palm frame 310. The finger support 228 projects from the central portion 224.2 of the support base 224 and has a post 228.2 at its distal end of the finger support 228. The knuckle support 222 also includes a wire conduit 228.4 through the support base 224 that extends from an access slot 228.6 in the post 228.2 through the finger support 228 and the support base 224 (see e.g., FIG. 24).

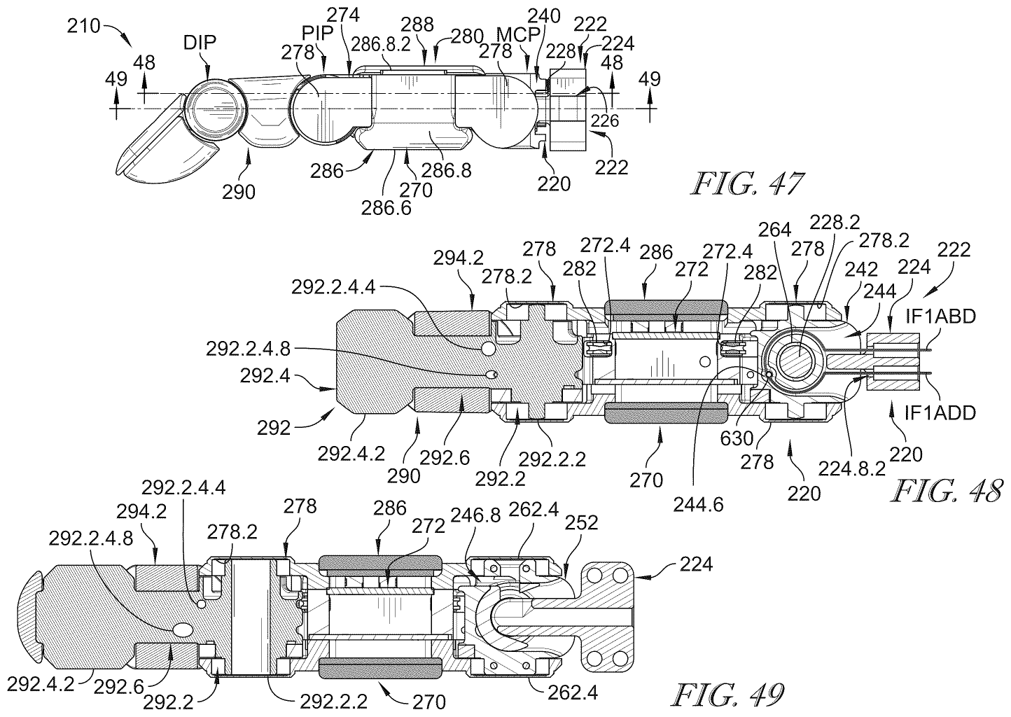

As shown in FIG. 11, the spacer 230 includes a pair of blocks 232 connected by a bridge section 234 and is configured to couple with the knuckle support 222. In the illustrative example, the blocks 232 of the spacer 230 are substantially triangular in shape and are spaced apart with a width substantially similar to the width of the finger support 228. For instance, when coupled to the knuckle support 222, the blocks 232 on opposing sides of the finger support 228 taper outward from a position near the post 228.2 to the support base 224. The width of the spacer 230 is not greater than the width of the support base 224 at the mounting portions 226. As noted above, the spacer 230 is omitted from the configuration of the index finger (IF) 210a (see e.g., FIGS. 47-67).

As shown in FIGS. 11-31 and 47-67, the knuckle enclosure 240 includes: (i) a top member 242, (ii) a bottom member 252, and (iii) a clasp 260, and is designed to protect and substantially encase the other components of the knuckle assembly 220. The knuckle enclosure 240 is also configured to enclose a portion of the tendon assembly 600 and includes exterior guide slots 246.2, 262.2 for additional portions of the tendon assembly 600. The knuckle enclosure 240 is configured to couple with the knuckle support 222 at the post 228.2, where a bearing 264 may be positioned around top and bottom extents of the post 228.2 to receive the knuckle enclosure 240. For the index finger 210a, the omission of the spacer 230 allows for limited rotation of the knuckle enclosure 240 about the post 228.2, which permits abduction and adduction movement. For the middle, ring, and little fingers 210b-d, the knuckle enclosure 240 is configured to surround the knuckle support 222 and the spacer 230 such that there is no rotational movement at the post 228.2. In all fingers 210a-d, the knuckle enclosure 240 is coupled to the post 228.2 of the knuckle support 222 in the same manner. The clasp 260 is configured to conform to an exterior portion of the knuckle enclosure 240 to couple the top and bottom members 242, 252 together.

As shown in FIGS. 11-31 and 47-67, the top member 242 has: (i) an interior portion 244, (ii) an exterior surface 246, and (iii) a coupling surface 248. The interior portion 244 includes a circular projection 244.2 configured to receive the bearing 264 positioned around a top extent of the post 228.2, a cable recess 244.4 configured to receive an extent of a tendon 610, and a ball seat 244.6 configured to retain a ball 630 coupled to the tendon 610 within the cable recess 244.4. The exterior surface 246 includes exterior cable guide slots 246.2, a semi-circular mount 246.4 projecting from one side of the top member 242, and a ring portion mount 246.6 projecting from a side opposite the semi-circular mount 246.4. A wire passage 246.8, located at the ring portion mount 246.6, extends from the exterior surface 246 to the interior portion 244 and is configured to route wiring therethrough. The coupling surface 248 is substantially flat and includes holes 248.2 to receive mounting pins 266 for coupling the top and bottom members 242, 252 of the knuckle enclosure 240.

Shown in FIGS. 11-31 and 47-67, the bottom member 252 of the knuckle enclosure 240 is configured to be complementary to the top member 242. The bottom member 252 includes: (i) an interior portion 256, (ii) a coupling surface 258, and (iii) an exterior surface 262. The coupling surface 258 is substantially flat with an arcuate projection 258.4 projecting therefrom. The coupling surface 258 also includes holes 258.2 to receive mounting pins 266 to couple the top and bottom members 242, 252. The arcuate projection 258.4 projects from the coupling surface 258 and is configured to (i) be received within the cable recess 244.4 of the top member 242, retaining the ball 630 coupled to the tendon 610 within the seat 244.6 of the top member 242, and (ii) receive the bearing 264 positioned around a bottom extent of the post 228.2. The exterior surface 262 includes exterior cable guide slots 262.2, a semi-circular mount 262.4 projecting from one side of the bottom member 252, and a ring portion mount 262.6 projecting from a side opposite the semi-circular mount 262.4.

ii. Proximal Assembly

As shown in FIGS. 11-31 and 47-67, the proximal assembly 270 includes: (i) a proximal member 272, (ii) spanning covers 274, (iii) a proximal housing assembly 280, (iv) wheels 282, and (v) pins 284. The proximal member 272 is configured to receive the wheels 282 and the pins 284 to route a tendon 610 through the proximal member 272. The spanning covers 274 are each configured to couple the proximal assembly 270 with the knuckle assembly 220 at a first end 274.2 to form the first finger joint or MCP joint and with the medial-distal assembly 290 at a second end 274.4 to form the second finger joint or PIP finger joint. The proximal housing assembly 280 is configured to enclose at least a portion of the proximal member 272 and/or the spanning covers 274 and may be made from a polymeric material (e.g., polyurethane) that may be injection molded or 3D printed.

As shown in FIGS. 11-31 and 47-67, the proximal member 272 includes: (i) a top surface 272.2 with two spaced-apart wheel wells 272.4, (ii) a first slot 272.6 that extends between the two wheel wells 272.4, (iii) a second slot 272.8 with a ball recess 272.8.2, and (iv) a bottom surface 272.10. The first and second slots 272.6, 272.8 are substantially parallel to each other and are configured to receive a tendon 610. The two wheel wells 272.4 are configured to receive the pins 284 and the wheels 282 to rotatably secure the wheels 282 at least partially within the respective wheel wells 272.4. At one end of the first slot 272.6, there is a ball recess 272.6.2 configured to receive a ball 630 attached to a tendon 610. The second slot 272.8 is also configured to receive a ball 630 attached to a tendon 610 within its ball recess 272.8.2.

As shown in FIGS. 11-31 and 47-67, the spanning covers 274 each include: (i) a central portion 276 and (ii) rounded end portions 278 at the first and second ends 274.2, 274.4 of the spanning cover 274. The central portion 276 of each spanning cover 274 is configured to cover the sides of the proximal member 272, with the rounded end portions 278 projecting outward. The rounded end portions 278 include interior-facing circular indentations 278.2. The circular indentations 278.2 of the rounded end portions 278 on the first end 274.2 of each spanning cover 274 are configured to receive the circular mounts 246.4, 262.4 protruding from the knuckle assembly 220. The circular indentations 278.2 of the rounded end portions 278 on the second end 274.4 of each spanning cover 274 are configured to receive circular mount projections 292.2.2 protruding from the medial-distal assembly 290.

As shown in FIGS. 11-31 and 47-67, The proximal housing assembly 280 includes: (i) a bottom cover 286 and (ii) a top cover 288. The bottom cover 286 extends around the bottom surface 272.10 of the proximal member 272 and at least a portion of the spanning covers 274. The top cover 288 is coupled to the top surface 272.2 of the proximal member 272 and extends over it to enclose the wheel wells 272.4. The top cover 288 prevents access to the pins 284, the wheels 282, and the tendon 610 within the slots 272.6, 272.8. As shown in FIG. 10, the bottom cover 286 has two separate components 286.2, 286.4 that are coupled or fixed together. Alternatively, the bottom cover 286 may be a single-piece component. The bottom cover 286 includes: (i) a bottom cover wall 286.6, (ii) a first cover sidewall 286.8, and (iii) a second cover sidewall 286.10. The sidewalls 286.8, 286.10 extend from the bottom wall 286.6 and form attachment lips 286.8.2, 286.10.2. These lips extend over a portion of the top surface 272.2 of the proximal member 272 and the central portion 276 of the spanning covers 274 to couple the bottom cover 286 to the proximal member 272 and the spanning covers 274. The top cover 288 has grooves 288.2, 288.4 that receive the attachment lips 286.8.2, 286.10.2 when the top cover 288 is coupled to the top surface 272.2 of the proximal member 272.

iii. Medial-Distal Assembly

As shown in FIGS. 11-31 and 47-67, the medial-distal assembly 290 includes: (i) a medial-distal member 292, (ii) a medial-distal housing assembly 294, and (iii) bearings 296. The medial-distal housing assembly 294 is configured to enclose at least a portion of the medial-distal member 292. Components of the medial-distal housing assembly 294 may be made from a polymeric material (e.g., polyurethane) that may be injection molded or 3D printed.

As shown in FIGS. 11-31 and 47-67, the medial-distal member 292 includes: (i) a coupling end portion 292.2, (ii) a distal end portion 292.4, and (iii) a medial portion 292.6 that extends therebetween. The coupling end portion 292.2 includes circular mount projections 292.2.2 protruding outward from opposite sides of the medial-distal member 292 and is configured to couple with the second end 274.4 of the proximal assembly 270. These circular mount projections 292.2.2 are configured to be received into the circular indentations 278.2 of the rounded end portions 278 on the second end 274.4 of the proximal assembly 270 on both sides, thereby forming the to form the second finger joint or PIP finger joint.

As shown in FIGS. 11-29 and 47-67, the coupling end portion 292.2 also has an exterior surface 292.2.4 that includes a top guide slot 292.2.4.2 and a bottom guide slot 292.2.4.6. The top and bottom guide slots 292.2.4.2, 292.2.4.6 extend around the end of the coupling end portion 292.2, but do not intersect. Each guide slot 292.2.4.2, 292.2.4.6 extends through a portion of the medial portion 292.6 and ends in a ball seat 292.2.4.4, 292.2.4.8. The top ball seat 292.2.4.4 is located at the end of the top guide slot 292.2.4.2, and the bottom ball seat 292.2.4.8 is located at the end of the bottom guide slot 292.2.4.6. Each ball seat 292.2.4.4, 292.2.4.8 is configured to receive a ball 630 attached to the respective tendon 610 located in the corresponding slot 292.2.4.2, 292.2.4.6.

As shown in FIGS. 11-29 and 47-67, the distal end portion 292.4 includes: (i) a circular bulge 292.4.2 and (ii) a tip 292.4.4 that extends therefrom. The circular bulge 292.4.2 extends from the medial portion 292.6. Although the circular bulge 292.4.2 is configured to represent a third finger joint, or the DIP joint, there is no rotational motion at this joint. The tip 292.4.4 extends from the circular bulge 292.4.2 at a preset or predefined angle (e.g., 44 degrees) and provides a mounting point for a portion of the medial-distal housing assembly 294.

As shown in FIGS. 11-29 and 47-67, the medial-distal housing assembly 294 includes: (i) a medial housing 294.2, (ii) a distal housing 294.4, and (iii) a fingertip cover 294.6. The medial housing 294.2 is configured to surround the medial portion 292.6. The distal housing 294.4 and the fingertip cover 294.6 are configured to cooperate to enclose the tip 292.4.4. The distal housing 294.4 is configured to be coupled to a bottom surface 292.4.4.2 of the tip 292.4.4, and the fingertip cover 294.6 is configured to be coupled to a top surface 292.4.4.4 of the tip 292.4.4. The distal housing 294.4 and/or the fingertip cover 294.6 may be made from a polymeric material (e.g., polyurethane) that may be injection molded or 3D printed.

c. Thumb

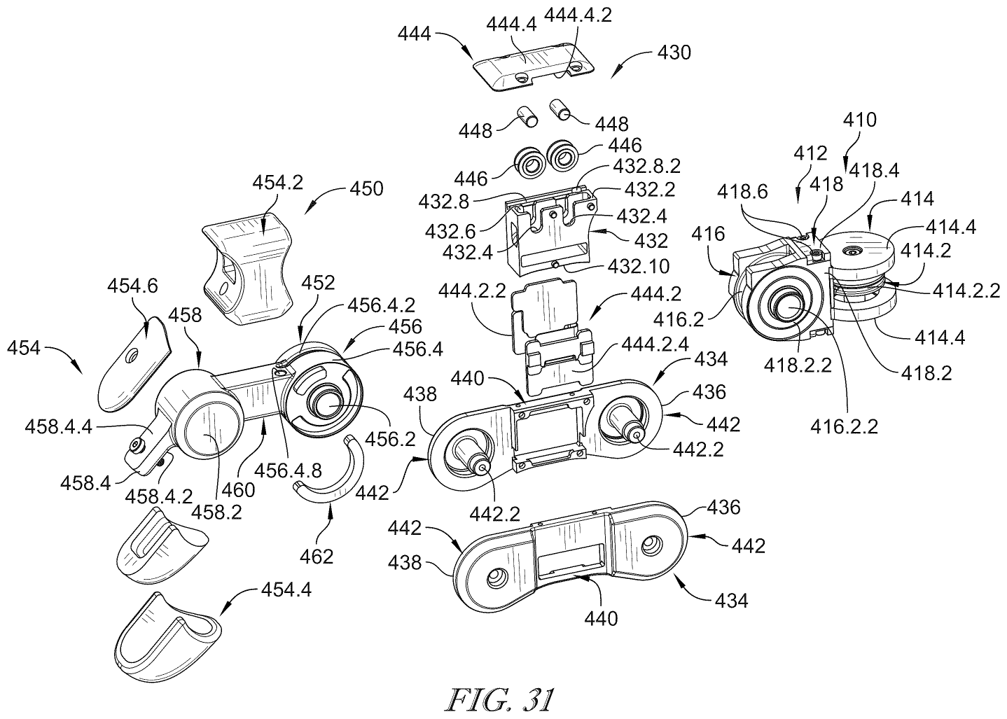

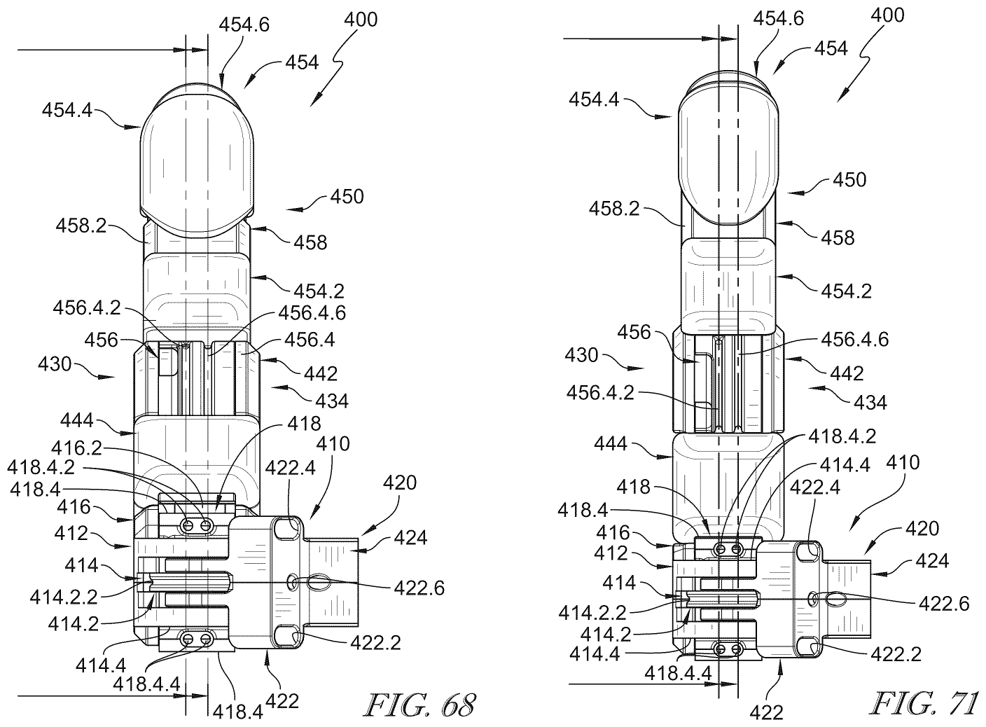

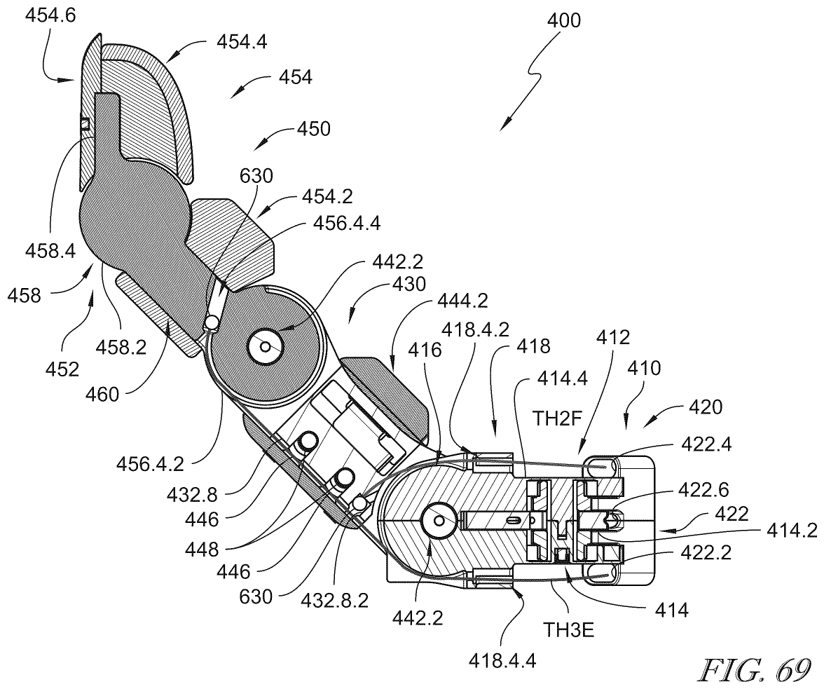

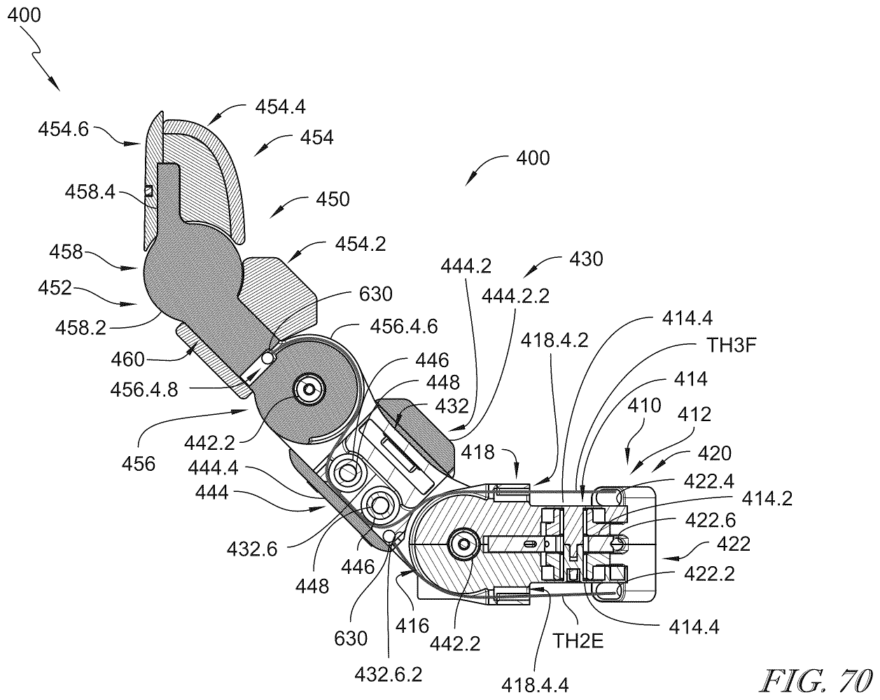

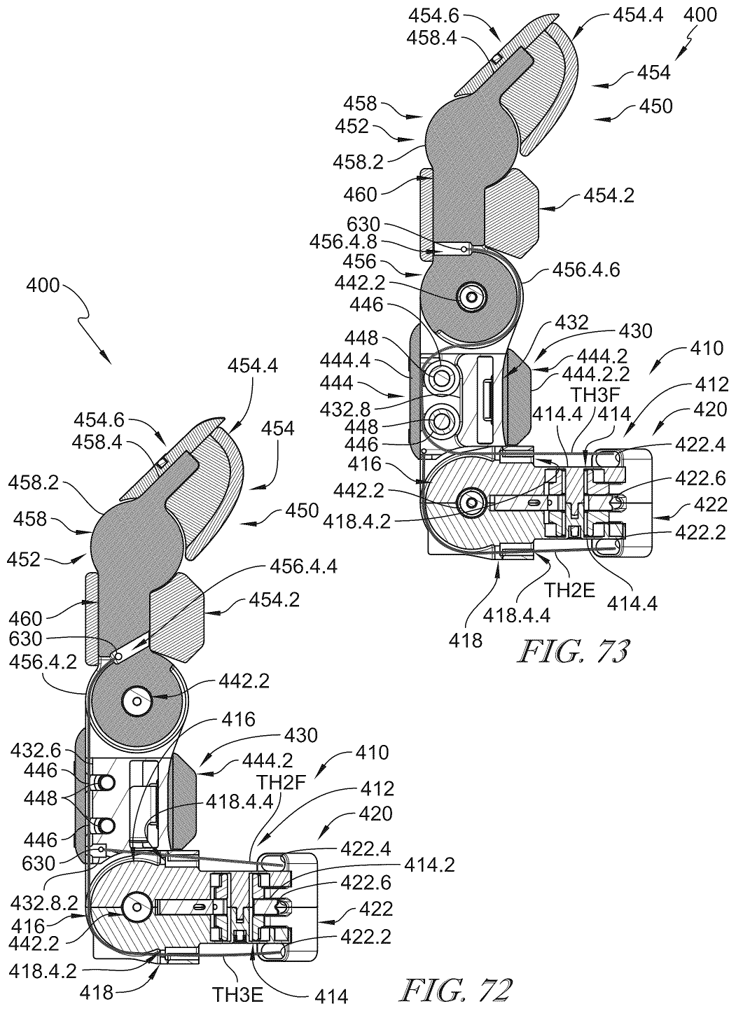

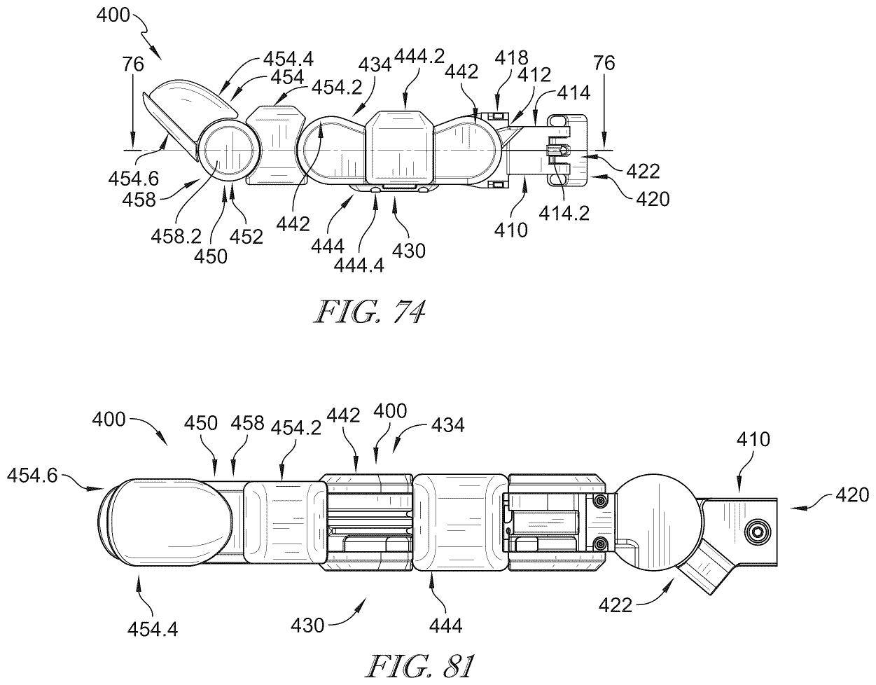

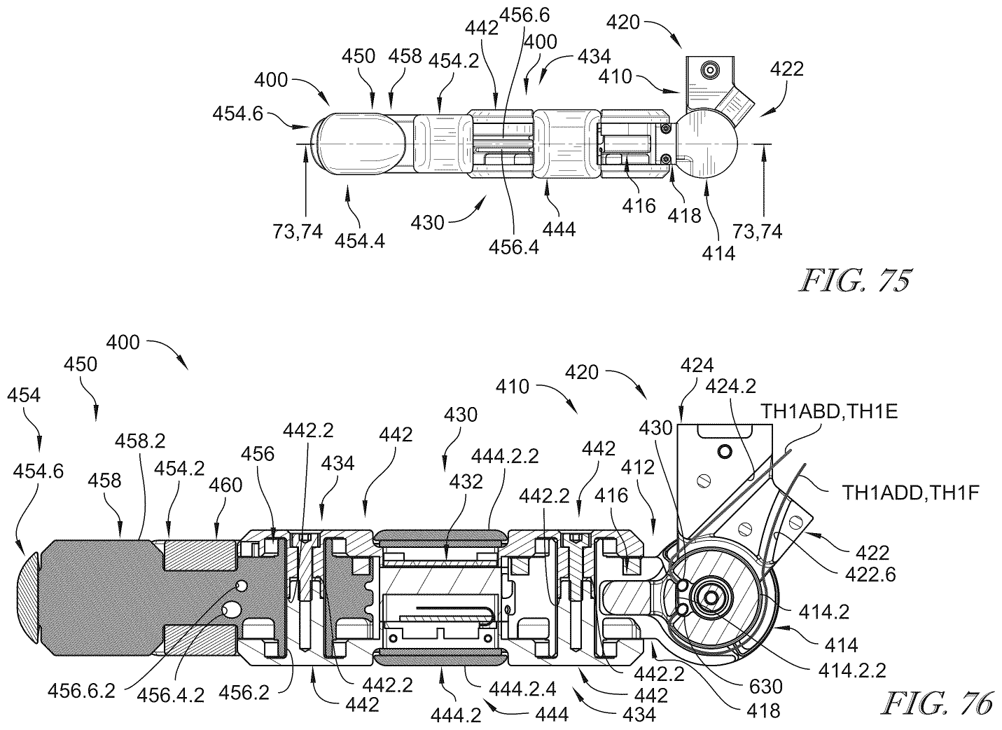

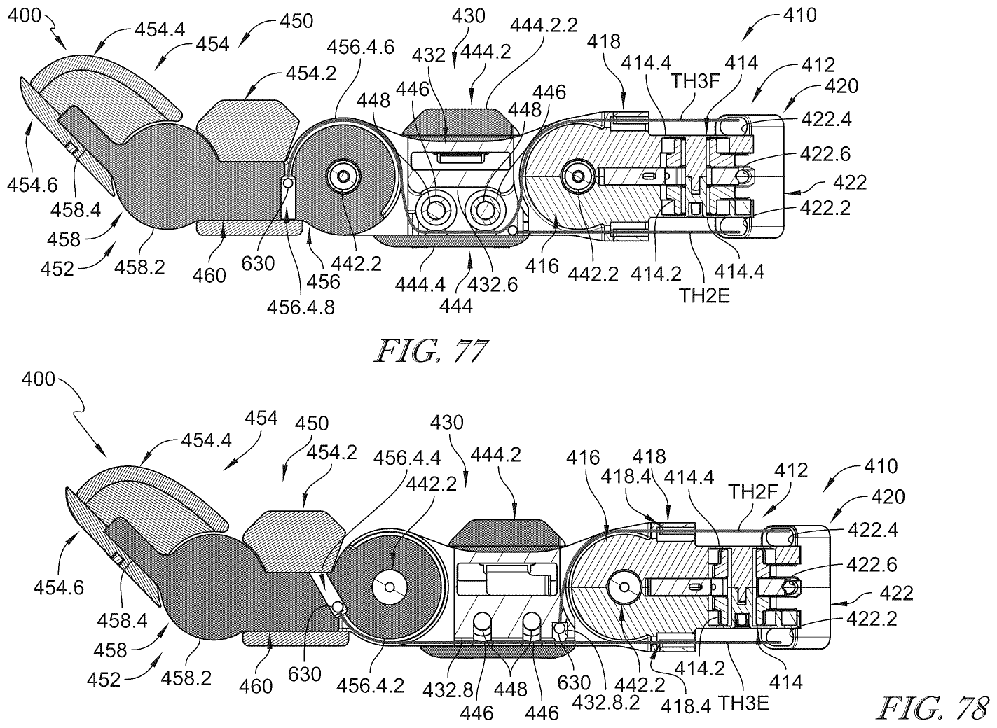

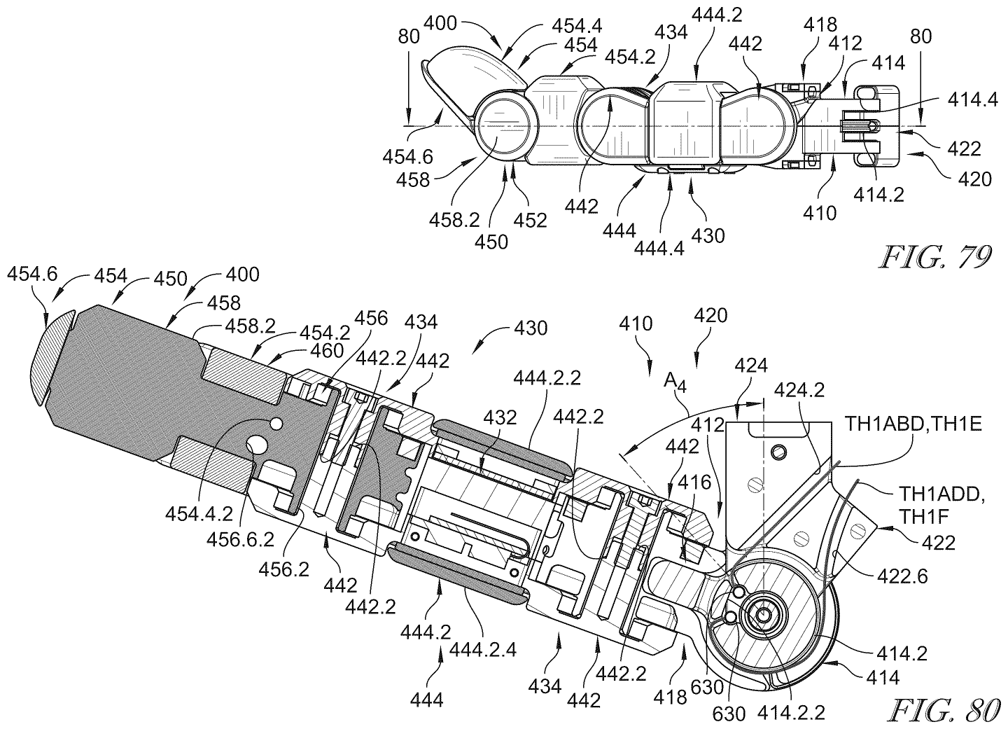

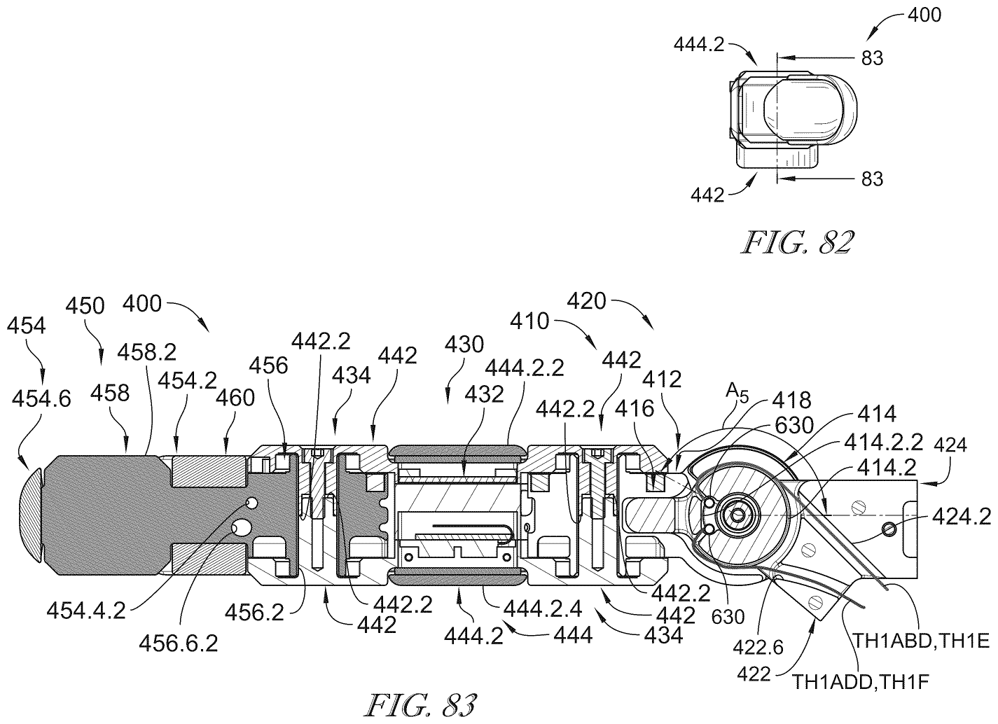

As shown in FIGS. 31-33 and 68-83, the thumb assembly 400 includes: (i) a thumb knuckle assembly 410, (ii) a thumb proximal assembly 430, and (iii) a thumb distal assembly 450. The thumb knuckle assembly 410 is coupled to the hand housing 300 at the thumb receptacle 310.4 to allow for abduction and adduction movement at the first thumb joint, or trapeziometacarpal (TTM) joint. The thumb proximal assembly 430 is coupled to the thumb knuckle assembly 410 for flexion and extension at the second thumb joint, or carpometacarpal (TCMC) joint. The thumb distal assembly 450 is coupled to the thumb proximal assembly 430, forming the third thumb joint, or metacarpophalangeal (TMCP) joint. In the illustrative embodiment, the fourth thumb joint, or interphalangeal (TIP) joint, is fixed at a predetermined angle for the thumb tip 458.4 of the thumb distal assembly 450.

i. Thumb Knuckle Assembly

As shown in FIGS. 31-33 and 68-83, the thumb knuckle assembly 410 includes: (i) a thumb knuckle member 412 and (ii) a thumb support 420. The thumb knuckle member 412 includes a first spool 414, a second spool 416, and a housing structure 418 configured to couple the first and second spools 414, 416 perpendicular to each other. The first and second spools 414, 416 form at least a portion of the first thumb joint or TTM joint and the second thumb joint or TCMC joint, respectively. As shown in FIG. 34, the first spool 414 forms a portion of the first thumb joint or TTM and the second spool 416 forms a portion of the second thumb joint or TCMC joint. The thumb support 420 is configured to couple to the thumb receptacle 310.4 of the hand housing 300.

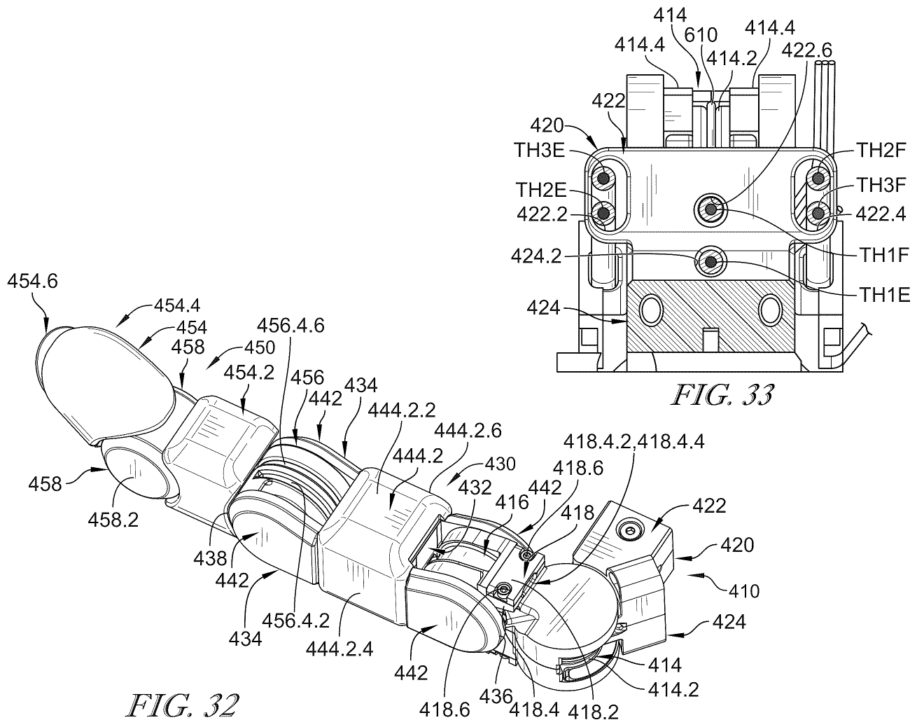

As shown in FIGS. 31-33 and 68-83, the thumb knuckle member 412 includes: (i) the first spool 414, (ii) the second spool 416, and (iii) the housing structure 418. The first spool 414 includes a first hub 414.2 recessed from the first rims 414.4 and is configured to receive a tendon 610. The first hub 414.2 has anchoring recesses 414.2.2 for one or more balls 630 attached to the tendon 610. The second spool 416 includes a second hub 416.2 configured to receive a tendon 610. The housing structure 418 includes: (i) circular mounts 418.2.2 extending outward from the housing structure 418 and axially aligned with the second hub 416.2, and (ii) cable passageways 418.4.2, 418.4.4 extending therethrough for the tendons 610. The circular mounts 418.2 have a hub aperture 416.2.2 therethrough configured to receive cylindrical mounts 442.2 of the thumb proximal assembly 430. As shown in FIGS. 31 and 32, the housing structure 418 also has cable covers 418.4 and fastening means 418.6 (e.g., bolts). The cable covers 418.4 are coupled to the main structure 418.2 with the fastening means 418.6 and block access to the tendons 610 routed through the housing. As shown in FIGS. 31-33 and 68-83, the thumb support 420 includes: (i) a support base 422 and (ii) a mounting portion 424. The support base 422 is coupled to the first spool 414 of the thumb knuckle member 412. The mounting portion 424 is coupled to the support base 422 and is configured to mount the thumb assembly 400 to the hand housing 300. Both the support base 422 and the mounting portion 424 include cable passageways 422.2, 422.4, 422.6, 424.2 extending therethrough.

ii. Thumb Proximal Assembly

As shown in FIGS. 31-33 and 68-83, the thumb proximal assembly 430 includes: (i) a proximal thumb member 432, (ii) thumb spanning covers 434, (iii) a proximal thumb housing assembly 444, (iv) thumb wheels 446, and (v) thumb pins 448. The proximal thumb member 432 is configured to receive the wheels 446 and the pins 448 to route a tendon 610 through the proximal thumb member 432. The spanning covers 434 are configured to couple the thumb proximal assembly 430 with the thumb knuckle assembly 410 at a first end 436 to form the second thumb joint or TCMC joint, and with the thumb distal assembly 450 at a second end 438 to form the third thumb joint or TMCP joint. The proximal thumb housing assembly 444 is configured to enclose at least a portion of the proximal thumb member 432 and/or the spanning covers 434 and may be made from a polymeric material (e.g., polyurethane) that may be injection molded or 3D printed.

Similar to the finger proximal assembly 270 and as shown in FIGS. 31-33 and 68-83, the proximal thumb member 432 includes: (i) a top surface 432.2 with two spaced-apart wheel wells 432.4, (ii) a first slot 432.6 extending between the two wheel wells 432.4, (iii) a second slot 432.8 with a ball recess 432.8.2, and (iv) a bottom surface 432.10. The first and second slots 432.6, 432.8 are substantially parallel to each other and are configured to receive a tendon 610. The two wheel wells 432.4 are configured to receive the pins 448 and wheels 446 to rotatably secure the wheels 446 at least partially within the respective wheel wells 432.4. At one end of the first slot 432.6, a ball recess 432.6.2 is configured to receive a ball 630 attached to a tendon 610. The second slot 432.8 is also configured to receive a ball 630 attached to a tendon 610 within its ball recess 432.8.2.

As shown in FIGS. 31-33 and 68-83, the spanning covers 434 each include: (i) a central portion 440 and (ii) rounded end portions 442. The central portion 440 of the spanning covers 434 is configured to cover the sides of the proximal thumb member 432, with the rounded end portions 442 projecting outward. The rounded end portions 442 include interior-facing cylindrical mounts 442.2 projecting inward from one spanning cover 434 to be received by the other spanning cover 434. The cylindrical mounts 442.2 of the rounded end portions 442 on the first end 436 of the respective spanning cover 434 are configured to be received into the hub aperture 416.2.2 of the thumb knuckle assembly 410. The cylindrical mounts 442.2 of the rounded end portions 442 on the second end 438 of the respective spanning cover 434 are configured to be received into a mounting aperture 456.2 of the thumb distal assembly 450.

As shown in FIGS. 31-33 and 68-83, the proximal thumb housing assembly 444 includes: (i) a bottom thumb cover 444.2 and (ii) a top thumb cover 444.4. The bottom thumb cover 444.2 extends around the bottom surface 432.10 of the proximal thumb member 432 and at least a portion of the thumb spanning covers 434. The top thumb cover 444.4 is coupled to the top surface 432.2 of the proximal thumb member 432 and extends over the top surface 432.2 to enclose the wheel wells 432.4, thereby preventing access to the pins 448, wheels 446, and the tendon 610 within the slots 432.6, 432.8. As shown in FIG. 31, the bottom thumb cover 444.2 is comprised of multiple separate components that are coupled or fixed together. Alternatively, the bottom thumb cover 444.2 may be a single-piece component. The bottom thumb cover 444.2 includes: (i) a bottom thumb cover wall 444.2.2, (ii) a first thumb cover sidewall 444.2.4, and (iii) a second thumb cover sidewall 444.2.6. The thumb cover sidewalls 444.2.4, 444.2.6 extend from the bottom thumb cover wall 444.2.2 and over a portion of the top surface 432.2 of the proximal thumb member 432 and the central portion 440 of the spanning covers 434 to couple the bottom thumb cover 444.2 to the proximal thumb member 432 and spanning covers 434. The top thumb cover 444.4 has grooves 444.4.2 that receive a portion of the bottom thumb cover 444.2 when the top thumb cover 444.4 is coupled to the top surface 432.2 of the proximal thumb member 432.

iii. Thumb Medial-Distal Assembly

As shown in FIGS. 31-33 and 68-83, the thumb distal assembly 450 includes: (i) a thumb medial-distal member 452, (ii) a thumb medial-distal housing assembly 454, and (iii) a clasp 462. The thumb medial-distal housing assembly 454 is configured to enclose at least a portion of the thumb medial-distal member 452. The clasp 462 is designed to protect and substantially encase the other components of the thumb distal assembly 450 and is configured to conform to a portion of the thumb medial-distal member 452. Components of the thumb medial-distal housing assembly 454 may be made from a polymeric material (e.g., polyurethane) that may be injection molded or 3D printed.

As shown in FIGS. 31-33 and 68-83, the thumb medial-distal member 452 includes: (i) a coupling end portion 456, (ii) a distal end portion 458, and (iii) a medial portion 460 therebetween. The coupling end portion 456 includes a circular mounting aperture 456.2 extending through the thumb medial-distal member 452 and is configured to couple with the second end 438 of the thumb proximal assembly 430. The circular mounting aperture 456.2 is configured to receive one of the cylindrical mounts 442.2 of the spanning covers 434 on the second end 438 of the proximal assembly 430 to form the third thumb joint or TMCP joint.

As shown in FIGS. 31-33 and 68-83, the coupling end portion 456 also has an exterior surface 456.4 that includes a top guide slot 456.4.2 and a bottom guide slot 456.4.6. The top guide slot 456.4.2 and the bottom guide slot 456.4.6 extend around the coupling end portion 456, but do not intersect. Each of the guide slots 456.4.2, 456.4.6 extends through a portion of the medial portion 460 and ends in a ball seat 456.4.4, 456.4.8. The top ball seat 456.4.4 is located at the end of the top guide slot 456.4.2, and the bottom ball seat 456.4.8 is located at the end of the bottom guide slot 456.4.6. Each of the top ball seat 456.4.4 and the bottom ball seat 456.4.8 is configured to receive a ball 630 attached to a respective tendon 610 located in the respective slot 456.4.2, 456.4.6.

As shown in FIGS. 31-33 and 68-83, the distal end portion 458 includes: (i) a circular bulge 458.2 and (ii) a tip 458.4. The circular bulge 458.2 extends from the medial portion 460 and represents the fourth thumb joint, although there is no rotational motion at this joint. The tip 458.4 extends from the bulge at an angle (e.g., 44 degrees).

As shown in FIGS. 31-33 and 68-83, the thumb medial-distal housing assembly 454 includes: (i) a medial housing 454.2, (ii) a distal housing 454.4, and (iii) a thumb tip cover 454.6. The medial housing 454.2 is configured to surround the medial portion 460. The distal housing 454.4 and the thumb tip cover 454.6 are configured to cooperate to enclose the tip 458.4. The distal housing 454.4 is configured to be coupled to a bottom surface 458.4.2 of the tip 458.4, and the thumb tip cover 454.6 is configured to be coupled to a top surface 458.4.4 of the tip 458.4. The distal housing 454.4 and/or the thumb tip cover 454.6 may be made from a polymeric material (e.g., polyurethane) that may be injection molded or 3D printed.

Said housing of the finger or thumb assemblies may be made from silicon, plastic (e.g., may include a known polymer composition), carbon composite, metal, a combination of these materials, and/or any other known material used in robot systems. In some embodiments, the exterior or skin of the finger or thumb assemblies may be less rigid or softer than the internal components of said assemblies. For example, the exterior or skin of the finger housing may be made from a deformable silicon material, while the internal frame of the finger assembly may be made from metal. It should be understood that these are examples of possible configurations and are not intended to be limiting in any manner.

### 3. Wrist Assembly

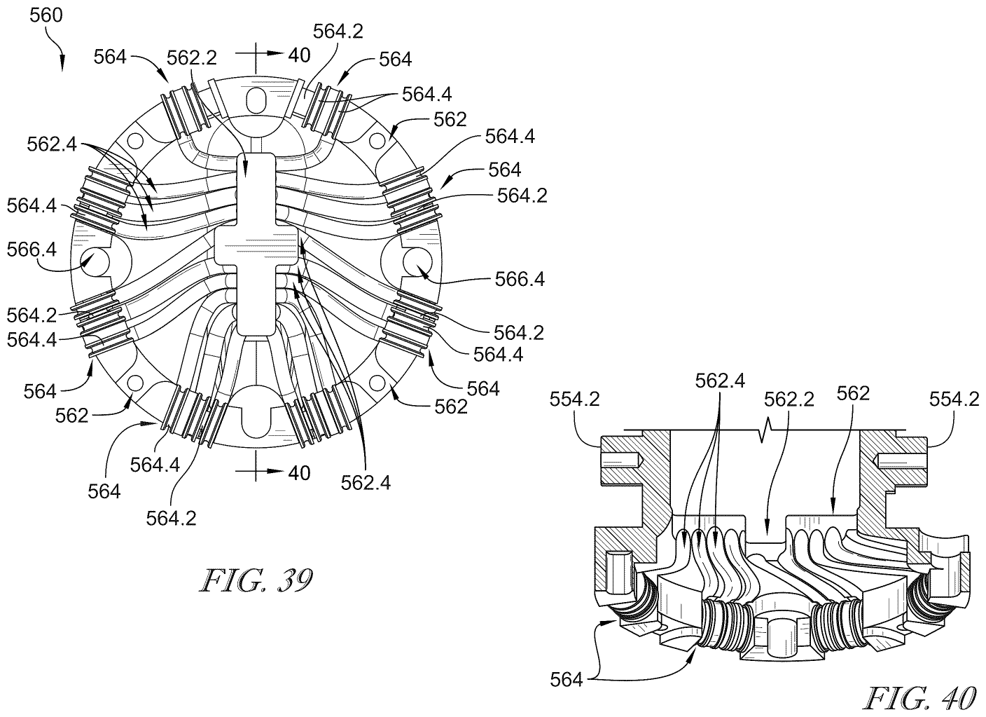

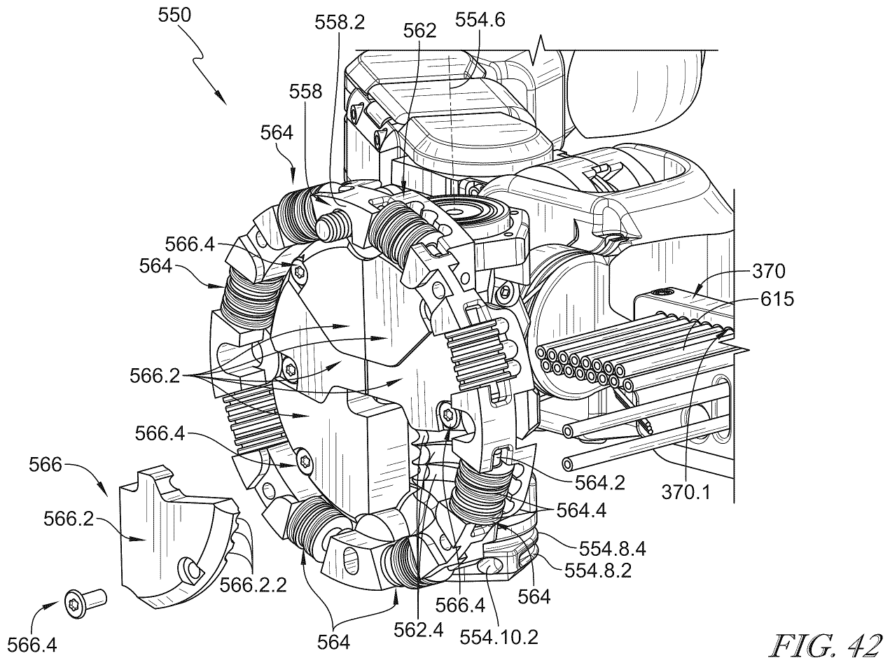

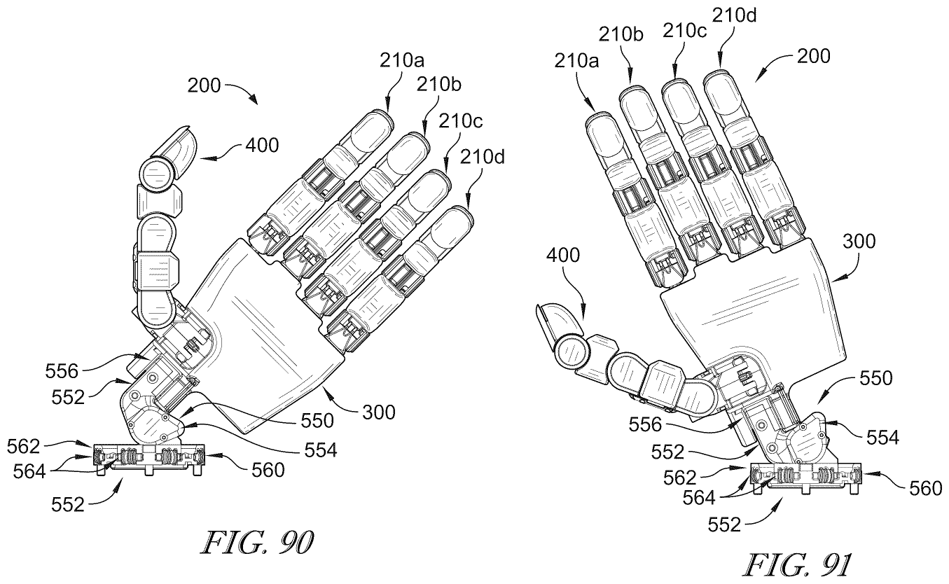

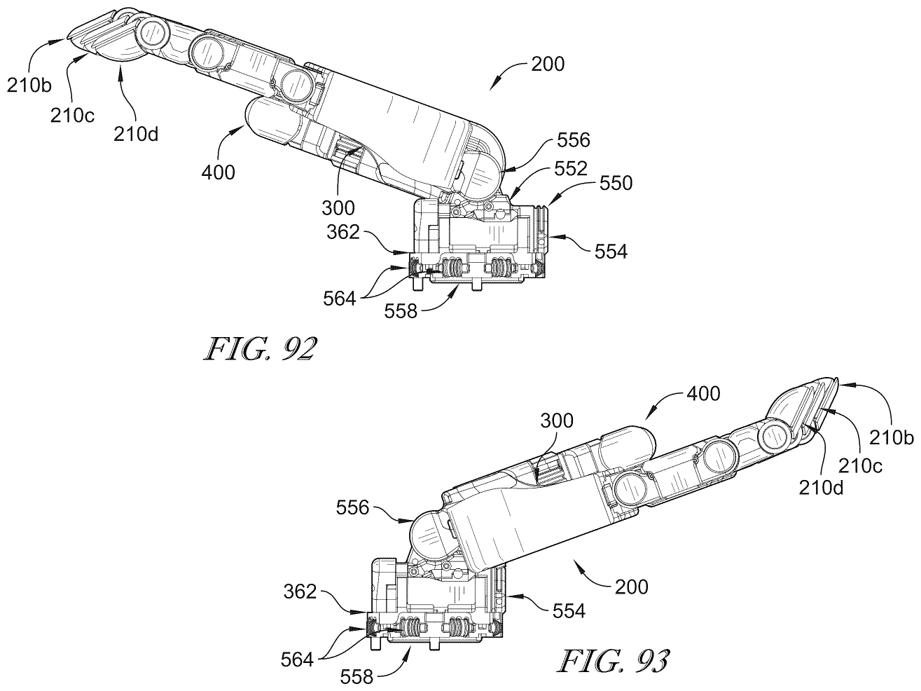

As shown in FIGS. 34-42 and 88-93, the wrist assembly 550 includes: (i) at least a housing coupling component 552, (ii) a yaw component 554, (iii) a pitch component 556, (iv) a base structure 558, and (v) a wrist tendon routing structure 560 (see, e.g., FIGS. 39-41). The wrist assembly 550 is coupled to the wrist mount 310.6 of the palm frame 310 by the housing coupling component 552. The yaw and pitch components 554, 556 are coupled to the housing coupling component 552. As shown in FIGS. 90 and 91, the yaw component 554 is configured to cooperate with the tendon assembly 600 and an actuator 130 to move the hand assembly 200 from side to side (e.g., wave). as shown in FIGS. 92 and 93, The pitch component 556 is configured to cooperate with the tendon assembly 600 and an actuator 130 to move the hand assembly 200 up and down. It should be understood that alternative connection methods or structures may be used. The base structure 558 is configured to couple to the forearm assembly 110. As shown in FIGS. 34 and 42, the wrist tendon routing structure 560 is coupled to the base structure 558 and configured to guide tendons 610 of the tendon assembly 600 from the wrist assembly 550 to the forearm assembly 110.

a. Housing Coupling Component

As shown in FIGS. 34-42 and 88-93, the housing coupling component 552 includes: (i) a base member 552.2, (ii) a cover member 552.4, and (iii) fasteners 552.6. Portions of the yaw and pitch components 554, 556 are coupled to the base member 552.2. of the housing coupling component 552. The base member 552.2 may be modular, with multiple components assembled to attach the palm frame 310 and the base structure 558. The base member 552.2 is also formed to define tendon guides 552.2.2, 552.2.4 through which the tendons for the pitch component 556 of the wrist assembly 550, i.e., WRPE and WRPF, are routed. The wrist pitch tendons WRPE and WRPF are routed through tendon or cable guides 556.8.2, 556.8.4 formed in the thumb receptacle 310.4, through the tendon guides 552.2.2, 552.2.4, through the wrist tendon routing structure 560, and to the respective actuator 130. The cover member 552.4 is coupled to the base member 552.2 over the tendon guides 552.2.2, 552.2.4 to prevent access to the tendons 610. Threaded fasteners 552.6 (e.g., bolts) may be utilized to secure the cover member 552.4 to the base member 552.2 over the tendon guides 552.2.2, 552.2.4. Other suitable fasteners or fastening means may be used, including, but not limited to, screws, pins, rivets, etc.

As shown in FIGS. 37, 88, and 89, the base member 552.2 is also formed to include: (i) tendon or cable guides 554.8.2, 554.8.4 and (ii) ball catches 554.10.2, 554.10.4 of the yaw component 554. The tendons 610 for the yaw component 554 of the wrist assembly 550, i.e., WRYAB and WRYAD, are routed through one of the cable guides 554.8.2, 554.8.4 and attached to a ball 630 that is seated in the respective ball catch 554.10.2, 554.10.4. The wrist yaw tendons WRYAB and WRYAD are routed through the cable guides 554.8.2, 554.8.4 to the wrist tendon routing structure 560, and to the respective actuator 130.

b. Yaw and Pitch Components

As shown in FIGS. 34-42 and 90-93, portions of the yaw and pitch components 554, 556 are coupled to the housing coupling component 552. The yaw component 554 includes pegs 554.2 that mate with bearings 554.4 coupled to the base member 552.2 of the housing coupling component 552. The pegs 554.2 extend from the base structure 558 along a yaw axis 554.6 and into the bearings 554.4 coupled to the base member 552.2 so that the hand assembly 200 may pivot from side to side (e.g., wave) about the yaw axis 554.6, as shown in FIGS. 90 and 91. The pitch component 556 includes pegs 556.2 that mate with bearings 556.4 coupled to the wrist mount 310.6 of the palm frame 310. The pegs 556.2 extend from the base member 552.2 of the housing coupling component 552 along a pitch axis 556.6 and into the bearings 556.4 coupled to the wrist mount 310.6 so that the hand assembly 200 may pivot up and down about the pitch axis 556.6, as shown in FIGS. 92 and 93. Alternatively, the arrangement of the pegs 554.2, 556.2 and bearings 554.4, 556.4 may be reversed for each of the yaw and pitch components 554, 556.

c. Wrist Tendon Routing Structure

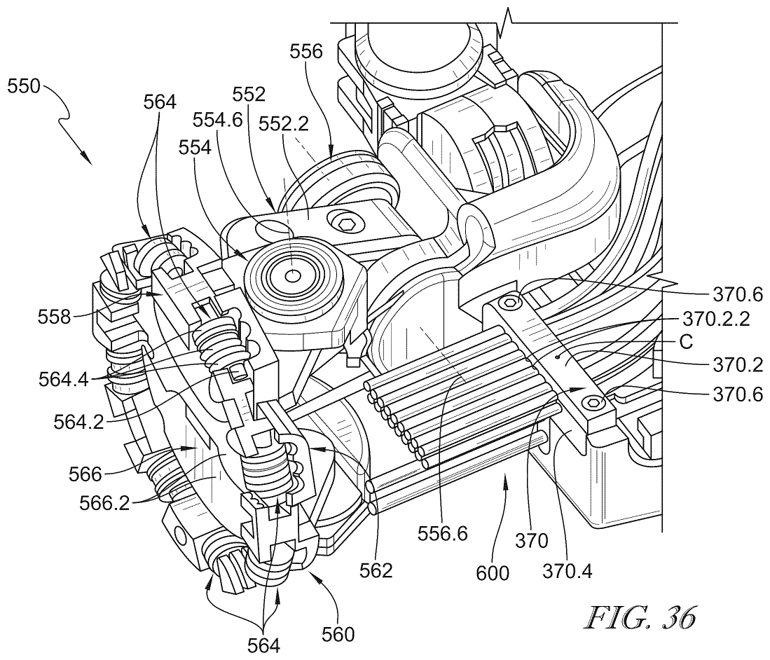

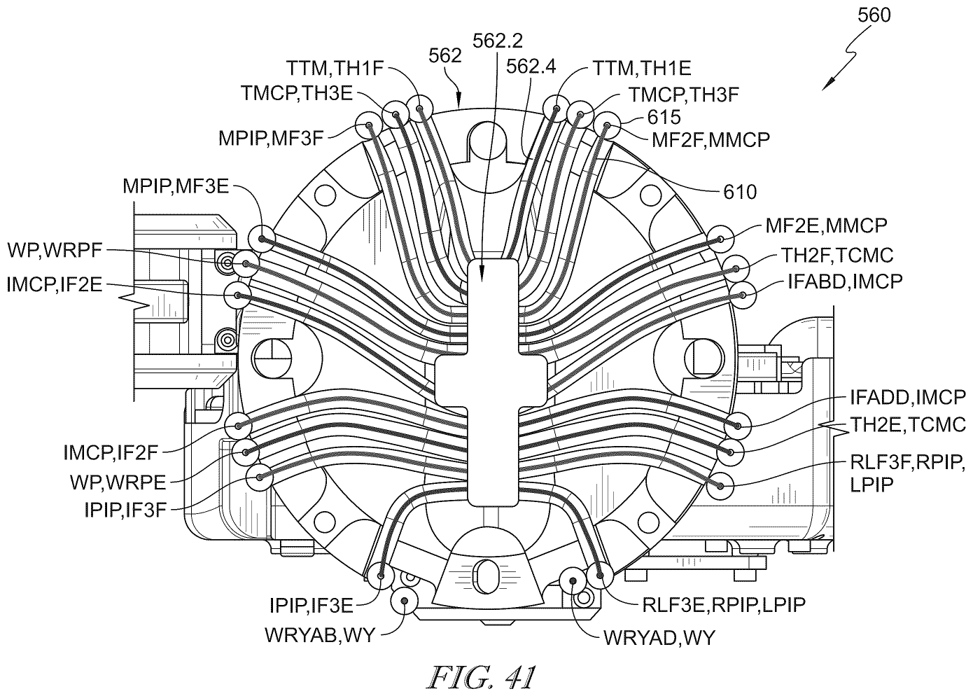

As shown in at least FIGS. 3, 10, and 34, 36, 40-42, the wrist tendon routing structure 560 includes: (i) a routing plate 562, (ii) bushing sub-assemblies 564, and (iii) a clamp assembly 566. The routing plate 562 is coupled to the base structure 558 and is formed with a center aperture 562.2 and guide channels 562.4 for the tendons 610 routed therethrough, as shown in FIGS. 36-41, 46. The bushing sub-assemblies 564 are coupled to the base structure 558 and spaced apart around its outer edge 558.2 of the base structure 558. Each bushing sub-assembly 564 has a dowel 564.2 coupled to the base structure 558 and a plurality of pulleys 564.4 arranged on the dowel 564.2 to rotate about it. As shown in FIG. 41, each tendon 610 is routed through the center aperture 562.2, through a respective guide channel 562.4, and around one of the pulleys 564.4 to the respective actuator 130. The wrist yaw tendons WRYAB and WRYAD are the only tendons not routed through the center aperture 562.2 and the guide channels 562.4. Rather, the wrist yaw tendons WRYAB and WRYAD are routed from the housing coupling component 552 to respective pulleys 564.4. The routing of the tendons 610 through the guide channels 562.4 is discussed in further detail below.

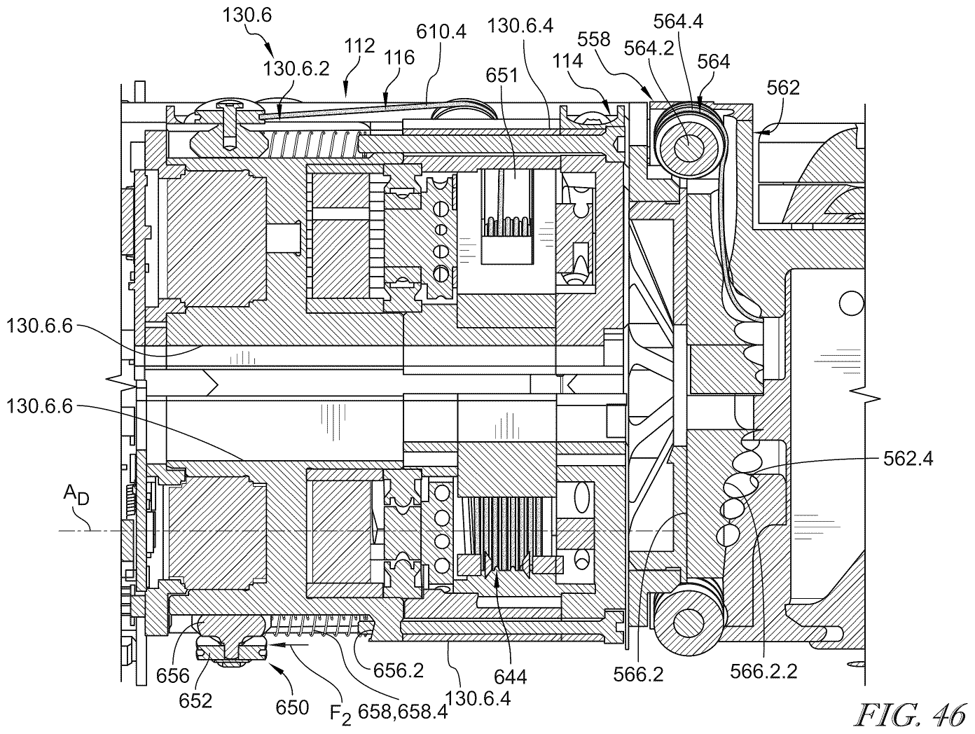

With the tendons 610 routed through the routing plate 562 and the bushing sub-assemblies 564, the clamp assembly 566 has a plurality of clamp plates 566.2 that are each coupled to the routing plate 562 over the tendons 610. Each clamp plate 566.2 has corresponding guide channels 566.2.2 (see, e.g., FIGS. 42 and 46) for the tendons 610 that align with the guide channels 562.4 in the routing plate 562. The clamp plates 566.2 are coupled to the routing plate 562 with fastening means 566.4 including, but not limited to, bolts, screws, pins, rivets, or other suitable fastening means. The clamp plates 566.2 prevent access to the tendons 610 and help guide the respective tendons 610 to the corresponding bushing sub-assembly 564.

### 4. Tendon Assembly

As shown in FIGS. 5-9 and 34-84, the tendon assembly 600 includes: (i) tendons 610, (ii) tendon sheaths or sheaths 615, and (iii) tendon routing structures (e.g., a spool frame 640, a spool 644, a pulley system 650, a wrist tendon routing structure 560). The tendons 610 are routed from components of the hand assembly 200, across respective tendon routing structures, to respective actuators 130 in the forearm assembly 110. Movement of a tendon 610 across these components and structures will cause an extent of a finger 210a-d, thumb 400, or the wrist assembly 550 to move. Specifically, the rotational or angular movement of an actuator 132, 134 will pull one side of the tendon loop and release the opposite side. As such, each tendon is designed to provide either: (i) both extension and flexion, or (ii) both abduction and adduction, thus providing that component with one DoF. This design reduces the required number of actuators 130 and helps minimize the need for syncing actuators 130 for controlling the hand assembly 200.

a. Tendons

The tendons 610 may have any workable configuration or be made from any suitable material, which includes or excludes: (a) a configuration that may be a single strand or a multi-strand (e.g., between 2 and 1000 strands), (b) materials such as steel, high-carbon steel, stainless steel, titanium alloy, tungsten alloy, nitinol, beryllium copper, nickel-chromium alloy, phosphor bronze, molybdenum alloy, rhenium alloy, magnesium alloy, metal wire rope, metal cable, shape memory alloy, copper-based shape memory alloy, iron-based shape memory alloy, polyethylene, ultra-high-molecular-weight polyethylene (UHMWPE), aramid fiber, Kevlar, Technora, Nomex, liquid crystal polymer fiber (LCP), Vectran, poly(p-phenylene-2,6-benzobisoxazole) fiber (PBO), polyhydroquinone-diimidazopyridine fiber (M5), carbon fiber, polyester fiber, polyamide, nylon, polyether ether ketone (peek), polyethylene terephthalate (pet), acetal (pom), polypropylene (pp), polylactic acid (PLA), polyurethane (PU), silicone rubber, liquid crystal elastomer (LCE), thiolene polymer, thermoplastic elastomer (TPE), fishing line, twisted and coiled polymer (TCP) actuator material, supercoiled polymer (SCP) actuator material, electroactive polymer (EAP), composite material, fiber-reinforced polymer (FRP), carbon fiber reinforced polymer (CFRP), aramid fiber reinforced polymer (AFRP), glass fiber reinforced polymer (GFRP), basalt fiber reinforced polymer (BFRP), hybrid fiber-reinforced polymer, metal matrix composite (MMC), polymer nanocomposite, silk fiber, spider silk fiber, collagen fiber, cellulose fiber, or nanocellulose fiber. Additionally, the spool 644 and any component that comes into contact with a tendon 610 may be coated with materials such as hard anodize, hard anodize with PTFE, cerakote, nickel-PTFE composite, electroless nickel plating, titanium nitride (TIN), chromium nitride (CRN), tungsten disulfide (WS2), molybdenum disulfide (MoS2), diamond-like carbon (DLC), plasma electrolytic oxidation (PEO), physical vapor deposition (PVD), boron nitride, nickel, silicon nitride, graphene, polymer, ceramic, or any similar coating.

The tendon assembly 600, as illustrated in the example embodiment, includes eleven tendons 610, which each tendon 610 having extension/flexion or abduction/addition portions. These eleven tendon 610 can be allocated as follows: (i) three tendons actuate the index finger (3 DoF), (ii) two tendons actuate the middle finger (2 DoF), (iii) one tendon actuates the combined ring and little fingers (1 DoF), (iv) three tendons actuate the thumb (3 DoF), and (v) two tendons actuate the wrist (2 DoF for pitch and yaw). The actuators associated with each of the eleven tendons 610, with the respective tendon portions, are positioned in the following locations in the forearm assembly 110:

i. Index Finger—IF

The index finger 210a is controlled by at least three tendons 610: (i) a first tendon (may also be referred to as a finger ABD/ADD tendon or, if separated, an finger ABD tendon and finger ADD tendon) comprised of tendon portions IF1ABD and IF1ADD to control abduction and adduction at the MCP joint (IMCP, IF1), (ii) a second tendon (may also be referred to as an index proximal tendon, index MCP tendon, or, if separated, an index MCP extension tendon and index MCP flexion tendon) comprised of tendon portions IF2E and IF2F to control extension and flexion at the MCP joint (IMCP, IF2), and (iii) a third tendon (may also be referred to as an index medial tendon, index PIP tendon, or, if separated, an index PIP extension tendon and index PIP flexion tendon) comprised of tendons IF3E and IF3F to control extension and flexion at the PIP joint (IPIP, IF3).

The intermediate portion 118 of the frame 112 contains the actuator 132 that controls abduction and adduction at the MCP joint (IMCP, IF1) and is coupled to tendon portions IF1ABD and IF1ADD. The tendon portions IF1ABD and IF1ADD are also referred to as IF1E and IF1F. The intermediate portion 118 of the frame 112 also contains the actuator 132 that controls flexion and extension at the MCP joint (IMCP, IF2) and is coupled to tendon portions IF2E and IF2F. The distal portion 116 of the frame 112 contains the actuator 132 that controls flexion and extension at the PIP joint (IPIP, IF3) and is coupled to tendon portions IF3E and IF3F.

ii. Middle Finger—MF

The middle finger 210b is controlled by at least two tendons 610: (i) a first tendon (may also be referred to as an index middle tendon, middle MCP tendon, or, if separated, an middle MCP extension tendon and middle MCP flexion tendon) comprised of tendon portions MF2E and MF2F to control abduction and adduction at the MCP joint (MMCP, MF2) and (ii) a second tendon (may also be referred to as an middle medial tendon, middle PIP tendon, or, if separated, an middle PIP extension tendon and middle PIP flexion tendon) comprised of tendon portions MF3E and MF3F to control extension and flexion at the PIP joint (MPIP, MF3). The distal portion 116 of the frame 112 contains the actuator 132 that controls flexion and extension at the MCP joint (MMCP, MF2) and is coupled to tendon MF2E and MF2F. The distal portion 116 of the frame 112 also contains the actuator 132 that controls flexion and extension at the PIP joint (MPIP, MF3) and is coupled to tendon MF3E and MF3F.

iii. Ring and Little Fingers—RF, LF

The ring finger 210c and the little finger 210d are both controlled by a single tendon comprised of: (i) tendon portions RLF3E and RLF3F, (ii) tendon portions RF3E and LF3E, and (iii) tendon portions RF3F and LF3F. In alternative embodiments, the ring finger 210c and the little finger 210d may be controlled by separate tendons for each finger. The distal portion 116 of the frame 112 contains the actuator 132 that controls flexion and extension at the PIP joint (RPIP, RLF3) and is coupled to tendon portions RLF3E and RLF3F. The tendon portions RLF3E and RLF3F are coupled to the slides 334.2, 334.4 and routed back to the respective actuator 132. Separate tendon portions RF3E/LF3E and RF3F/LF3F are routed around the respective wheel guides 336.2, 336.4 to the fingers 210c, 210d. One end RF3E of the tendon RF3E/LF3E is routed to the ring finger 210c, and the other end LF3E of the tendon portion RF3E/LF3E is routed to the little finger 210d. Similarly, For the other tendon portion RF3F/LF3F, one end RF3F is routed to the ring finger 210c, and the other end LF3F is routed to the little finger 210d.

iv. Thumb—TH

The thumb 400 is controlled by at least three tendons 610: (i) a first tendon (may also be referred to as a thumb ABD/ADD tendon or, if separated, an thumb ABD tendon and thumb ADD tendon) comprised of tendon portions TH1ABD and TH1ADD to control abduction and adduction at the TTM joint (TTM, TH1), (ii) a second tendon (may also be referred to as an TCMC tendon, or, if separated, an TCMC extension tendon and TCMC flexion tendon) comprised of portions TH2E and TH2F to control extension and flexion at the TCMC joint (TCMC, TH2), and (iii) a third tendon (may also be referred to as an TMCP tendon, or, if separated, an TMCP extension tendon and TMCP flexion tendon) comprised of portions TH3E, and TH3F to control extension and flexion at the TMCP joint (TMCP, TH3). The proximal portion 120 of the frame 112 contains the actuator 134 that controls abduction and adduction at the TTM joint (TTM, TH1) and is coupled to tendon portions TH1ABD and TH1ADD. The tendon portions TH1ABD and TH1ADD are also referred to as TH1E and TH1F. The proximal portion 120 of the frame 112 also contains the actuator 134 that controls flexion and extension at the TCMC joint (TCMC, TH2) and is coupled to tendon portions TH2E and TH2F. The intermediate portion 118 of the frame 112 contains the actuator 132 that controls flexion and extension at the TMCP joint (TMCP, TH3) and is coupled to tendon portions TH3E and TH3F.

v. Wrist—WR

The wrist assembly 550 is controlled by at least two tendons: (i) a first tendon (may also be referred to as an yaw tendon, or, if separated, an yaw max tendon and yaw min tendon) comprised of tendon portions WRYAB and WRYAD that controls yaw (WY) of the wrist assembly 550 and (ii) a second tendon (may also be referred to as an pitch tendon, or, if separated, an pitch max tendon and pitch min tendon) comprised of tendon portions WRPE and WRPF to control pitch (WP) of the wrist assembly 550. The intermediate portion 118 of the frame 112 contains the actuator 134 that controls yaw (WY) and is coupled to tendon portions WRYAB and WRYAD. The proximal portion 120 of the frame 112 contains the actuator 134 that controls pitch (WP) and is coupled to tendon portions WRPE and WRPF.

b. Tendon Routing Structures

The tendon routing structures (e.g., a spool frame 640, a spool 644, a pulley system 650, a wrist tendon routing structure 560) are configured to route the tendons 610 from components of the hand assembly 200, through the wrist assembly 550, and to the respective actuators 130 in the forearm assembly 110. To interact with these tendons 610, the above-disclosed actuators 132, 134 have been modified to include a spool frame 640, a spool 644, and a pulley system 650 (e.g., spindles 651, pulleys or cable guides 652, 654, sliding members 656, biasing members 658). The spool 644 is attached to the output shaft 131.4 of the cycloidal gearing, and an end of the tendon 610 is wrapped around the spool 644. The spool frame 640 may surround and protect portions of the pulley system 650 and the tendon 610. The spool 644 has projections 644.2 and grooves 644.4 formed therein that guide the tendon 610 when it is wound around the spool 644.

As shown in FIGS. 5-9 and 46, the pulley system 650 includes (i) spindles 651, (ii) first pulleys 652, (iii) second pulleys 654, (iv) sliding members 656, and (v) biasing members 658. The spindles 651 are rotatably coupled to the spool frame 640 and arranged parallel with the spool 644. As shown in the disclosed embodiment, the first pulley 652 may be in a fixed location, while the second pulley 654 may be in a non-fixed location. The first pulleys 652 are rotatably coupled to the spool frame 640 on either side of the actuator 130, adjacent to one of the spindles 651. The second pulleys 654 are rotatably coupled to sliding members 656, which allow the second pulleys 654 to move up and down within a channel 656.2 formed in the side of the actuator housing 131.12. In further embodiments, the second pulley 654 may be in a fixed location, and the first pulley 652 may be in a non-fixed location.

The sliding members 656 are configured to slide relative to the respective actuator 130 within the channel 656.2 formed in the actuator housing 131.12. The biasing members 658 (e.g., a spring, an alternative linear elastic element, and/or a nonlinear elastic element) are arranged between the sliding member 656 and the actuator housing 131.12 within the respective channel 656.2. The sliding member 656 is biased downward or away from the end effector 200 by the corresponding biasing member 658, which may be any known mechanism, including a coil spring. As such, a first biasing member 658.2 on one actuator 130 is configured to apply a first biasing force F₁ on the first tendon 610.2, and a second biasing member 658.4 on a different actuator 130 is configured to apply a second biasing force F₂ on the second tendon 610.4. Preferably, the first biasing force F₁ is about equal to the second biasing force F₂, but the first biasing force F₁ may be different from the second biasing force F₂ in some embodiments. The combination of the sliding member 656 and the corresponding biasing member 658 is designed to provide compliance within the system to help increase the durability of the end effector 200. In other words, when an external force is applied to the end effector 200, one or more sliding members 656 can move within their respective channels 656.2, thereby causing the corresponding second pulley 654 to move up or down relative to the base of the hand housing 300. This movement allows the system to absorb the external force to the end effector 200 without causing the tendons 610 with corresponding biasing members 656 to break. In other embodiments, the second pulley 654 may be fixed and may not be able to slide within the channel 656.2.

The tendon 610 extends tangentially away from the spool 644 to the spindle 651, which is positioned substantially parallel with said spool 644. The spindle 651 includes a concave profile to help position the tendon 610 properly to engage the first pulley 652. The first pulley 652 causes the tendon 610 to turn 90 degrees towards the motor portion of the rotary actuator 132, 134. The tendon 610 then passes through the second pulley 654, which turns it 180 degrees so that the tendon 610 is directed back towards the cycloidal gear side of the actuator 132, 134. From the second pulley 654, the tendon 610 then extends to the wrist tendon routing structure 560 in the wrist assembly 550.

Once the tendon 610 reaches the wrist tendon routing structure 560, then one of the pulleys 564.4 on the respective bushing sub-assembly 564 enables the tendon 610 to bend 90 degrees inward towards the center of the wrist assembly 550. Once around said pulley 564.4, the tendon 610 is positioned within one of the guide channels 562.4 formed in the routing plate 562. As shown in FIGS. 39 and 41, the guide channel 562.4 in the wrist tendon routing structure 560 is not linear but is instead a complex structure with multiple curvatures in two different planes. In other embodiments, any other pulley configuration can be used. In some embodiments, the spool 644 can have a spiral groove 644.2, and a line feeding system can be attached to the spool frame 640 to align the line with the guide channel 562.4, ensuring that the line does not overlap any line already wrapped on the spool 644.

The tendons 610 (specifically, IF1ABD, IF1ADD, IF2E, IF2F, IF3E, IF3F, MF2E, MF2F, MF3E, MF3F, RLF3E, RLF3F, TH1ABD, TH1ADD, TH2E, TH2F, TH3E, TH3F, WRPE, WRPF) are routed through one of the pulleys 564.4 to bend 90 degrees inward towards the center of the wrist assembly 550 to be routed through the center aperture 562.2 in the routing plate 562. The wrist yaw tendons WRYAB and WRYAD are routed through one of the pulleys 564.4 but do not bend 90 degrees inward. Instead, the wrist yaw tendons WRYAB and WRYAD extend from the pulleys 564.4 to the housing coupling component 552 to control the yaw component 554.

Once each tendon 610 exits the wrist tendon routing structure 560 through the center aperture 562.2 at the center of said tendon routing structure 560, each tendon 610 is positioned within a corresponding sheath 615. Said sheaths 615 include a first extent that is positioned within the carpal tunnel-like structure, (ii) a second extent that extends towards the finger assembly, and (iii) a third extent that extends towards the wrist assembly. Each tendon 610 then continues through its sheath 615, through the opening 370.1 in the carpal tunnel-like structure 370, through the cavity 310.2.10, into an upper extent of the hand housing 300, and to the respective finger assemblies 210a-d. As shown FIG. 35, the opening in an upper extent of the hand housing 300, where the tendons 610 enter into said hand housing 300 from the finger assemblies 210a-d, has a first distance D_{P1}, while a lower-middle extent of the hand housing 300 includes the narrowing cavity 310.2.10, where the tendons are most compressed, which has a second distance D_{P2}. This second distance D_{P2} extends between two interior curvilinear surfaces, wherein the first interior curvilinear surface 310.2.8.2.2 is associated with the thumb 400, and a second interior curvilinear surface 310.2.6.2 is associated with either the little finger 210d, the ring finger 210c, the finger coupler 330, or a combination thereof. The second distance D_{P2} is less than 45% of the first distance D_{P1}, and preferably less than 35% of the first distance D_{P1}. Also, the third distance D_{P3} may be greater than 15% of the second distance D_{P2}, and preferably greater than 25% of the second distance D_{P2}. The carpal tunnel-like structure 370 is configured to route the tendons 610 (via the opening 370.1) through the narrow section of the hand housing 300 into the cavity 310.2.10.

Also, as shown in FIG. 35 and to facilitate the routing of the tendons 610, the sheaths 615 extend from the finger and thumb assemblies 210a-d, 400, into an upper extent of the hand housing 300, through the narrowing cavity 310.2.10, and into the tunnel structure 370. As such, a sheath 615 may include a jogged configuration, wherein a first sheath 615 may have a first jog distance D_{J1} and a second sheath 615 may have a second jog distance D_{J2}. Said second jog distance D_{J2} may be substantially less than the first jog distance D_{J1}, and both the first and second jog distances D_{J2}, D_{J2} may be less than 70% of the first distance D_{P1}, and may be greater than 30% of the first distance D_{P1}.

The sheaths 615 may have a tubular configuration and may be made from materials such as polytetrafluoroethylene (PTFE), ultra-high molecular weight polyethylene, UHMWPE, polyether ether ketone, PEEK, polyimide, Nylon, polyamide, Nylon 6, Nylon 6/6, Nylon 11, Nylon 12, filled polyamide, Acetal, polyoxymethylene, POM, polyethylene, PE, high-density polyethylene, HDPE, low-density polyethylene, LDPE, polypropylene, P_{P}, silicone polymer, silicone rubber, thermoplastic elastomer, TPE, thermoplastic polyurethane, TPU, thermoplastic polyester elastomer, TPEE, copolyester elastomer, styrenic block copolymer elastomer, TPE-S, thermoplastic vulcanizate, TPE-V, polyamide elastomer, TPE-A, polyurethane, PU, polyvinyl chloride, PVC, fiber-reinforced polymer, FRP, carbon fiber composite, carbon fiber reinforced polymer, fiberglass composite, glass fiber reinforced polymer, GFRP, aramid fiber composite, aramid fiber reinforced polymer, spider silk composite, wear-resistant alloy, Hardox steel, Ultimet alloy, shape memory alloy, SMA, Nitinol, stainless steel, self-healing polymer, conductive polymer, piezoelectric polymer, polyvinylidene fluoride, PVDF, diamond-like carbon coating, DLC coating, PTFE coating, molybdenum disulfide coating, MoS2 coating. In other embodiments, the sheaths 615 may be omitted, or their length may be reduced.

Once each tendon 610 reaches the upper extent of the hand housing 300, it can now interact with the following components, structures, and/or parts of its associated finger assembly 210a-d. As shown in the Figures, there are eleven tendon loops 610, wherein each tendon loop 610 is comprised of: (i) an extension side (denoted as an “E”) and an opposed flexion side (denoted as an “F”), or (ii) an abduction side (denoted as an “ABD”) and an opposed adduction side (denoted as an “ADD”). For ease of reference, Applicant has color-coded the tendons for ease of reference. In particular, the extension/adduction side of the tendon 610 is shown in blue, and the flexion/abduction side is shown in red (see. e.g., FIGS. 55, 57-61, 63-67, 69-73, 76-78, and 83). While the following disclosure focuses on the index finger, it should be understood that this disclosure is equally applicable to other fingers. Additionally, while the disclosed tendons 610 are described as being a continuous loop, it should be understood that the sides of the loop can be split into separate and distinct tendons.

As shown in FIGS. 54, 58, 60, the IF2F tendon (flexion), shown in red, controls flexion at the first (MCP) joint. The IF2F tendon 610 is routed through the lower portion 224.6 of the support base 224 of the knuckle assembly 220, through one of the cable guide slots 262.2 on the exterior of the bottom member 252, and is attached to a first ball 630 that is received in the ball recess 272.8.2 of the second slot 272.8 of the proximal member 272. As shown in FIGS. 55, 57, and 61, the opposing side of the IF2F tendon or the IF2E tendon (extension), is shown in blue and controls extension at the first (MCP) joint. Said IF2E tendon 610 is attached to a second ball 630 that is positioned in the ball recess 272.6.2 and is routed through one of the cable guide slots 246.2 on the exterior of the top member 242 of the knuckle assembly 220 and returns through the upper portion 224.4 of the support base 224.

Each of the IF2F and IF2E tendons have an actuator ball 631 that is coupled to the opposite end from the ball 630. The actuator ball 631 is attached to the respective actuator 130 housed in the forearm assembly 110 like as shown in FIG. 9. This connects the IF2F and IF2E tendons to the actuator 130. In other embodiments, the blue and red portions of the tendon loop 610 are joined at the actuator ball 631 to create a tendon loop, and the actuator ball 631 is coupled to the actuator 130 housed in the forearm assembly 110.

FIGS. 55, 57, 61, 63, and 66 show the IF3F tendon (flexion), shown in red, which is configured to control flexion at the second (PIP) joint. Said IF3F tendon is routed through the lower portion 224.6 of the support base 224 of the knuckle assembly 220, through the cable guide slots 262.2 on the exterior of the bottom member 252, into the first slot 272.6 of the proximal member 272, then over the wheels 282 of the proximal member 272, and into the bottom guide slot 292.2.4.6, with its attached first ball 630 seated in the bottom ball seat 292.2.4.8. Likewise, the IF3E tendon (extension), shown in FIGS. 54, 58, 60, 64, and 67 in blue, is configured to control the extension at the second (PIP) joint. Said IF3E tendon is attached to a second ball 630 in the top ball seat 292.2.4.4, routed through the top guide slot 292.2.4.2, through the second slot 272.8 of the proximal member 272, then through the cable guide slots 246.2 on the exterior of the top member 242 of the knuckle assembly 220, and returns through the upper portion 224.4 of the support base 224.

Each of the IF3F and IF3E tendons have an actuator ball 631 that is coupled to the opposite end from the ball 630. The actuator ball 631 is attached to the respective actuator 130 housed in the forearm assembly 110 like as shown in FIG. 9. This connects the IF3F and IF3E tendons to the actuator 130. In other embodiments, the blue and red portions of the tendon 610 are joined at the actuator ball 631 to create a tendon loop, and the actuator ball 631 is coupled to the actuator 130 housed in the forearm assembly 110.

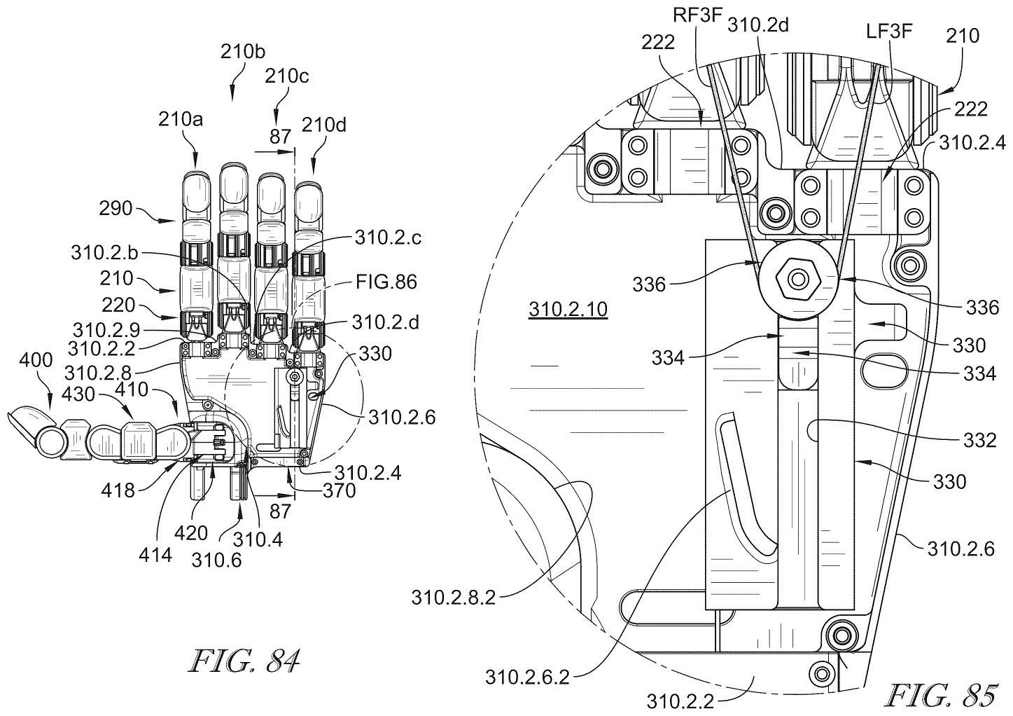

A similar routing to the second (PIP) finger joint of the ring finger 210c and little finger 210d can be modified so that flexion of the second (PIP) finger joints of the ring finger 210c and little finger 210d are coupled together and extension of the second (PIP) finger joints of the ring finger 210c and little finger 210d are coupled together, and each coupled action indirectly causes bending in the first (MCP) finger joint. As shown in FIGS. 85-87, the finger coupler 330 includes the track 332 with the track channels 332.2, 332.4, the slides 334.2, 334.4, and the wheel guides 336.2, 336.4 coupled to either the bottom slide 334.2 or the top slide 334.4. A cable portion (e.g., RLF3E, RLF3F) is coupled between the slides 334.2, 334.4 and the assigned actuator 134 in the forearm assembly 110. The cables or tendons RLF3E, RLF3F are coupled to the respective slide 334.2, 334.4 and extend through guide channels 332.6.2, 332.6.4. The top wheel guide 336.4 is configured to hold a u-shaped cable (e.g., RF3E, LF3E) with balls 630 on each end, where one cable portion (RF3E) follows the blue path for the ring finger 210c and the other (LF3E) follows the blue path for the little finger 210d. Similarly, the bottom wheel guide 336.2 is configured to hold a u-shaped cable (e.g., RF3F, LF3F), where one cable portion (RF3F) follows the red path for the ring finger 210c and the other (LF3F) follows the red path for the little finger 210d. Thus, the movement of both fingers 210c, 210d is coupled, and flexion and extension of the second (PIP) finger joints are controlled by the movement of the slides 334.2, 334.4.

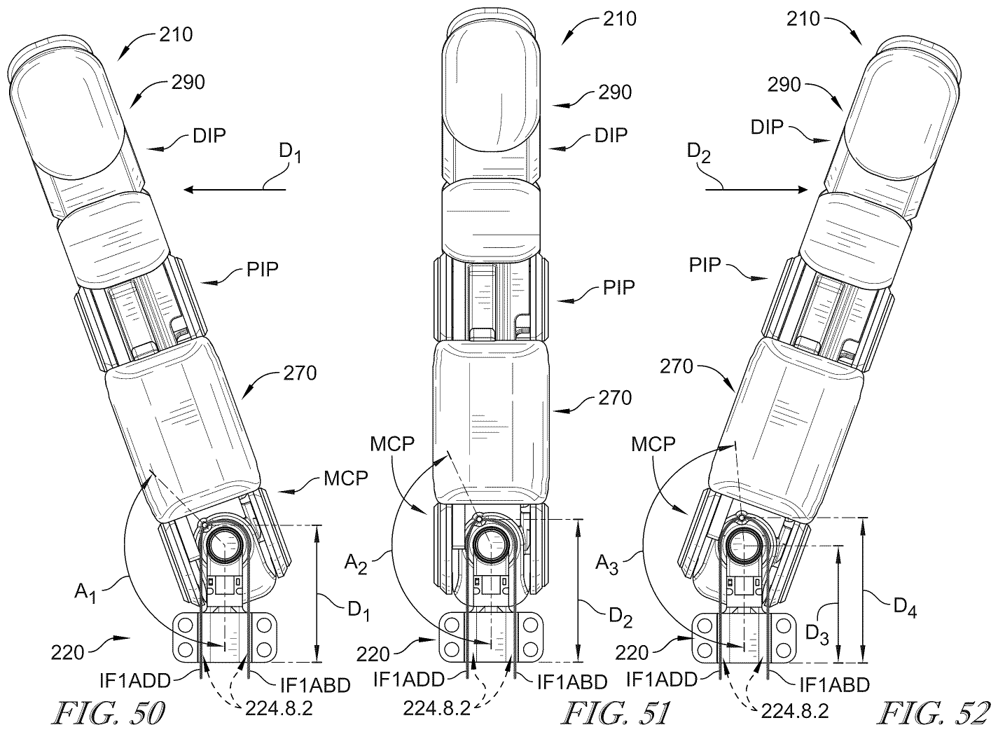

FIGS. 48 and 50-52 show the IF1ABD and IF1ADD tendons that control adduction (shown in blue) and abduction (shown in red) at the first (MCP) finger joint of the index finger 210a. The IF1ABD and IF1ADD tendons 610 are guided in the cable recess 244.4, and an attached ball 630 is retained in the ball seat 244.6 of the top member 242 of the knuckle enclosure 240. As shown in FIGS. 50-52, the IFABD tendon 610 is routed through the center portion 224.2 of the support base 224 of the knuckle assembly 220, through one of the cable passageway 224.8.2, and is attached to a ball 630 located in the ball seat 244.6. As shown in FIGS. 50-52, the IFADD tendon 610 is routed through the center portion 224.2 of the support base 224 of the knuckle assembly 220, through the other cable passageway 224.8.2, and is attached to the ball 630 located in the ball seat 244.6.

FIGS. 48 and 51 illustrate the index finger 210a in an uncurled state. The tendon 610 is routed through the cable passageways 224.8.2 in the support base 224 with an attached ball 630 positioned to be received in the knuckle enclosure 240, and specifically in ball seat 244.6 of the top member 242. In this configuration, the tendon 610 is configured to move the finger assembly 210a for abduction and adduction.

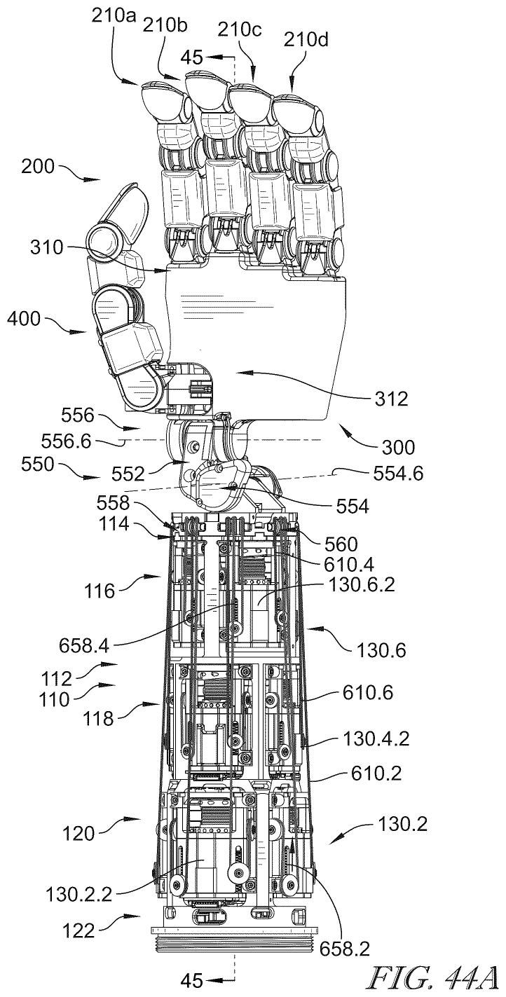

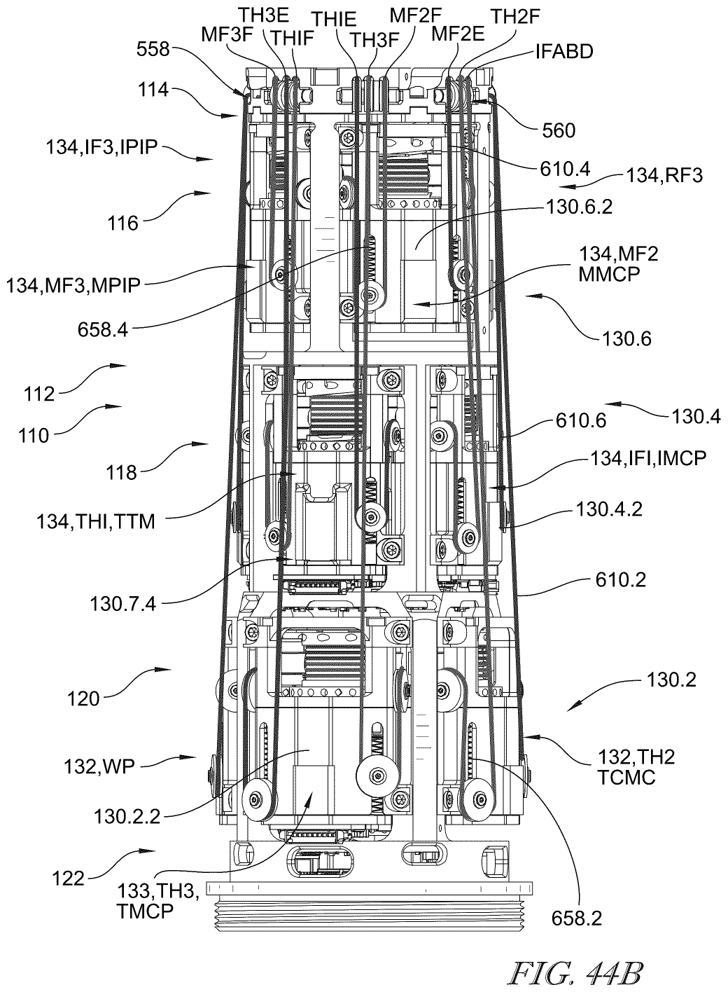

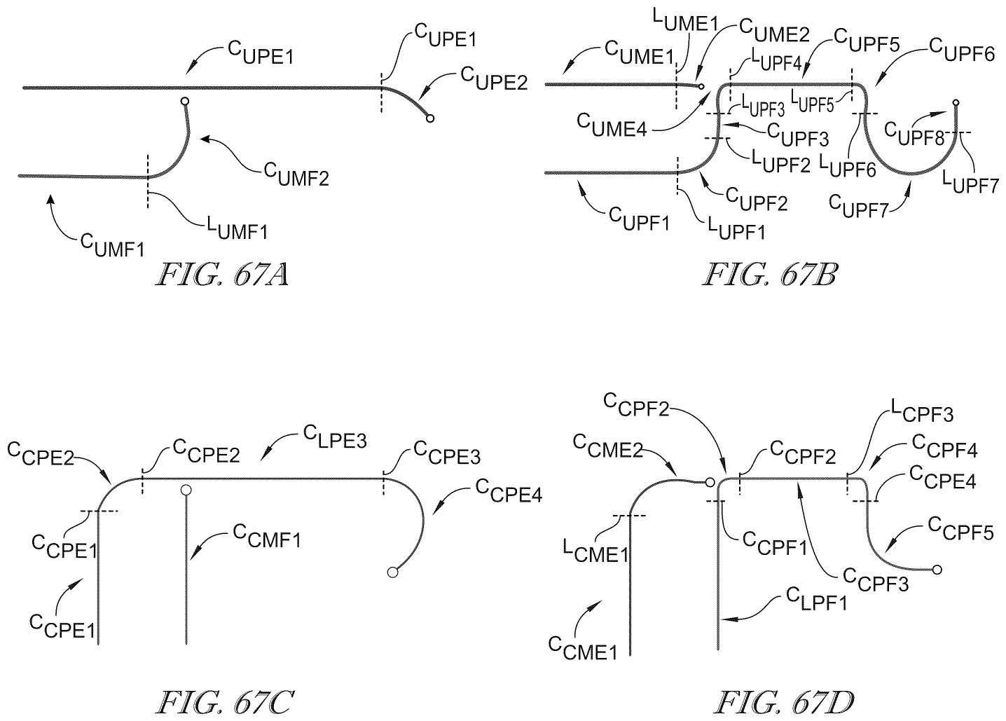

FIGS. 44, 45, and 67A-67D illustrate a first tendon 610.2 has a first total curvature or bentness over the length of the tendon in the uncurled state, wherein the first total curvature is a summation of absolute curvature values of said tendon 610.2. For example, the first total curvature or bentness of MCP extension tendon (blue) shown in FIG. 67B includes the summation of: (i) the first partial curvature value C_{UME1} associated with a first extent of the tendon that extends from the edge of the finger assembly to line L_{UME1}, and (ii) the second partial curvature value C_{UME2} associated with a second extent of the tendon that extends from line L_{UME1} to the end or ball. The first tendon 610.4 has a second total curvature or bentness over the length of the tendon in the uncurled state, wherein the second total curvature is a summation of absolute curvature values of said tendon 610.4. Specifically, the second total curvature or bentness of PIP extension tendon (blue) shown in FIG. 67A includes the summation of: (i) the first partial curvature value C_{UPE1} associated with a first extent of the tendon that extends from the edge of the finger assembly to line L_{UPE1}, and (ii) the second partial curvature value C_{UPE2} associated with a second extent of the tendon that extends from line L_{UPE1} to the end or ball. Here, it can be seen that the first total curvature or bentness of MCP extension tendon (blue) is less than the second total curvature or bentness of PIP extension tendon (blue).

The first or third total curvature or bentness of MCP flexion tendon (red) shown in FIG. 67A includes the summation of: (i) the first partial curvature value C_{UMF1} associated with a first extent of the tendon that extends from the edge of the finger assembly to line L_{UMF1}, and (ii) the second partial curvature value C_{UMF2} associated with a second extent of the tendon that extends from line L_{UMF1} to the end or ball. The second or fourth total curvature or bentness of PIP flexion tendon (red) shown in FIG. 67B includes the summation of: (i) the first partial curvature value C_{UPF1} associated with a first extent of the tendon that extends from the edge of the finger assembly to line L_{UPF1}, (ii) the second partial curvature value C_{UPF2} associated with a second extent of the tendon that extends from line L_{UPF1} to line L_{UPF2}, (iii) the third partial curvature value C_{UPF3} associated with a third extent of the tendon that extends from line L_{UPF2} to line L_{UPF3}, (iv) the fourth partial curvature value C_{UPF4} associated with a fourth extent of the tendon that extends from line L_{UPF3} to line L_{UPF4}, (v) the fifth partial curvature value C_{UPF5} associated with a fifth extent of the tendon that extends from line L_{UPF4} to line L_{UPF5}, (vi) the sixth partial curvature value C_{UPF6} associated with a sixth extent of the tendon that extends from line L_{UPF5} to line L_{UPF6}, (vii) the seventh partial curvature value C_{UPF7} associated with a seventh extent of the tendon that extends from line L_{UPF6} to line L_{UPF7}, and (ix) the eighth partial curvature value C_{UPE8} associated with a eighth extent of the tendon that extends from line L_{UPE7} to the end or ball. Here, it can be seen that the first or third total curvature or bentness of MCP flexion tendon (red) is less than the second or fourth total curvature or bentness of PIP flexion tendon (red).

As shown in FIGS. 67C and 67D, the curvature of each tendon changes as the finger assembly moves from the uncurled state to a curled state. In comparison to the uncurled state, the total curvature or bentness of MCP extension tendon (blue) increases in the curled state. Specifically, the total curvature of the MCP extension tendon (blue) in the curled state includes the summation of: (i) the first partial curvature value C_{CME1} associated with a first extent of the tendon that extends from the edge of the finger assembly to line L_{CME1}, and (ii) the second partial curvature value C_{CME2} associated with a second extent of the tendon that extends from line L_{CME1} to the end or ball. Likewise and in comparison to the uncurled state, the total curvature or bentness of PIP extension tendon (blue) increases in the curled state. Specifically, the total curvature of the PIP extension tendon (blue) in the curled state includes the summation of: (i) the first partial curvature value C_{CPE1} associated with a first extent of the tendon that extends from the edge of the finger assembly to line L_{CPE1}, (ii) the second partial curvature value C_{CPE2} associated with a second extent of the tendon that extends from line L_{CPE1} to line L_{CPE2}, (iii) the third partial curvature value C_{CPE3} associated with a third extent of the tendon that extends from line L_{CPE2} to line L_{CPE3}, and (iv) the fourth partial curvature value C_{CPE4} associated with a fourth extent of the tendon that extends from line L_{CPE3} the end or ball.

Also and in comparison to the uncurled state, the total curvature or bentness of MCP flexion tendon (red) decreases in the curled state. Specifically, the total curvature of the MCP flexion tendon (red) in the curled state includes the first partial curvature value C_{CMF1} associated with a first extent of the tendon that extends from the edge of the finger assembly to the end or ball. It should be noted that the first partial curvature value C_{CMF1} of the MCP flexion tendon (red) in the curled state is equal to zero in this exemplary embodiment. Likewise and in comparison to the uncurled state, the total curvature or bentness of PIP flexion tendon (red) decreases in the curled state. Specifically, the total curvature of the PIP flexion tendon (red) in the curled state includes the summation of: (i) the first partial curvature value C_{CPF1} associated with a first extent of the tendon that extends from the edge of the finger assembly to line L_{CPF1}, (ii) the second partial curvature value C_{CPF2} associated with a second extent of the tendon that extends from line L_{CPF1} to line L_{CPF2}, (iii) the third partial curvature value C_{CPF3} associated with a third extent of the tendon that extends from line L_{CPF2} to line L_{CPF3}, (iv) the fourth partial curvature value C_{CPF4} associated with a fourth extent of the tendon that extends from line L_{CPF3} to line L_{CPF4}, and (v) the fifth partial curvature value C_{CPF5} associated with a fifth extent of the tendon that extends from line L_{CPF4} to the end or ball. It should be understood that the above described and shown curvatures are only for a portion of each tendon and do not represent the total curvature; nevertheless, the same principles that are shown here can be used to calculate the total curvature for any tendon contained within the end effector. Furthermore, it should be understood that the total curvature can be measured in mm⁻¹, while other measurement units are contemplated by this disclosure.

It may be desirable to reduce the curvature of the tendon if the application of force needed from said tendon needs to increase, or if the acceleration of the reaction of said tendon needs to increase, and/or if the usage of said tendon needs to increase. For example, it may be desirable to use a tendon that includes less curvature for a movement of the end effector 200 that needs more force than other movements. Specifically, it may be desirable to have the tendons WRYAB, WRYAD, WRPE, WRPF that move the wrist 550 include less curvature than the tendons RLF3E, RLF3F that move the little finger. In another example, it may be desirable for a second tendon (associated with am extent of a finger 210a-d, e.g., IF3E, IF3F, MF2E, MF2F, MF3E, MF3F, RLF3E, RLF3F) 610.4 to have a second curvature that is greater than a first curvature of a first tendon (associated with an extent of the thumb 400, e.g., TH1E, TH1F, TH2E, TH2F) 610.2, when the application of force that is associated with the second tendon 610.4 is less than the application of force associated with the first tendon 610.2. In a further example, it may be desirable for a second tendon 610.4 to have a second curvature that is greater than the first curvature of the first tendon 610.2, when the frequency of use associated with the second tendon 610.4 is less than the frequency of use associated with the first tendon 610.2. Finally, it may be desirable for a second tendon 610.4 to have a second curvature that is greater than the first curvature of the first tendon 610.2, when the acceleration need associated with the second tendon 610.4 is less than the acceleration need associated with the first tendon 610.2.

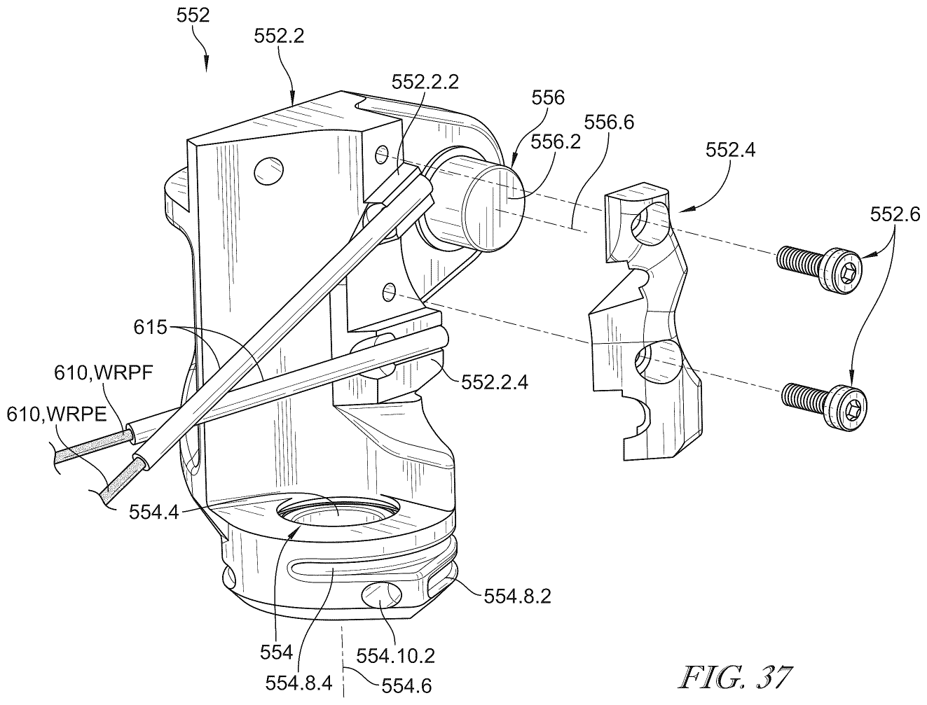

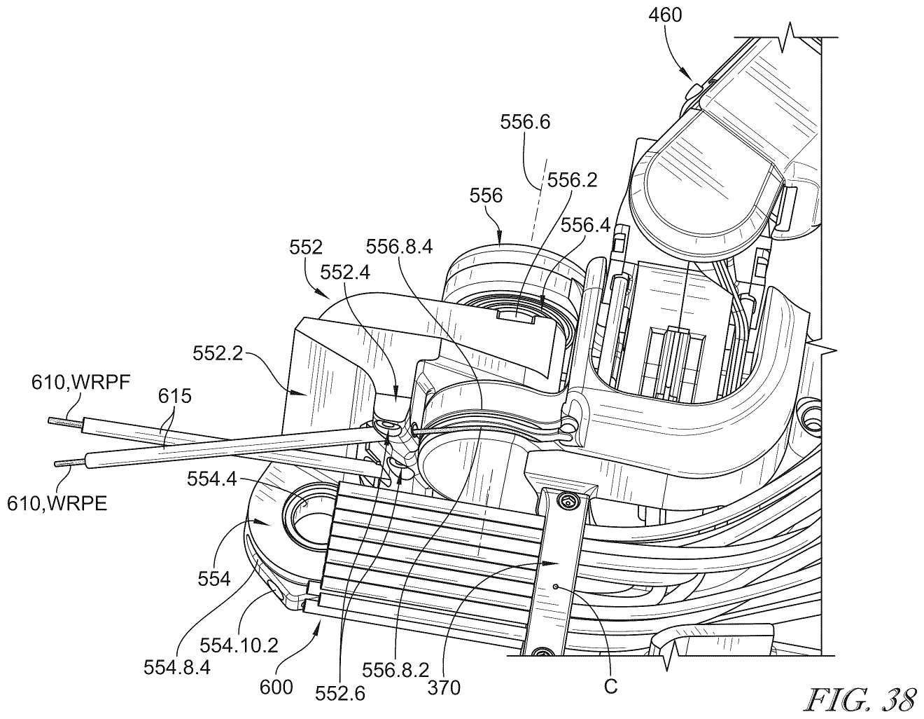

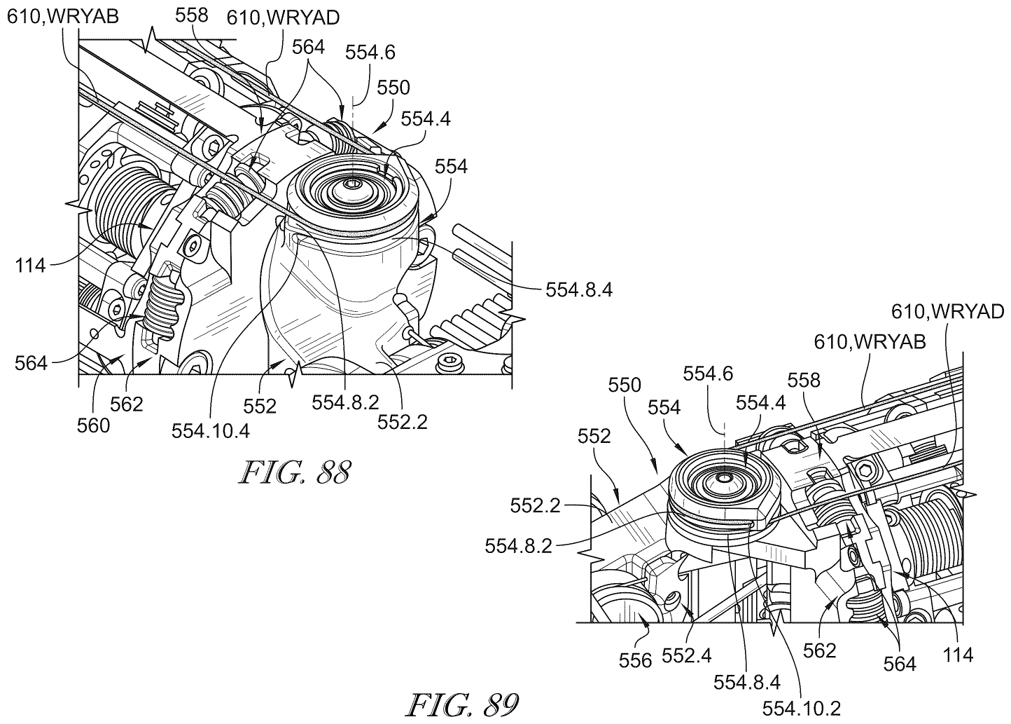

FIGS. 37-38 illustrate a portion of the tendon assembly 600 at the wrist assembly 550 for yaw of the hand assembly 200. FIGS. 88 and 89 show different views of one end of a tendon 610 with a ball 630 received into the ball seat or catch 554.10.2 of the yaw component 554, and the cable is guided by the cable guide 554.8.2 around the front of the yaw component 554. The tendon 610 is routed around the pulleys 652, 654 and spindles 651 of an actuator, e.g., H1 actuator 132, as discussed above. Additionally, the opposed end of the tendon 610, including a ball 630, is received into the ball catch 554.10.4 on the opposite side of the yaw component 554, and the cable is guided by the cable guide 554.8.4 around the front of the yaw component 554, completing the loop.

c. Movement of the Tendons

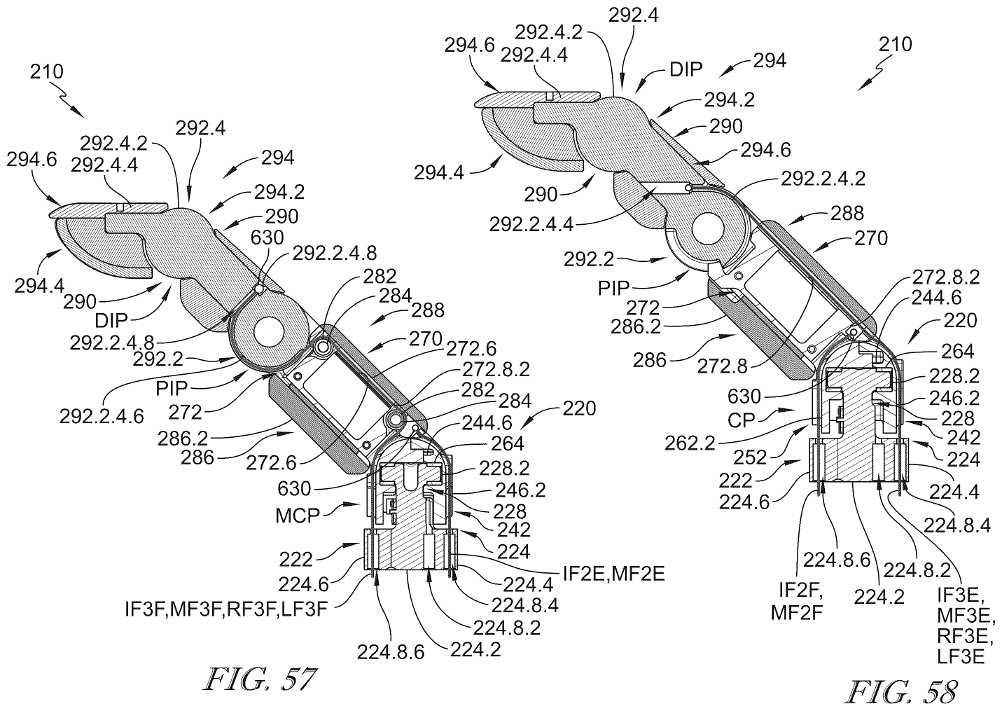

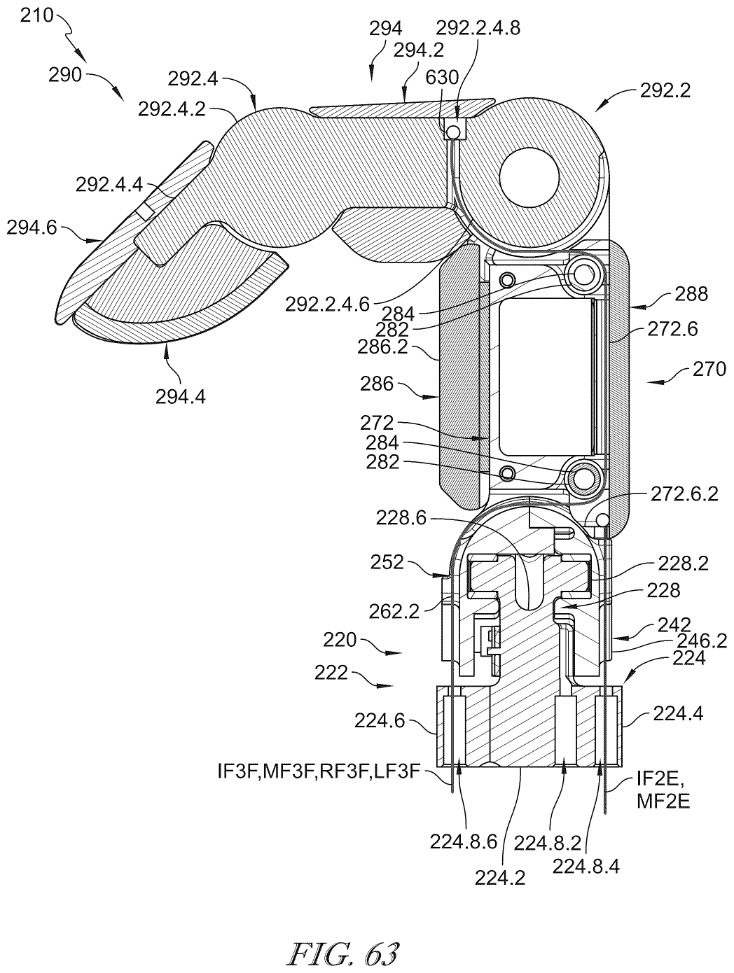

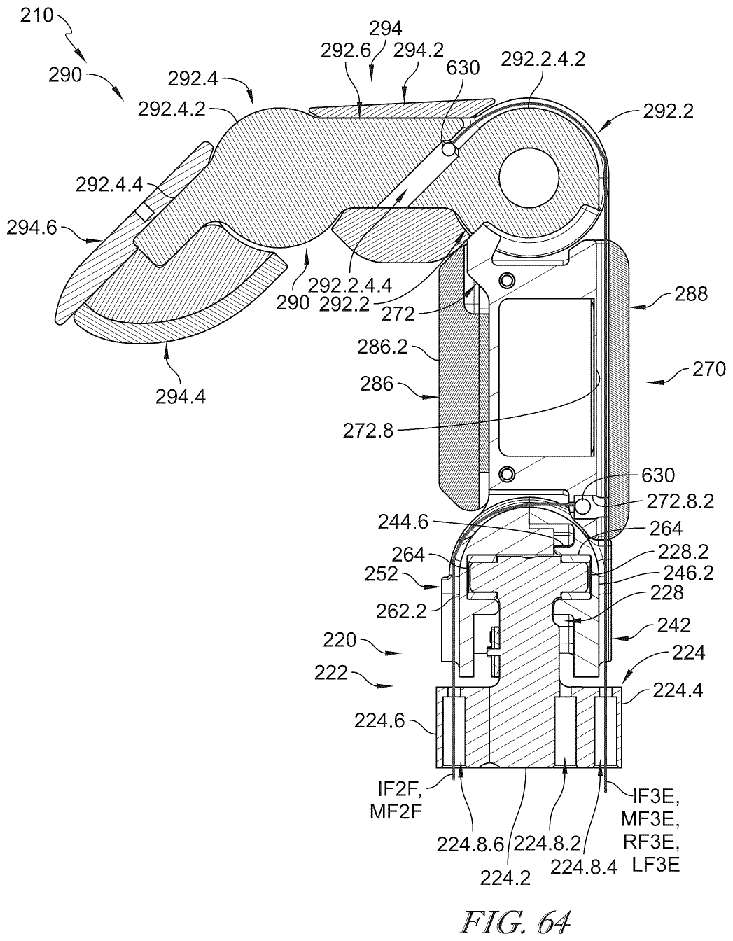

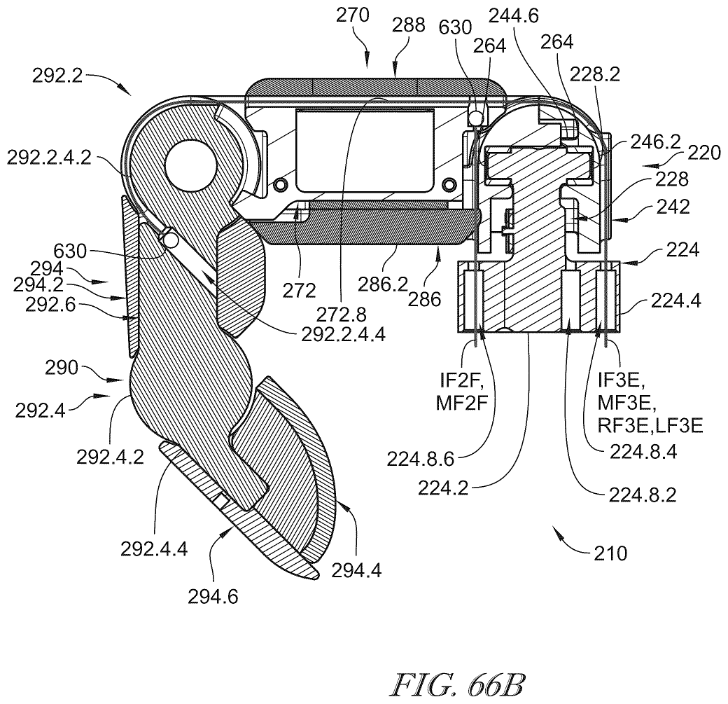

Movement of the joints of the hand assembly 200 is disclosed in connection with FIGS. 47-83, and movement of the joints of the wrist assembly 550 is disclosed in connection with FIGS. 90-93. For example, FIG. 50 shows the change in position (adduction) due to counter-clockwise movement of the ball 630, which moves a finger 210 (e.g., the index finger 210a). FIG. 52 shows the change in position (abduction) due to clockwise movement of the ball 630, which also moves the finger (e.g., index finger 210a). In another example, FIGS. 57 and 58 show the tendon position for a 45 degree bend at the MCP joint. Additionally, FIGS. 60 and 61 show the tendon position for a 90 degree bend at the MCP joint. In another example, FIGS. 63 and 64 show the tendon positions for a 90 degree bend at the PIP joint. In another example, FIGS. 66 and 67 show the tendon positions for a 90 degree bend at the MCP joint and a 90 degree bend at the PIP joint.

One example of how the index finger 210a moves based on the movement of the IF2 actuator 134 is described below. It should be understood that this is only exemplary and can apply the same or similarly to other fingers. The rotational or angular movement of the IF2 actuator 134 will cause the finger to move towards or away from the hand housing 300. This rotational or angular movement of the IF2 actuator causes: (i) a first extent of the IF2 flexion tendon (red tendon) to be wrapped around the actuator spool 644, (ii) a second extent of the IF2 flexion tendon to be pulled across the routing plate 562, (iii) a third extent of the IF2 flexion tendon to move through a sheath 615 within the opening 370.1 of the carpal tunnel-like structure 370 and the lower extent of the hand 200, (iv) a fourth extent of the IF2 flexion tendon to move through the cable passageways 224.8.6 of the knuckle support 222, and specifically the third set of passageways 224.8.6, (v) a fifth extent of the IF2 flexion tendon to move across an extent of the knuckle assembly 220, and specifically the cable guide slots 262.2, (vi) a first extent of the IF2 extension tendon (blue tendon) to be pulled across an extent of the knuckle assembly 220, and specifically the cable guide slots 246.2, (vii) a second extent of the IF2 extension tendon to move through the cable passageways 224.8.2 of the knuckle support 222, and specifically the first set of passageways 224.8.2, (viii) a third extent of the IF2 extension tendon to move through another sheath 615 within the opening 370.1 of the carpal tunnel-like structure 370 and lower extent of the hand, (ix) a fourth extent of the IF2 extension tendon to be pulled across the routing plate 562, and (x) a fifth extent of the IF2 extension tendon to be unwrapped from the actuator spool 644.

### 5. Elbow Assembly and Hand Twist Assembly

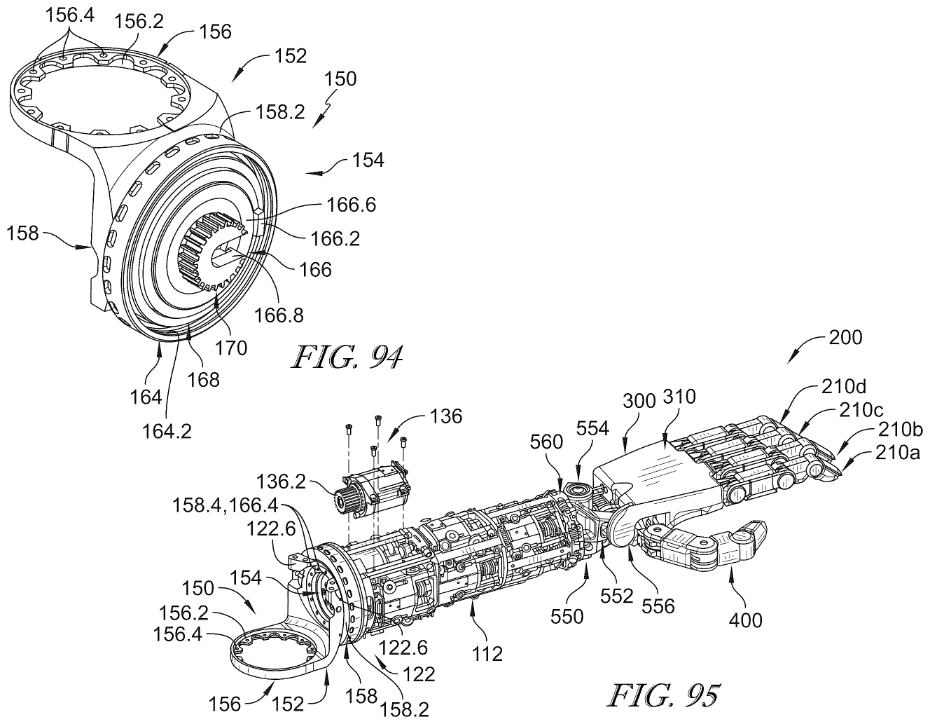

As shown in FIGS. 94-97, the illustrative embodiment of the elbow assembly 150 includes: (i) an elbow frame 152 and (ii) an output mount assembly 154. The elbow frame 152 is configured structurally to support the forearm assembly 110 and the attached hand assembly 200. The output mount assembly 154 is configured to interface with the direct-drive actuator 136, which is coupled in the proximal mounting portion 120 of the forearm frame 112.

As shown in FIGS. 94 and 95, the elbow frame 152 includes: (i) an attachment portion 156 and (ii) an output mount receiving portion 158. The attachment portion 156 is configured to secure the lower arm assembly 28, 1028 to the robot 1, 1001 and includes a mounting ring 156.2 with a plurality of apertures 156.4 for receiving fasteners that couple the elbow assembly 150 to the elbow actuator (J4). The output mount receiving portion 158 is configured to receive the output mount assembly 154 and includes a mounting ring 158.2 with a plurality of apertures 158.4 for fasteners that couple the output mount assembly 154 to the output mount receiving portion 158 of the elbow frame 152.

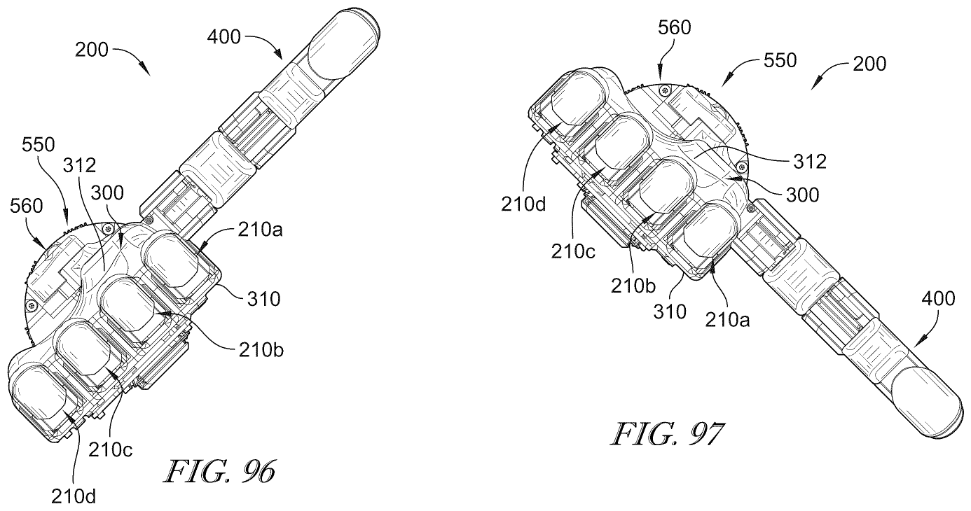

As shown in FIGS. 95 and 96, the output mount assembly 154 includes: (i) a twist bearing 162, (ii) an outer retaining ring 164, (iii) an inner retaining ring 166, (iv) an encoder ring 168, and (v) a slotted spur gear 170. The inner retaining ring 166 can include a hardstop 166.2, a plurality of mounting holes 166.4, and a central hub 166.6 with a keyed slot 166.8 facing the hardstop 166.2. The direct-drive actuator (i.e., non-tendon based) actuator 136 has an output gear 136.2 fixed to its output shaft that engages the slotted spur gear 170. The elbow end portion 122 of the forearm frame 112 can include end stops 122.6 within its interior portion 122.2 that are configured to interact with the hardstop 166.2 of the output mount assembly 154 of the elbow assembly 150. The encoder ring 168 can include a rotary sensor for measuring rotational position and velocity. Although the illustrative embodiment of the output mount assembly 154 is configured for a specific actuator, other configurations adapted for alternate actuators can be relied on for twist rotation of the lower arm and hand.

In the illustrative embodiment, the elbow assembly 150 is assembled by positioning the outer retaining ring 164 of the output mount assembly 154 around the mounting ring 158.2 of the output mount receiving portion 158 of the elbow frame 152, and sliding the twist bearing 162 onto the mounting ring 158.2. The inner retaining ring 166 is oriented on the mounting ring 158.2 in a selected position for a left or right side lower arm assembly 28, 1028, where the hardstop 166.2 on the inner retaining ring 166 limits motion at the maximum and minimum rotation. For example, with the attachment portion 156 of the elbow frame 152 facing upward, the hardstop 166.2 of the inner retaining ring 166 can be oriented at +90 degrees from the top (i.e., the 3 o'clock position) for a left side assembly, or oriented at −90 degrees from the top (i.e., the 9 o'clock position) for a right side assembly. The inner retaining ring 166 is coupled to the mounting ring 158.2 of the output mount receiving portion 158 by aligning the plurality of mounting holes 166.4 of the inner retaining ring 166 with the plurality of apertures 158.4 of the mounting ring 158.2, with the hardstop 166.2 oriented in the selected position. The encoder ring 168 can include an indicator configured to align with the hardstop 166.2 to ensure proper orientation for the sensor readings of the related movements. The encoder ring 168 is secured around the central hub 166.6 of the inner retaining ring 166. The slotted spur gear 170 is coupled to the central hub 166.6 with the slot of the slotted spur gear 170 aligned with the keyed slot 166.8 of the central hub 166.6.

The elbow assembly 150 is configured to couple to the forearm assembly 110 and receive output from the direct-drive actuator 136 to twist the forearm and hand. In the illustrative embodiment, the outer retaining ring 164 of the output mount assembly 154 of the elbow assembly 150 is coupled to the elbow end portion 122 of the forearm frame 112. For example, the outer retaining ring 164 can include interior threaded portions 164.2 configured to couple with an exterior threaded portion 122.4 of the forearm frame 112. To prevent over-rotation, prior to coupling, the elbow assembly 150 is positioned such that the hardstop 166.2 of the inner retaining ring 166 of the output mount assembly 154 is positioned between the two end stops 122.6 of the forearm frame 112, defining the rotation limits of the forearm assembly 110. The direct-drive actuator 136 is housed in the proximal mounting portion 120 of the forearm frame 112 and positioned such that the output gear 136.2 of the direct-drive actuator 136 is meshed with the slotted spur gear 170 of the output mount assembly 154. The direct-drive actuator 136 drives rotational movement (clockwise or counter-clockwise) of the forearm assembly 110 with respect to the elbow assembly 150 via the slotted spur gear 170 and inner retaining ring 166, where the hardstop 166.2 on the inner retaining ring 166 limits the twist or rotational movement of the forearm assembly 110 when the hardstop 166.2 contacts either end stop 122.6 of the forearm frame 112. The minimum and maximum twist movements are shown in FIGS. 96 and 97.

### D. Alternative Embodiments

It should be understood that this disclosure contemplates a multitude of alternative designs for the robot, a combination of its assemblies (e.g., an arm), its individual assemblies (e.g., a lower arm assembly), a combination of its parts or components (e.g., a plurality of actuators), and/or any individual part or component (e.g., a tendon or cable). To this extent, it should be recognized that any assembly, combination of assemblies, part, component, or combination thereof from any embodiment disclosed herein may be combined with any other assembly, combination of assemblies, part, component, or combination thereof. Accordingly, the detailed description shall not be interpreted as limited to a specific disclosed embodiment. Instead, this application should be construed according to how one of ordinary skill in the art would interpret, understand, build, or configure the robot, its assemblies, its components, or any part thereof, based on their knowledge and the information disclosed in this Application.

In one embodiment, the disclosed tendons 610 are manually tensioned for operation. As an alternative to manually tensioning the tendons 610, the tendons 610 may be tensioned by controlling a corresponding actuator 132, 134 using a processor that executes a tensioning algorithm. In particular, the processor may command the actuator 132, 134 to turn until an associated strain or torque reading exceeds a predefined threshold. Once this threshold is met, the processor may stop the actuator, and an installer may then tighten a locking mechanism (e.g., one or more screws) to secure the tendon 610 in the desired position. This controlled method for setting the tension in the tendons 610 simplifies manufacturing and ensures a reliable configuration.

In an alternative embodiment, instead of being routed on the exterior of the forearm frame 112, the tendons 610 may be routed on the interior of the forearm frame 112. As shown in FIGS. 3 and 95, the pulleys 652, 654 are positioned on the exterior of the actuator assembly. In other embodiments, the pulleys 652, 654 may be positioned on the interior of the actuator assembly. While this configuration may complicate the assembly process, it may also minimize potential damage to the tendons 610. Instead of using only rotary actuators, the lower arm assembly may include linear actuators, hydraulics, pneumatics, piezoelectric actuators, or any other type of mechanism capable of controlling the extension and contraction of the hand components. Additionally, it should be understood that this alternative embodiment contemplates a hybrid approach that may include a combination of linear actuators, hydraulics, pneumatics, piezoelectric actuators, and rotary actuators.

The tendons 610 may be configured as a continuous (i.e., looped) tendon that extends from a point on the finger assembly 210 to the actuator 132, 134 and returns to the finger assembly 210 without being cut, broken, or segmented. In other embodiments, the tendon 610 may be segmented into two separate and distinct components-namely, an extension tendon and a flexion tendon. In this embodiment, the extension tendon runs from the finger assembly to the actuator 132, 134 in a single piece, and the flexion tendon runs from the finger assembly to the actuator 132, 134 in a single piece. In other embodiments, additional segments (e.g., three or more segments) may be included in each tendon. This design may reduce the assembly's ability to properly apply tension between the extension and flexion of the finger. However, it may simplify the manufacturing and repair of the robot or its sub-assemblies.

As disclosed herein, the medial-distal assembly 290 of a finger 210 includes a distal end portion 292.4 that is affixed at a defined external angle (e.g. 135 degrees) relative to the medial portion 292.6 at the third finger joint or distal interphalangeal (DIP) joint. In alternative embodiments, the angle between these portions 292.4 and 292.6 may be increased to a value between 136 degrees and 180 degrees or reduced to a value between 134 degrees and 45 degrees. Additionally, the neutral angle (e.g., 180 degrees) between the proximal assembly 270 and the medial-distal assembly 290 may be increased to a value greater than 180 degrees or reduced to a value between 179 degrees and 45 degrees. If the angle between the proximal assembly 270 and the medial-distal assembly 290 is modified, it should be understood that this modified angle may be calculated in the uncurled state. Accordingly, the second finger joint or proximal interphalangeal (PIP) joint may have the same range of motion as disclosed above. The only change is the starting or neutral position contained in this range of motion. In a further embodiment, the angle between the distal end portion 292.4 and the medial portion 292.6 may be reduced, and the angle between the proximal assembly 270 and the medial-distal assembly 290 may be increased. In this embodiment, the uncurled state of the finger assembly might have a slight curvature that is distributed across a larger extent of the finger assembly in comparison to the curvature that is shown in the finger assembly disclosed in the Figures of this application.

In other embodiments, the little finger 210d may be omitted from the hand assembly 200. The omission of the little finger 210d reduces the complexity of the hand by omitting the need to tie or couple the movement of the ring finger 210c with said little finger 210d.

In another embodiment, at least one movement associated with the ring finger 210c may be tied or coupled with a movement of the middle finger 210b. For example, as the movement of the little finder 210d is tied to the ring finger 210c as described above. For example, the movement of the medial-distal assembly 290 of each finger may be tied or coupled to one another. In coupling this movement together, an actuator from the forearm assembly 110 may be omitted, or the degree of freedom may be moved to another joint (e.g., abduction/adduction of the little finger 210d, flexion/extension of the first or metacarpophalangeal (MCP) joint of the ring finger 210c). In another embodiment, the hand may include only two joints, instead of the three joints as disclosed in the Figures. In other words, the hand may omit the fixed distal interphalangeal (DIP) joint.

In a further embodiment, the actuator that controls the rotation of the wrist may be removed from the forearm assembly 110. Instead, this movement may be relocated to a position between the forearm assembly 110 and the elbow joint. Removing this actuator from the forearm assembly 110 will allow either: (i) the omission of an actuator, which in turn allows the size of the forearm assembly 110 to be reduced, or (ii) the designer to add another degree of freedom to the hand assembly 200. Examples of where the design may include an extra degree of freedom include: (i) untying or decoupling the little finger 210d from the ring finger 210c, (ii) adding abduction/adduction of the little finger 210d, (iii) adding flexion/extension of the first or metacarpophalangeal (MCP) joint of the ring finger 210c, or (iv) adding flexion/extension of the first or metacarpophalangeal (MCP) joint of the little finger 210d.

Instead of using a tendon-only approach for the hand assembly 200, it should be understood that an alternative embodiment of the hand assembly may include a combination of tendon-based actuators and non-tendon-based actuators. In this embodiment, the following movements/joints, or any combination thereof, may be controlled using a non-tendon-based actuator: (i) wrist yaw, (ii) wrist pitch, (iii) abduction/adduction of any finger (e.g., index finger 210a), (iv) flexion/extension of any joint contained in any finger (e.g., the second or proximal interphalangeal (PIP) joint of the little finger 210d), (v) abduction/adduction of the thumb 400, and/or (vi) flexion/extension of any joint contained in the thumb 400. The non-tendon-based actuators may utilize: (i) linear actuators and/or rotary actuators (e.g., that include worm drives), or (ii) a combination of linkages to form a component or assembly that is underactuated, and/or the omission of linkages. The addition of non-tendon-based actuators may allow for a reduction in the size of the forearm assembly 110 or an increase in the degrees of freedom of the hand assembly 200. Examples of where the design may include an extra degree of freedom include: (i) untying or decoupling the little finger 210d from the ring finger 210c, (ii) adding abduction/adduction of the first or metacarpophalangeal (MCP) joint of the little finger 210d, (iii) adding flexion/extension of the first or metacarpophalangeal (MCP) joint of the ring finger 210c, or (iv) adding flexion/extension of the first or metacarpophalangeal (MCP) joint of the little finger 210d.

In a further embodiment, one tendon may be omitted from each finger or each movable joint contained in each finger. The omitted tendon may be replaced with a spring (e.g., compression springs or torsion springs) or another mechanism (e.g., torsion springs or living hinges) that is designed to force the finger or thumb into, or to return to, a desired or preset configuration. For example, the extension tendon may be omitted. In this example, the spring or another mechanism may be designed to force the finger or thumb into an uncurled state. The actuator can then act on the flexion tendon to close the finger or thumb, allowing it to grasp an object. To close the finger or thumb, the actuator must overcome the biasing force applied by the spring or other mechanism. Once the robot has finished grasping the object, it can reduce the force on the tendon, thereby allowing the spring or other mechanism to return the finger or thumb to the uncurled state. While this configuration does not omit actuators, it simplifies manufacturing and assembly. Likewise, the flexion tendon may be omitted, and the spring or another mechanism may be designed to force the finger or thumb into a closed or curled state.

Instead of relying on a processor that runs a tensioning algorithm, the system could employ a closed-loop feedback mechanism with force sensors on the tendons to adjust tension to a target value automatically. Alternatively, optical sensing can be used to measure tendon deflection and ensure proper tension. A more straightforward manual tensioning approach can also be employed, with a calibrated torque wrench ensuring consistent force application. Beyond traditional tendon-driven designs, many actuation technologies may be integrated to power the hand's movements. Shape memory alloy wires, for instance, contract when heated, while electroactive polymer artificial muscles can flex under electrical stimulation. In other embodiments, the continuous loop tendon approach may be revised to use separate tendons for flexion and extension with adjustable turnbuckles, implement a differential pulley system to balance tension, or incorporate inline spring elements for compliance and shock absorption. Finger joint angles can be customized by using modular segments with standardized interfaces, installing adjustable stop mechanisms to achieve precise range-of-motion limits, or 3D printing finger components with patient-specific angles. Further, hybrid actuation systems that combine tendon-driven motion with small electric motors at the joints may enable fine-grained control. Finger segments may also be 3D printed from gradient materials to strategically place stiffer polymers at high-stress points and more flexible polymers at bending regions.

The lower arm assembly may include a protective covering or a glove 180 that is positioned over an extent of the forearm, wrist, and end effector or hand. In other embodiments, the protective covering may only be positioned over the wrist and end effector. In further embodiments, the protective covering may only extend over the hand. The type of protective covering may be selected based on the specific tasks to be performed by the robot in its designated operating environment. For specific operating environments, the robot's hands may include protective coverings as a barrier against heat, cold, electrical shock, liquids, dust, chemicals, and mechanical damage (e.g., cuts, punctures, abrasions). For other operating environments, the robot's hands may include protective coverings with padding. For yet other operating environments, the hands of the robot may include protective coverings with a deformable or adherent material to provide a better grip. The protective coverings can include underlying padding that may be glued to a substrate or over-molded. The choice of materials may be customized based on the specific use case or may include a common multi-layer approach for padding across multiple use cases. For example, the padding can be made from thermoplastic polyurethane (TPU) foam, ethylene propylene diene monomer (EPDM), solid silicone, or polyurethane. In one example, TPU foam can be used alone or in combination with a blend of other rubbers. Specifically, EPDM may be used to make the padding softer and stickier. In some examples, a very soft silicone core may be used with a tough polyurethane skin over the outside.

Another contemplated embodiment involves a modular architecture for the forearm assembly 110. Rather than integrating actuators 130 directly into distinct portions 116, 118, 120 of the forearm frame 112, the frame or an exoskeleton housing structure could be designed with standardized receptacles or bays configured to accept self-contained actuator modules or cartridges. Each module could encapsulate one or more actuators (which may be of the disclosed H1/H2 rotary type or alternative designs), associated control electronics (e.g., portions of the electronics package 140), and standardized interfaces for mechanical fixation, power transmission, data communication, and coupling to the downstream transmission system (e.g., tendon terminators, linkage pivots, fluidic ports). Such modularity could significantly simplify manufacturing, assembly, maintenance, and repair processes by enabling the rapid swapping of actuator units. It could also facilitate customization or upgrades, allowing a user to install modules with different performance characteristics (e.g., varying torque output, speed, or precision) based on application requirements.

The disclosed actuators 132, 134 may be replaced with a dual-disc cycloidal drive configuration. In such a design, two cycloidal discs 131.22 could be driven by the input motor, operating approximately 180 degrees out of phase with each other. This provides inherent cancellation of primary imbalance forces, which may enable smoother operation, albeit possibly at the expense of increased actuator length or component count. Control fidelity and interaction capabilities may be enhanced by incorporating additional sensing modalities within the actuator structure. For example, torque sensors could be integrated into the actuator's output stage, downstream from the cycloidal reduction mechanism, to provide a direct measurement of the torque being delivered to the load (e.g., a tendon or joint). This enables more precise force control and may potentially compensate for transmission elasticity or friction. Furthermore, the disclosed actuators 132, 134 could incorporate mechanisms for actively varying the gear reduction ratio (e.g., by adjusting the eccentricity ‘e’ using controllable elements), allowing the actuator to adapt its speed-torque characteristics to different phases of a task or varying operating conditions.

Further embodiments may replace or supplement fixed mechanical coupling between fingers (such as the described coupling of the ring finger 210c and little finger 210d via coupler 330, or the potential coupling of the ring finger 210c and middle finger 210b) with dynamic, software-controlled coupling. In such a configuration, additional actuators 130 and corresponding tendon loops 610 could be provided to grant independent control over previously coupled or fixed joints (e.g., providing independent MCP flexion/extension for the ring and little fingers, and independent PIP flexion/extension for the ring and little fingers). The control system processor could then execute algorithms to virtually couple the motion of selected joints or fingers based on the task context. This could involve mimicking the combined ring/little finger motion for power grasps, enabling independent motion for fine manipulation or tasks such as typing, or creating other synergistic movements as needed. This approach increases hardware requirements (actuators, tendons, routing complexity) but offers significantly greater kinematic flexibility and adaptability compared to fixed mechanical linkages.

In other embodiments, miniature compliant elements could be utilized, such as integrated elastomer segments within the tendon 610 itself, small spring-damper units incorporated near the MCP or PIP joints (e.g., integrated into the knuckle assembly 220 or proximal assembly 270 structures), or flexural elements within the joint bearings/pins 264, 266 themselves. Such distributed compliance may enhance shock absorption during impacts, provide more stable passive grasping, allow for better conformance to object surfaces, and potentially enable more natural, less rigid interactions with the environment.

In further embodiments, the palm structure, described primarily via the palm frame 310, may be modified to incorporate articulation or compliance. Instead of a fully rigid frame, segments of the palm structure could be interconnected by passive compliant joints or even limited-range active joints driven by dedicated tendons or local actuators. This could allow the palm itself to change shape slightly, for example, by deepening the transverse palmar arch to improve grip stability on cylindrical objects, or by flattening to manipulate planar objects more effectively. Such palmar articulation, mimicking aspects of human hand flexibility, could enhance grip adaptability and stability for a wider variety of object shapes and sizes without necessarily increasing the complexity or degrees of freedom of the fingers 210 or thumb 400.

### 1. Alternative Embodiment #1

The alternative embodiment of the hand assembly features 8 degrees of freedom (DoF). The index finger 210a has 2 DoF: (i) abduction/adduction at the first or metacarpophalangeal (MCP) joint and (ii) flexion/extension of the second or proximal interphalangeal (PIP) joint. The middle finger 210b has 1 DoF: (i) flexion/extension of the second or proximal interphalangeal (PIP) joint. The ring finger 210c has 1 DoF: (i) flexion/extension of the second or proximal interphalangeal (PIP) joint. The little finger 210d has 1 DoF: (i) flexion/extension of the second or proximal interphalangeal (PIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 2. Alternative Embodiment #2

The alternative embodiment of the hand assembly features 8 degrees of freedom (DoF). The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b, the ring finger 210c, and the little finger 210d all have a combined 1 DoF: (i) flexion/extension of the second or proximal interphalangeal (PIP) joint. The thumb 400 has 2 DoF: (i) abduction/adduction of the first thumb joint or trapeziometacarpal (TM) joint and (ii) flexion/extension of the third thumb joint or metacarpophalangeal (MCP) joint.

### 3. Alternative Embodiment #3

The alternative embodiment of the hand assembly features 9 degrees of freedom (DoF). The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b has 2 DoF: (i) flexion/extension of the first or metacarpophalangeal (MCP) joint and (ii) flexion/extension of the second or proximal interphalangeal (PIP) joint. The ring finger 210c and little finger 210d have a combined 1 DoF: (i) flexion/extension of the second or proximal interphalangeal (PIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 4. Alternative Embodiment #4

The alternative embodiment of the hand assembly features 9 degrees of freedom (DoF). The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b, the ring finger 210c, and the little finger 210d all have a combined 1 DoF: (i) flexion/extension of the second or proximal interphalangeal (PIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 5. Alternative Embodiment #5

The alternative embodiment of the hand assembly features 9 degrees of freedom (DoF). The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b and the ring finger 210c have a combined 1 DoF: (i) flexion/extension of the second or proximal interphalangeal (PIP) joint. The little finger 210d has 2 DoF: (i) abduction/adduction at the first or metacarpophalangeal (MCP) joint and (ii) flexion/extension of the second or proximal interphalangeal (PIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 6. Alternative Embodiment #6

The alternative embodiment of the hand assembly features 9 degrees of freedom (DoF). The index finger 210a has 2 DoF: (i) abduction/adduction at the first or metacarpophalangeal (MCP) joint and (ii) flexion/extension of the second or proximal interphalangeal (PIP) joint. The middle finger 210b has 1 DoF: (i) flexion/extension of the second or proximal interphalangeal (PIP) joint. The ring finger 210c has 1 DoF: (i) flexion/extension of the second or proximal interphalangeal (PIP) joint. The little finger 210d has 2 DoF: (i) abduction/adduction at the first or metacarpophalangeal (MCP) joint and (ii) flexion/extension of the second or proximal interphalangeal (PIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 7. Alternative Embodiment #7

The alternative embodiment of the hand assembly features 9 degrees of freedom (DoF). The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b has 1 DoF: (i) flexion/extension of the second or proximal interphalangeal (PIP) joint. The ring finger 210c has 1 DoF: (i) flexion/extension of the second or proximal interphalangeal (PIP) joint. The little finger 210d has 2 DoF: (i) abduction/adduction at the first or metacarpophalangeal (MCP) joint and (ii) flexion/extension of the second or proximal interphalangeal (PIP) joint. The thumb 400 has 2 DoF: (i) abduction/adduction of the first thumb joint or trapeziometacarpal (TM) joint and (ii) flexion/extension of the third thumb joint or metacarpophalangeal (MCP) joint.

### 8. Alternative Embodiment #8

The alternative embodiment of the hand assembly features 10 degrees of freedom (DoF). The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b has 2 DoF: (i) flexion/extension of the first or metacarpophalangeal (MCP) joint and (ii) flexion/extension of the second or proximal interphalangeal (PIP) joint. The ring finger 210c has 1 DoF: (i) flexion/extension of the second or proximal interphalangeal (PIP) joint. The little finger 210d has 1 DoF: (i) flexion/extension of the second or proximal interphalangeal (PIP) joint. The thumb 400 has 3 DoF: (i) abduction/adduction of the first thumb joint or trapeziometacarpal (TM) joint, (ii) flexion/extension of second thumb joint or carpometacarpal (CMC) joint, and (iii) flexion/extension of third thumb joint or metacarpophalangeal (MCP) joint.

### 9. Alternative Embodiment #9

The alternative embodiment of the hand assembly features 10 degrees of freedom (DoF). The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b has 1 DoF: (i) flexion/extension of the second or proximal interphalangeal (PIP) joint. The ring finger 210c has 1 DoF: (i) flexion/extension of the second or proximal interphalangeal (PIP) joint. The little finger 210d has 2 DoF: (i) abduction/adduction at the first or metacarpophalangeal (MCP) joint and (ii) flexion/extension of the second or proximal interphalangeal (PIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 10. Alternative Embodiment #10

The alternative embodiment of the hand assembly features 10 degrees of freedom (DoF). The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b has 1 DoF: (i) flexion/extension of the second or proximal interphalangeal (PIP) joint. The ring finger 210c has 1 DoF: (i) flexion/extension of the second or proximal interphalangeal (PIP) joint. The little finger 210d has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 11. Alternative Embodiment #11

The alternative embodiment of the hand assembly features 11 degrees of freedom. The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b has 2 DoF: (i) flexion/extension of the first or metacarpophalangeal (MCP) joint and (ii) flexion/extension of the second or proximal interphalangeal (PIP) joint. The ring finger 210c has 2 DoF: (i) flexion/extension of the first or metacarpophalangeal (MCP) joint and (ii) flexion/extension of the second or proximal interphalangeal (PIP) joint. The little finger 210d has 2 DoF: (i) abduction/adduction at the first or metacarpophalangeal (MCP) joint and (ii) flexion/extension of the second or proximal interphalangeal (PIP) joint. The thumb 400 has 2 DoF: (i) abduction/adduction of the first thumb joint or trapeziometacarpal (TM) joint and (ii) flexion/extension of the second thumb joint or carpometacarpal (CMC) joint.

### 12. Alternative Embodiment #12

The alternative embodiment of the hand assembly features 12 degrees of freedom. The index finger 210a has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The middle finger 210b has 2 DoF: (i) flexion/extension of the first or metacarpophalangeal (MCP) joint and (ii) flexion/extension of the second or proximal interphalangeal (PIP) joint. The ring finger 210c has 2 DoF: (i) flexion/extension of the first or metacarpophalangeal (MCP) joint and (ii) flexion/extension of the second or proximal interphalangeal (PIP) joint. The little finger 210d has 2 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 13. Alternative Embodiment #13

The alternative embodiment of the hand assembly features 15 degrees of freedom (DoF). The index finger 210a has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The middle finger 210b and the ring finger 210c each have 2 DoF: (i) flexion/extension of the first or metacarpophalangeal (MCP) joint and (ii) flexion/extension of the second or proximal interphalangeal (PIP) joint. The little finger 210d has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 14. Alternative Embodiment #14

The alternative embodiment of the hand assembly features 17 degrees of freedom. The index finger 210a has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The middle finger 210b has 3 DoF: (i) flexion/extension of the first or metacarpophalangeal (MCP) joint, (ii) flexion/extension of the second or proximal interphalangeal (PIP) joint, and (iii) flexion/extension of the third or distal interphalangeal (DIP) joint. The ring finger 210c has 3 DoF: (i) flexion/extension of the first or metacarpophalangeal (MCP) joint, (ii) flexion/extension of the second or proximal interphalangeal (PIP) joint, and (iii) flexion/extension of the third or distal interphalangeal (DIP) joint. The little finger 210d has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 15. Alternative Embodiment #15

The alternative embodiment of the hand assembly features 17 degrees of freedom. The index finger 210a has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The middle finger 210b and the ring finger 210c each has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The little finger 210d has 2 DoF: (i) abduction/adduction at the first or metacarpophalangeal (MCP) joint and (ii) flexion/extension of the first or metacarpophalangeal (MCP) joint. The thumb 400 has 3 DoF: (i) abduction/adduction of the first thumb joint or trapeziometacarpal (TM) joint, (ii) flexion/extension of second thumb joint or carpometacarpal (CMC) joint, and (iii) flexion/extension of third thumb joint or metacarpophalangeal (MCP) joint.

### 16. Alternative Embodiment #16

The alternative embodiment of the hand assembly features 18 degrees of freedom. The index finger 210a has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The middle finger 210b and the ring finger 210c each have 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The little finger 210d has 2 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The thumb 400 has 3 DoF: (i) abduction/adduction of the first thumb joint or trapeziometacarpal (TM) joint, (ii) flexion/extension of the second thumb joint or carpometacarpal (CMC) joint, and (iii) flexion/extension of the third thumb joint or metacarpophalangeal (MCP) joint.

### 17. Alternative Embodiment #17

The alternative embodiment of the hand assembly has 18 DoF. The index finger 210a has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The middle finger 210b and the ring finger 210c each have 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The little finger 210d has 3 DoF: (i) abduction/adduction at the first or metacarpophalangeal (MCP) joint, (ii) flexion/extension of the first or metacarpophalangeal (MCP) joint, and (iii) flexion/extension of the second or proximal interphalangeal (PIP) joint. The thumb 400 has 4 DoF: (i) abduction/adduction of the first thumb joint or trapeziometacarpal (TM) joint, (ii) flexion/extension of the second thumb joint or carpometacarpal (CMC) joint, (iii) flexion/extension of the third thumb joint or metacarpophalangeal (MCP) joint, and (iv) flexion/extension of the third or distal interphalangeal (DIP) joint.

### 18. Alternative Embodiment #18

This alternative embodiment of the hand assembly has 20 DoF. The index finger 210a has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The middle finger 210b, the ring finger 210c, and the little finger 210d each have 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The thumb 400 has 4 DoF: (i) abduction/adduction of the first thumb joint or trapeziometacarpal (TM) joint, (ii) flexion/extension of the second thumb joint or carpometacarpal (CMC) joint, (iii) flexion/extension of the third thumb joint or metacarpophalangeal (MCP) joint, and (iv) flexion/extension of the third or distal interphalangeal (DIP) joint.

### 19. Alternative Embodiment #19

This alternative embodiment of the hand assembly has 22 DoF. The index finger 210a has 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The middle finger 210b, the ring finger 210c, and the little finger 210d each have 4 DoF: (i) abduction/adduction at the first or metacarpophalangeal (MCP) joint, (ii) flexion/extension of the first or metacarpophalangeal (MCP) joint, (iii) flexion/extension of the second or proximal interphalangeal (PIP) joint, and (iv) flexion/extension of the third or distal interphalangeal (DIP) joint. The thumb 400 has 4 DoF: (i) abduction/adduction of the first thumb joint or trapeziometacarpal (TM) joint, (ii) flexion/extension of the second thumb joint or carpometacarpal (CMC) joint, (iii) flexion/extension of the third thumb joint or metacarpophalangeal (MCP) joint, and (iv) flexion/extension of the third or distal interphalangeal (DIP) joint. The hand housing 300 has 2 DoF: (i) flexion/extension of the little finger and (ii) flexion/extension of the thumb.

Any other combination of the above embodiments is also contemplated. It should also be understood that the degrees of freedom for any joint may be reduced by half if the joint is biased in one direction. For example, the hand may not include a degree of freedom for the extension of the third thumb joint or metacarpophalangeal (MCP) joint because said degree of freedom is replaced by a spring or another biasing member.

### E. Industrial Application

While the disclosure shows illustrative embodiments of a robot (in particular, a humanoid robot), it should be understood that embodiments are designed to be examples of the principles of the disclosed assemblies, methods and systems, and are not intended to limit the broad aspects of the disclosed concepts to the embodiments illustrated. As will be realized, the disclosed robot, and its functionality and methods of operation, are capable of other and different configurations and several details are capable of being modified all without departing from the scope of the disclosed methods and systems. For example, one or more of the disclosed embodiments, in part or whole, may be combined with a disclosed assembly, method and system. As such, one or more steps from the diagrams or components in the Figures may be selectively omitted and/or combined consistent with the disclosed assemblies, methods and systems. Additionally, one or more steps from the arrangement of components may be omitted or performed in a different order. Accordingly, the drawings, diagrams, and detailed description are to be regarded as illustrative in nature, not restrictive or limiting, of said humanoid robot. It should be understood that the use of the word “or” when separating element names in connection with a single reference number indicates that the same structure can have two different names. For example, “end effector or hand assembly 200” indicates that the structure 200 can either be referred to or claimed as an “end effector” or “hand assembly.” In another example, the structure 114 can be referred to or claimed as “a wrist portion,” “a distal end,” or “a second end.”

While the above-described methods and systems are designed for use with a general-purpose humanoid robot, it should be understood that the assemblies, components, learning capabilities, and/or kinematic capabilities may be used with other robots. Examples of other robots include: articulated robot (e.g., an arm having two, six, or ten degrees of freedom, etc.), a cartesian robot (e.g., rectilinear or gantry robots, robots having three prismatic joints, etc.), Selective Compliance Assembly Robot Arm (SCARA) robots (e.g., with a donut shaped work envelope, with two parallel joints that provide compliance in one selected plane, with rotary shafts positioned vertically, with an end effector attached to an arm, etc.), delta robots (e.g., parallel link robots with parallel joint linkages connected with a common base, having direct control of each joint over the end effector, which may be used for pick-and-place or product transfer applications, etc.), polar robots (e.g., with a twisting joint connecting the arm with the base and a combination of two rotary joints and one linear joint connecting the links, having a centrally pivoting shaft and an extendable rotating arm, spherical robots, etc.), cylindrical robots (e.g., with at least one rotary joint at the base and at least one prismatic joint connecting the links, with a pivoting shaft and extendable arm that moves vertically and by sliding, with a cylindrical configuration that offers vertical and horizontal linear movement along with rotary movement about the vertical axis, etc.), self-driving car, a kitchen appliance, construction equipment, or a variety of other types of robot systems. The robot system may include one or more sensors (e.g., cameras, temperature, pressure, force, inductive or capacitive touch), motors (e.g., servo motors and stepper motors), actuators, biasing members, encoders, housing, or any other component known in the art that is used in connection with robot systems. Likewise, the robot system may omit one or more sensors (e.g., cameras, temperature, pressure, force, inductive or capacitive touch), motors (e.g., servo motors and stepper motors), actuators, biasing members, encoders, housing, or any other component known in the art that is used in connection with robot systems.

In other embodiments, other configurations and/or components may be utilized. As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. The server functions may be implemented in a distributed fashion on a number of similar platforms, to distribute the processing load.

Hence, aspects of the disclosed methods and systems outlined above may be embodied in programming. Program aspects of the technology may be thought of as “products” or “articles of manufacture” typically in the form of executable code and/or associated data that is carried on or embodied in a type of machine-readable medium. “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

A machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the disclosed methods and systems. Volatile storage media include dynamic memory, such as the main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is to be understood that the invention is not limited to the exact details of construction, operation, exact materials or embodiments shown and described, as obvious modifications and equivalents will be apparent to one skilled in the art. While the specific embodiments have been illustrated and described, numerous modifications come to mind without significantly departing from the spirit of the invention, and the scope of protection is only limited by the scope of the accompanying Claims. In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

It should also be understood that the term “substantially” as utilized herein means a deviation less than 15% and preferably less than 5%. It should also be understood that the term “near” means within 10 cm, the term “proximate” means within 5 cm, and the term “adjacent” means within 1 cm. It should also be understood that other configurations or arrangements of the above described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

In this Application, to the extent any U.S. patents, U.S. patent applications, or other materials (e.g., articles) have been incorporated by reference, the text of such materials is only incorporated by reference to the extent that they do not conflict with materials, statements and drawings set forth herein. In the event of such conflict, the text of the present document controls, and terms in this document should not be given a narrower reading in virtue of the way in which those terms are used in other materials incorporated by reference. It should also be understood that structures and/or features not directly associated with a robot cannot be adopted or implemented into the disclosed humanoid robot without careful analysis and verification of the complex realities of designing, testing, manufacturing, and certifying a robot for completion of usable work nearby and/or around humans. Theoretical designs that attempt to implement such modifications from non-robotic structures and/or features are insufficient (and in some instances, woefully insufficient) because they amount to mere design exercises that are not tethered to the complex realities of successfully designing, manufacturing and testing a robot.

1. A humanoid robot, comprising:
an upper region including at least: (i) a head, (ii) a torso, (iii) an arm having: (a) an elbow assembly, (b) a forearm assembly, and (c) a wrist assembly, and wherein the forearm assembly includes:
a forearm frame includes: (i) a forearm axis that is substantially centered within an extent of the forearm frame, (ii) a proximal mounting portion including a proximal end coupled to an extent of the elbow assembly, (iii) a distal mounting portion including a distal end coupled to an extent of the wrist assembly,
a first plurality of actuators coupled to the proximal mounting portion and arranged radially around the forearm axis, and wherein a first actuator contained in the first plurality of actuators is in contact with a first tendon and includes a first tendon departure region,
a second plurality of actuators coupled to the distal mounting portion and arranged radially around the forearm axis, and wherein a second actuator contained in the second plurality of actuators is in contact with a second tendon and includes a second tendon departure region, and
wherein the first tendon departure region is at a first distance from the wrist assembly and the second tendon departure region is at a second distance from the wrist assembly, and wherein the first distance is not equal to the second distance;
a lower region spaced apart from the upper region and including a pair of legs; and,
a central region interconnecting the upper region and the lower region.

2. The humanoid robot of claim 1, wherein the humanoid robot includes a non-tendon based actuator that is at least partially positioned between the elbow assembly and the distal end of the forearm frame.

3. The humanoid robot of claim 2, wherein the non-tendon based actuator is a linear actuator.

4. The humanoid robot of claim 1, further comprising a first biasing member configured to apply a first biasing force on the first tendon, and a second biasing member configured to apply a second biasing force on the second tendon.

5. The humanoid robot of claim 1, wherein the first tendon has a first total curvature in an uncurled state, and the second tendon has a second total curvature that is greater than the first total curvature in the uncurled state, and wherein an application of force that is associated with the second tendon is less than the application of force associated with the first tendon.

6. The humanoid robot of claim 1, wherein the first tendon has a first total curvature in an uncurled state, and the second tendon has a second total curvature that is greater than the first total curvature in the uncurled state, and wherein a frequency of use that is associated with the second tendon is less than a frequency of use associated with the first tendon.

7. The humanoid robot of claim 1, further comprising: an end effector having a housing and a finger assembly, and (ii) a carpal tunnel-like structure configured to guide the first and second tendons from the forearm assembly, through the wrist assembly, and to a base of the housing.

8. The humanoid robot of claim 7, further comprising a sheath having: (i) a first extent that is positioned within the carpal tunnel-like structure, (ii) a second extent that extends towards the finger assembly, and (iii) a third extent that extends towards the wrist assembly.

9. The humanoid robot of claim 1, further comprising an end effector with less than 24 degrees of freedom, which are actuated by less than 20 motors.

10. The humanoid robot of claim 1, wherein the proximal end of the forearm frame has a proximal perimeter that is larger than a distal perimeter of the distal end of the forearm frame.

11. A humanoid robot, comprising:
an upper region including: (i) a head, (ii) a torso, (iii) an arm coupled to the torso and including: (a) a forearm assembly, (b) a wrist assembly coupled to the forearm assembly, and (c) an end effector coupled to the wrist assembly, and wherein said end effector includes:
an index finger assembly,
a middle finger assembly positioned proximate to the index finger assembly,
a ring finger assembly positioned proximate to the middle finger assembly,
a little finger assembly positioned proximate to the ring finger assembly,
a thumb assembly,
a housing: (i) coupled to the index finger, middle finger, ring finger, little finger, and thumb assemblies, and (ii) having a base, and wherein said housing includes:
a first interior wall extent,
a second interior wall extent positioned a first distance from the first interior wall extent,
a third interior wall extent,
a fourth interior wall extent positioned a second distance from the third interior wall extent, and wherein the second distance is closer to the base of the housing than the first distance, and
wherein the first distance is less than 45% of the second distance;
a first plurality of tendons coupled to at least the index finger assembly and a second plurality of tendons coupled to the middle finger assembly, and wherein the first and second plurality of tendons are positioned between both: (i) the first and second interior wall extents, and (ii) the third and fourth interior wall extents;
a lower region spaced apart from the upper region and including a pair of legs; and,
a central region interconnecting the upper region and the lower region.

12. The humanoid robot of claim 11, wherein the wrist assembly comprises:
a housing coupling component configured to couple to the housing;
a yaw component coupled to the housing coupling component and configured to provide side-to-side movement of the end effector;
a pitch component coupled to the yaw component and configured to provide up-and-down movement of the end effector; and
a base structure configured to couple to the forearm assembly.

13. The humanoid robot of claim 12, wherein the pitch component includes a cable guide configured to route at least one tendon of the first or second plurality of tendons around a portion of the pitch component.

14. The humanoid robot of claim 11, further comprising a carpal tunnel-like structure configured to guide the first or second plurality of tendons from the forearm assembly to the housing of the end effector, wherein the carpal tunnel-like structure is positioned between the first interior wall extent and the second interior wall extent.

15. The humanoid robot of claim 11, further comprising a plurality of actuators positioned in the forearm assembly and coupled to the first or second plurality of tendons, wherein the forearm assembly includes a forearm frame having a tapered outer profile that is larger at a proximal end than at a distal end.

16. A humanoid robot, comprising:
an upper region including: (i) a head, (ii) a torso, (iii) an arm coupled to the torso and including: (a) a forearm assembly, (b) a wrist assembly coupled to the forearm assembly, and (c) an end effector coupled to the wrist assembly, and wherein wrist assembly includes:
a left base member,
a right base member,
a rotational axis that extends between the left and right base members,
a carpal tunnel-like structure coupled to the end effector and having an opening formed therein, and wherein a centroid is defined by said opening, and
wherein the centroid of the opening formed in the carpal tunnel-like structure is offset from the rotational axis, whereby said centroid does not lie on the rotational axis; and
a lower region spaced apart from the upper region and including a pair of legs; and,
a central region interconnecting the upper region and the lower region.

17. The humanoid robot of claim 16, wherein the humanoid robot includes a non-tendon based actuator that is at least partially positioned between a proximal end of the forearm frame and a distal end of the forearm frame.

18. The humanoid robot of claim 16, further comprising a first tendon that extends through the carpal tunnel-like structure to a portion of the end effector, and wherein a biasing member provides a biasing force on said tendon.

19. The humanoid robot of claim 16, further comprising: (i) a first tendon that extends through the carpal tunnel-like structure and has a first total curvature in an uncurled state, and (ii) a second tendon that extends through the carpal tunnel-like structure and has a second total curvature that is less than the first total curvature in the uncurled state.

20. The humanoid robot of claim 16, wherein an application of force or a frequency of use that is associated with the second tendon is greater than an application of force or a frequency of use associated with the first tendon.

21. The humanoid robot of claim 16, further comprising a glove that substantially encases the end effector, the wrist assembly, and a portion of the forearm assembly.

22. The humanoid robot of claim 16, wherein the end effector includes more than 19 degrees of freedom, but less than 24 degrees of freedom.

23. The humanoid robot of claim 22, wherein the forearm assembly includes more than six motors, but fewer than 20 motors.
